(19) United States
(12) Patent Application Publication
(10) Pub. No.: US 2025/0029319 A1
(43) Pub. Date: Jan. 23, 2025

(54) DEVICES, METHODS, AND GRAPHICAL USER INTERFACES FOR SHARING CONTENT IN A COMMUNICATION SESSION

(71) Applicant: Apple Inc., Cupertino, CA (US)

(72) Inventors: Benjamin H. BOESEL, Jackson, WY (US); Shih-Sang CHIU, San Francisco, CA (US); Christopher D. MCKENZIE, Burlingame, CA (US); Jonathan RAVASZ, Sunnyvale, CA (US); Jesse CHAND, San Francisco, CA (US)

(21) Appl. No.: 18/781,745

(22) Filed: Jul. 23, 2024

Related U.S. Application Data
(60) Provisional application No. 63/594,820, filed on Oct. 31, 2023.
(60) Provisional application No. 63/515,120, filed on Jul. 23, 2023.

(51) Int. Cl. G06T 15/20; G06F 3/01; G06T 19/00

(52) U.S. Cl. CPC G06T 15/20; G06F 3/017; G06T 19/00; G06T 2200/24; G06T 2219/024

(57) ABSTRACT

A computer system displays representations of second computer systems included in a communication session and/or content in an environment in some embodiments. For example, the computer system displays the representations of the second computer systems in a first region while content is not shared in the communication session and displays the representations of the second computer systems in a second region different from the first region concurrently with content that is shared in the communication session. In some embodiments, the computer system displays the representations of the second computer system (e.g., a representation of a shared content item) such that it partially occludes a representation of the one or more participants of the video communication session when the representation of the one or more participants is a non-spatial representation.

### CROSS-REFERENCE TO RELATED APPLICATIONS

This application claims the benefit of U.S. Provisional Application No. 63/515,120, filed Jul. 23, 2023, and U.S. Provisional Application No. 63/594,820, filed Oct. 31, 2023, the contents of which are incorporated herein by reference in their entireties for all purposes.

### TECHNICAL FIELD

The present disclosure relates generally to computer systems that provide computer-generated experiences, including, but not limited to, electronic devices present content shared in a communication session with other computer systems.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics. In some embodiments, computer systems present content and participate in communication sessions with other computer systems in augmented reality environments.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display (HMD), a display, projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system participates in a communication session with one or more second computer systems. In some embodiments, while participating in the communication, the computer system displays representations of one or more of the second computer systems participating in the communication session in a first region of an environment. In some embodiments, in response to receiving an input corresponding to a request to share content in the communication session with the one or more second computer systems, the computer system displays the content and displays representations of one or more of the second computer systems participating in the communication session in a second region of the environment different from the first region. In some embodiments, the second region is proximate to the content.

In some embodiments, an in accordance with one or more criteria that includes a determination that a representation of one or more participants associated with the communication session is a non-spatial representation, the computer system displays a representation of a shared content item within a three-dimensional environment such that the representation of the shared content item is displayed in front of, and partially occludes the representation of the one or more participants with respect to the viewpoint of the user of the computer system. In some embodiments, once the representation of the shared content item is initially displayed at a location within the three-dimensional environment such that it partially occludes the representation of the one or more participants, the computer system can move either representation based on detected user inputs and detected motion of one or more portions of the user's body.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figs.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7V illustrate examples of a computer system displaying representations of second computer systems included in a communication session and/or content in an environment in accordance with some embodiments.

FIG. 8 is a flow diagram illustrating methods of displaying representations of second computer systems included in a communication session and/or content in an environment in accordance with some embodiments.

FIGS. 9A-9J illustrates examples of a computer system displaying representations of one or more participants included in a communication session and/or shared content in an environment in accordance with some embodiments.

FIG. 10 is a flow diagram illustrating methods of displaying representations of shared content items included in a communication session in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system participates in a communication session with one or more second computer systems. In some embodiments, while participating in the communication, the computer system displays representations of one or more of the second computer systems participating in the communication session in a first region of an environment. In some embodiments, in response to receiving an input corresponding to a request to share content in the communication session with the one or more second computer systems, the computer system displays the content and displays representations of one or more of the second computer systems participating in the communication session in a second region of the environment different from the first region. In some embodiments, the second region is proximate to the content. In some embodiments, while participating in the communication session, the computer system displays representations of one or more participants in the video communication session and displays one or more representations of shared content such that when initially displayed the representations of the shared content items partially occlude the one or more representations of the one or participants, thereby providing the user of the computer system with a visual indication that the one or more representations of shared content items is associated with the same video communication session as the one or more representations of the one or more participants.

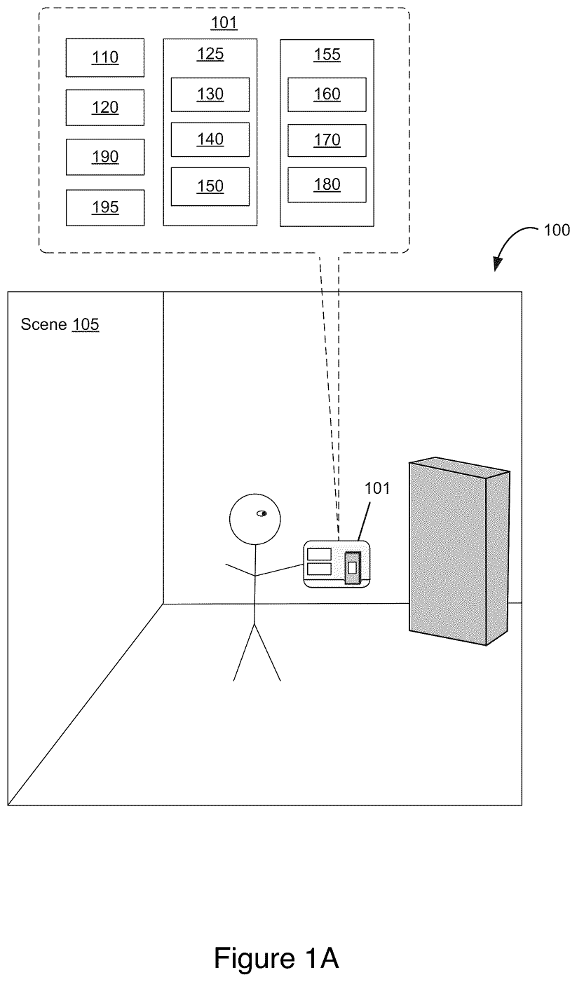

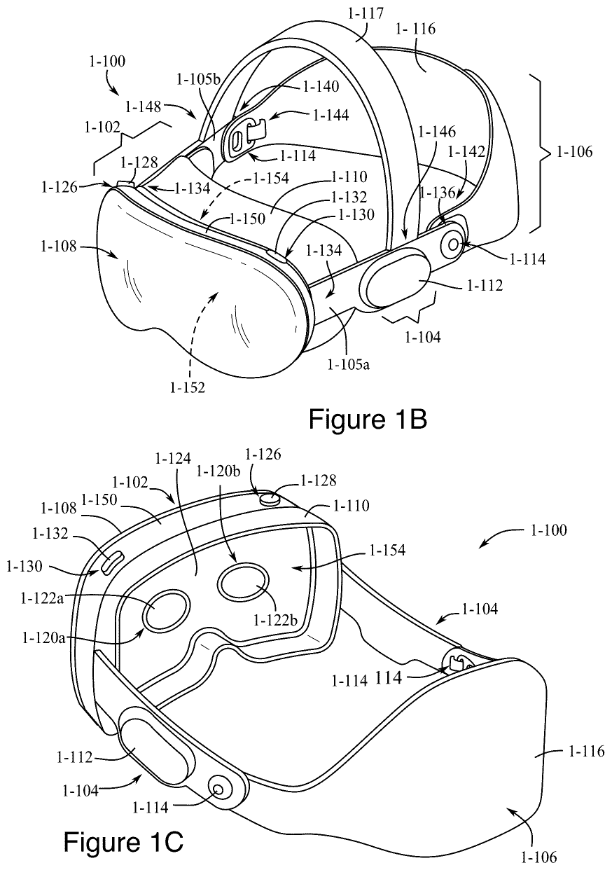

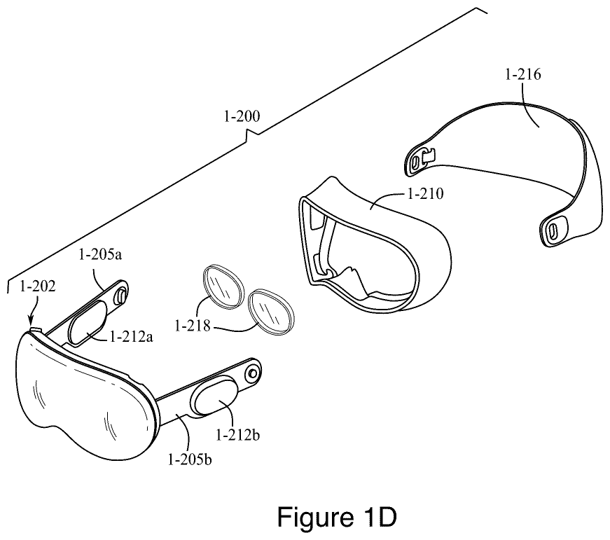

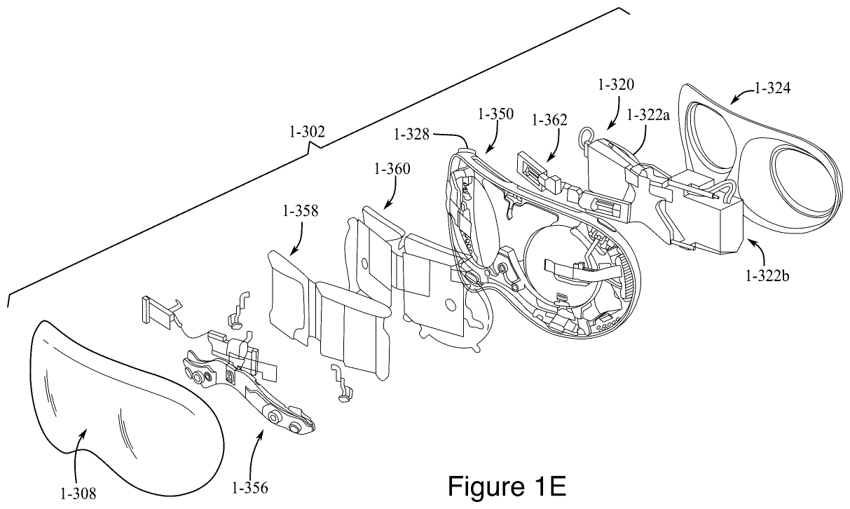

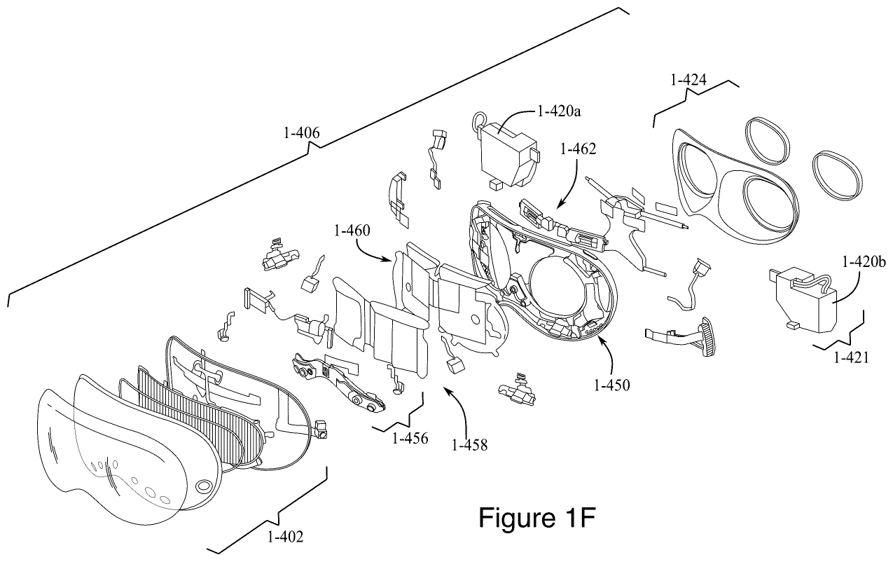

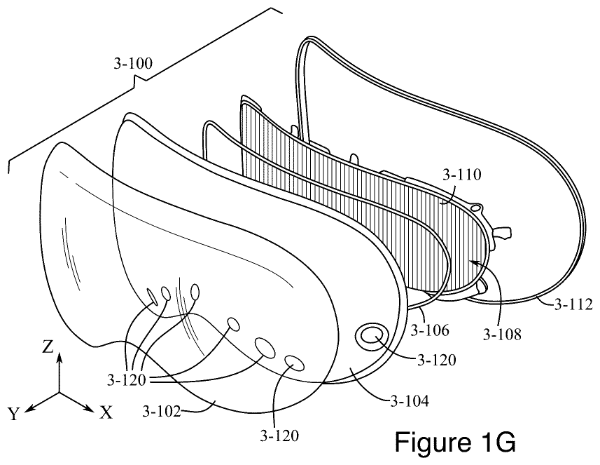

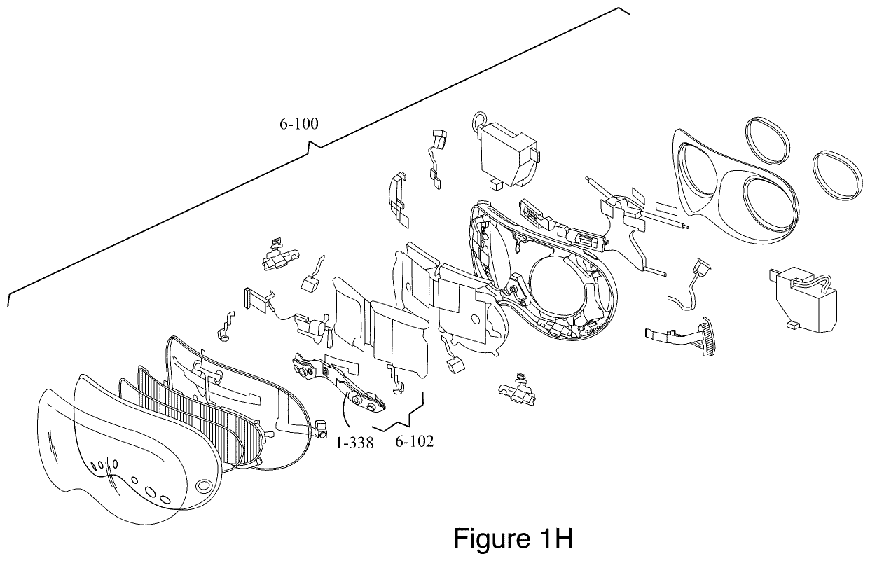

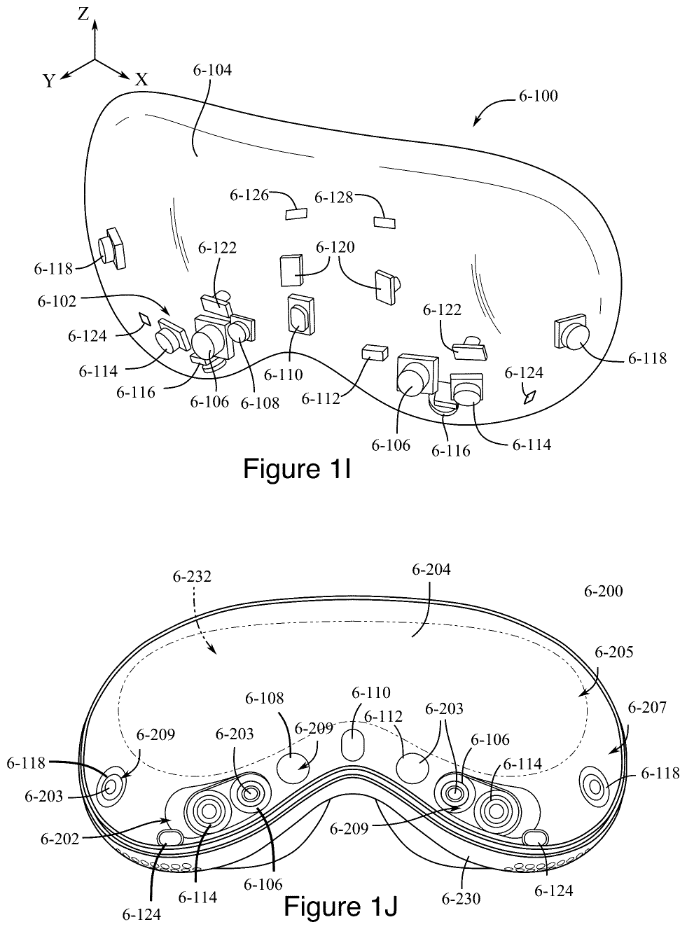

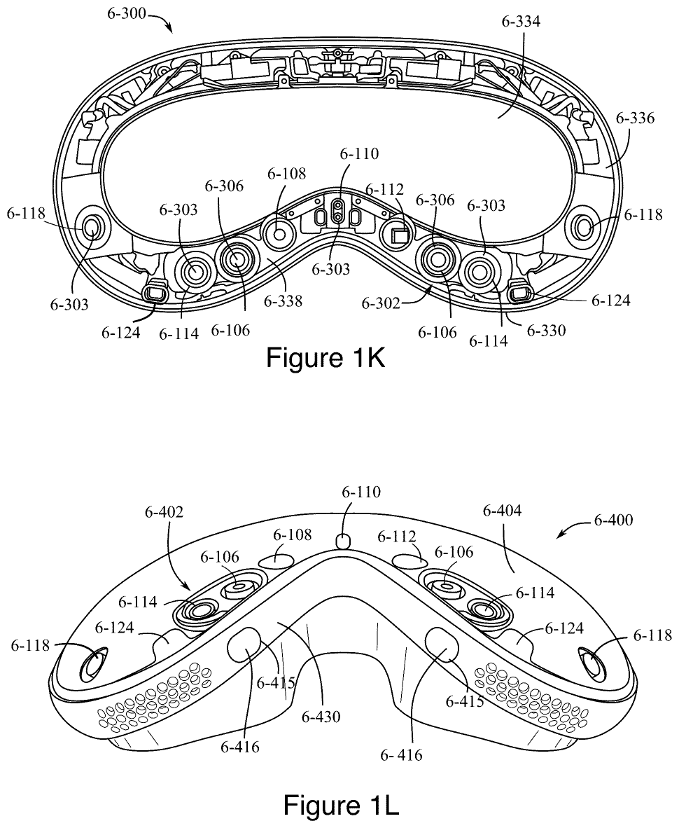

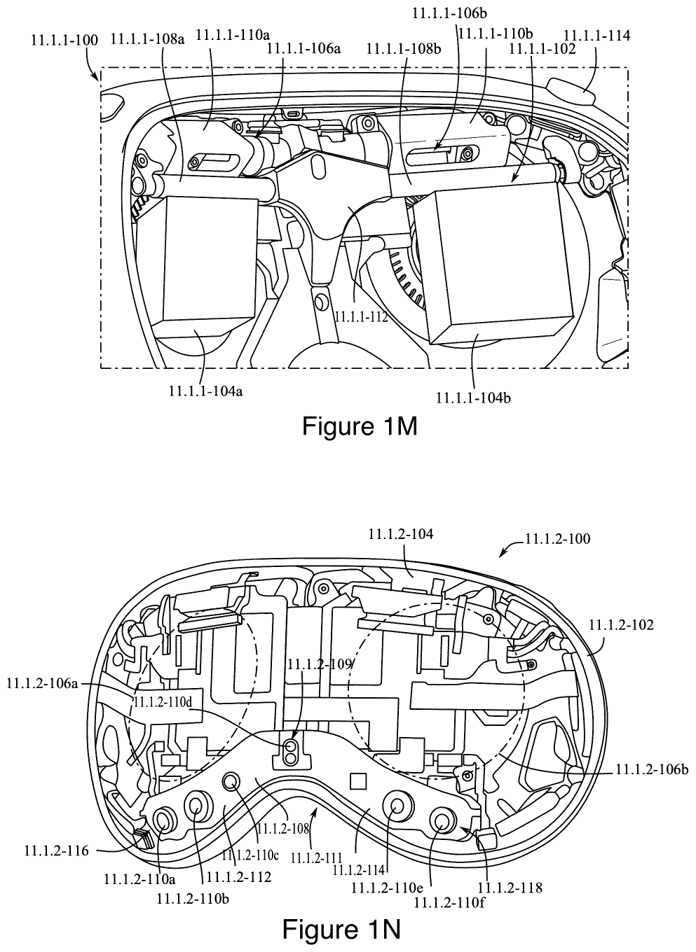

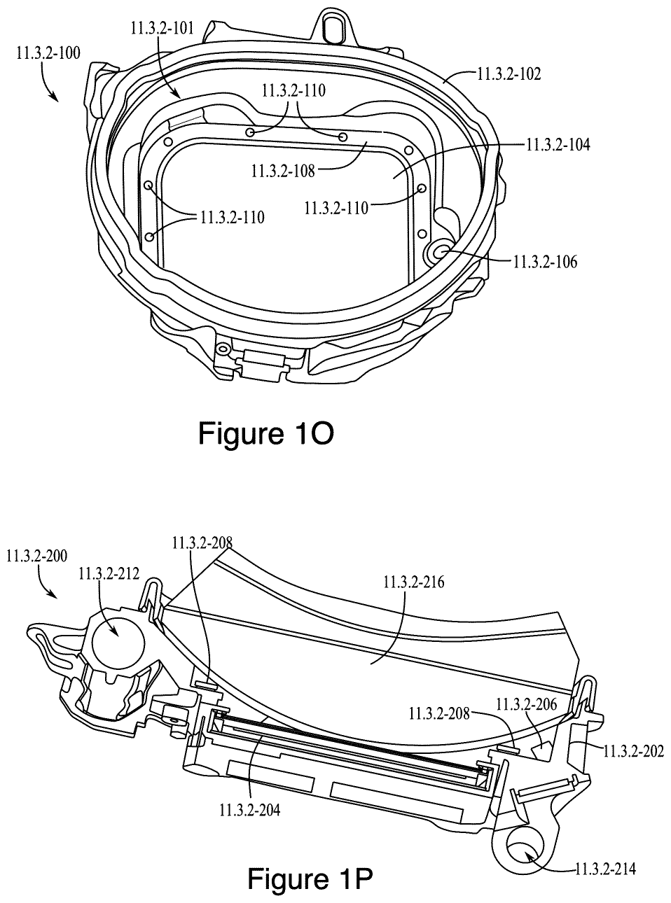

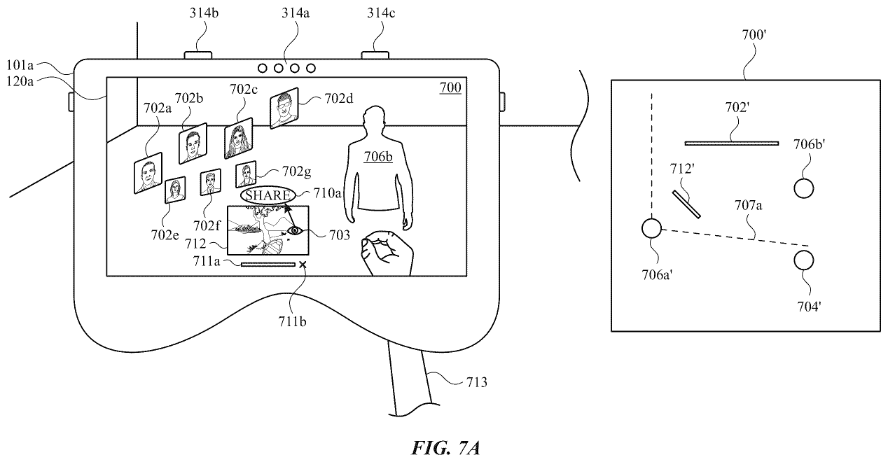

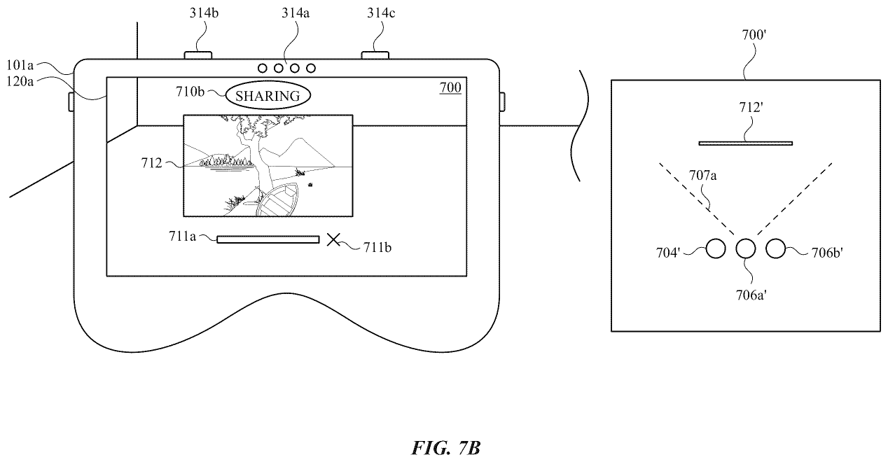

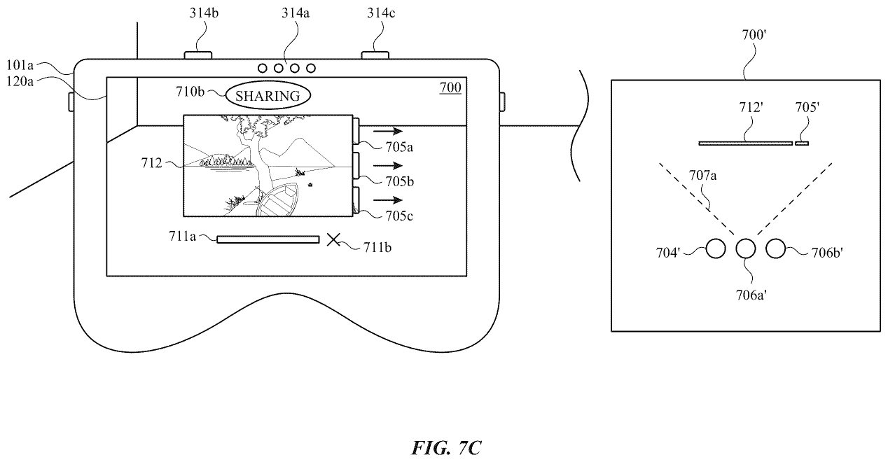

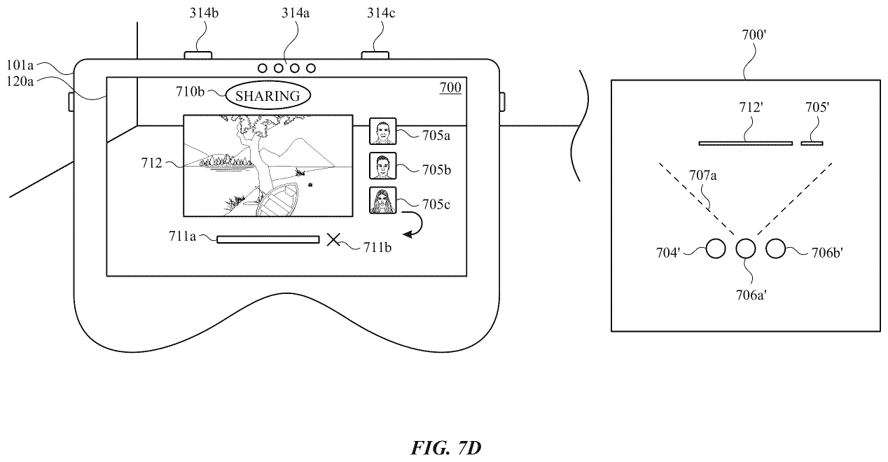

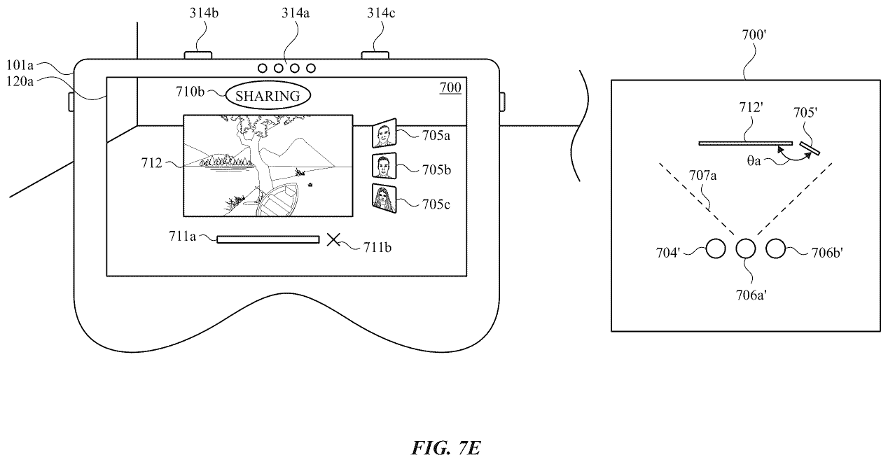

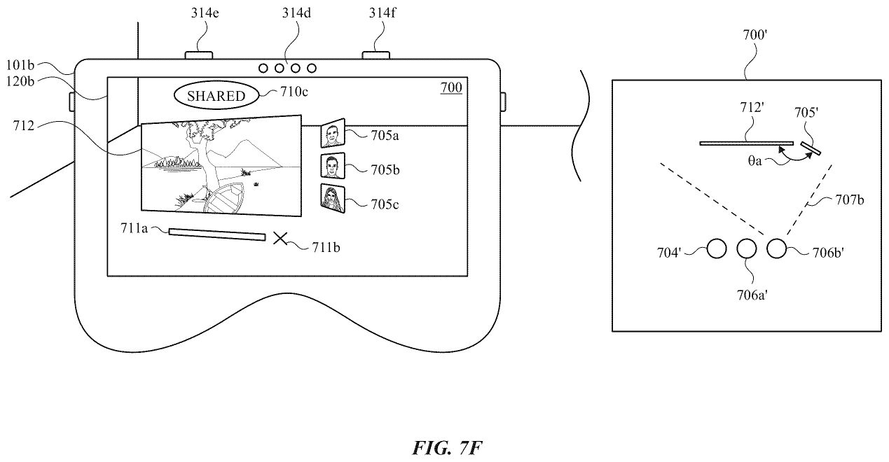

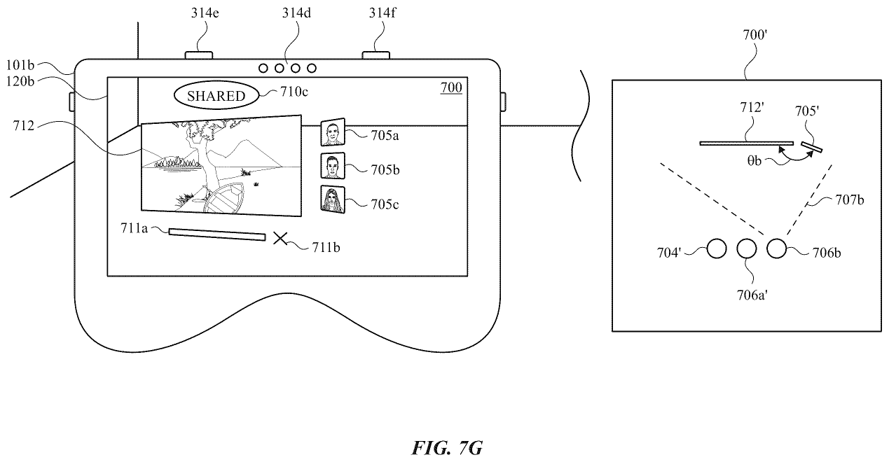

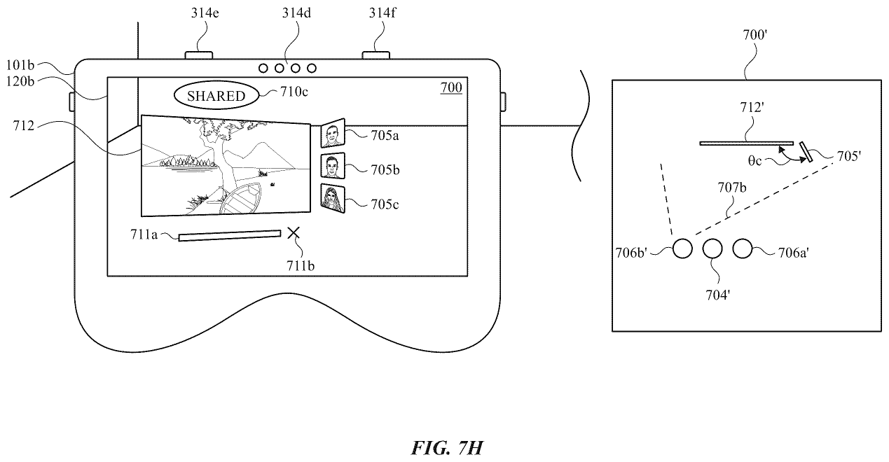

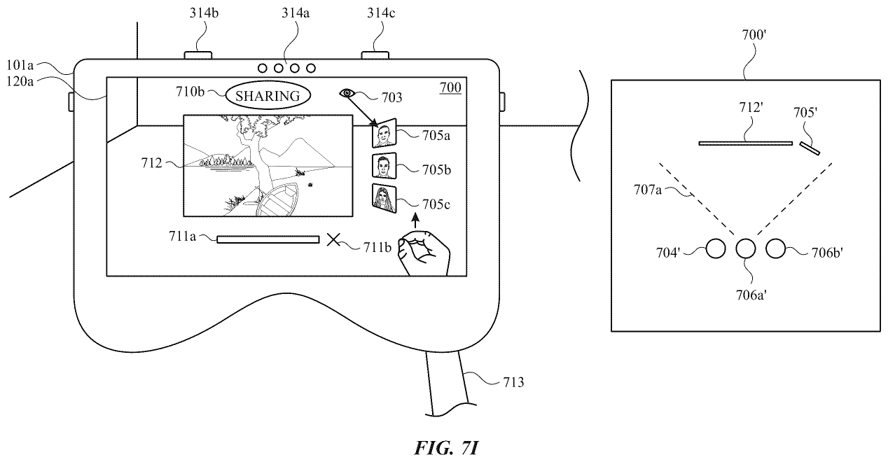

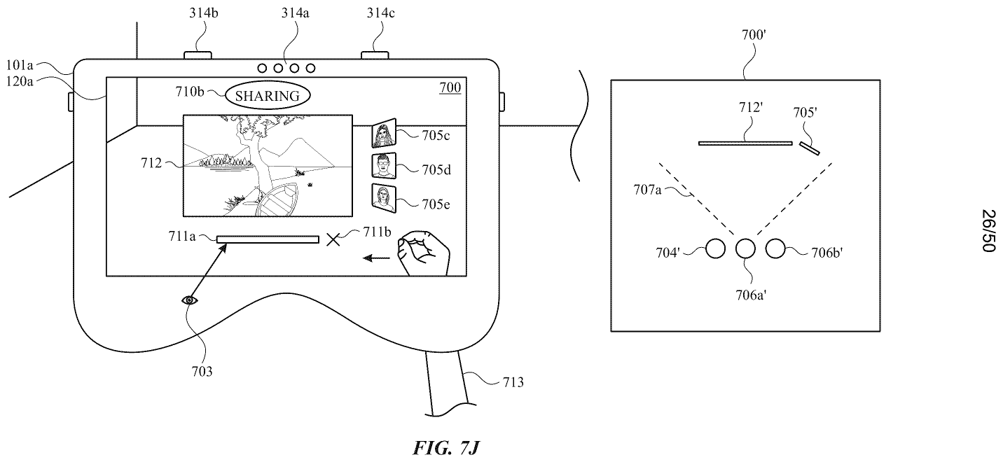

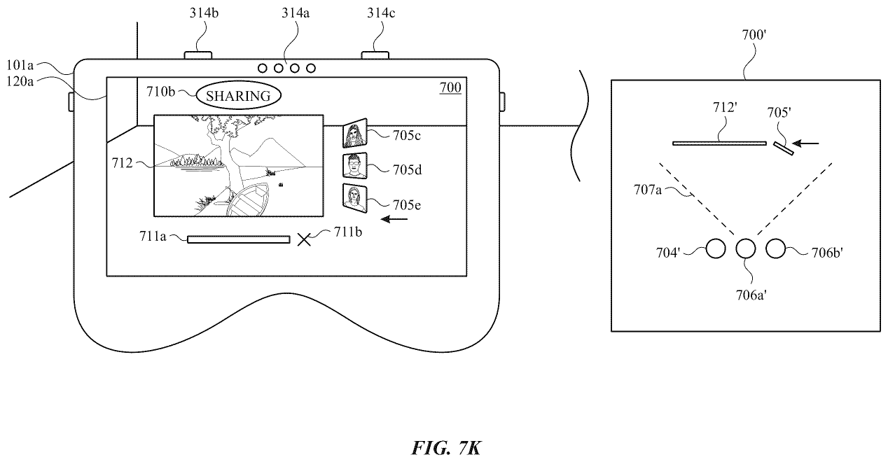

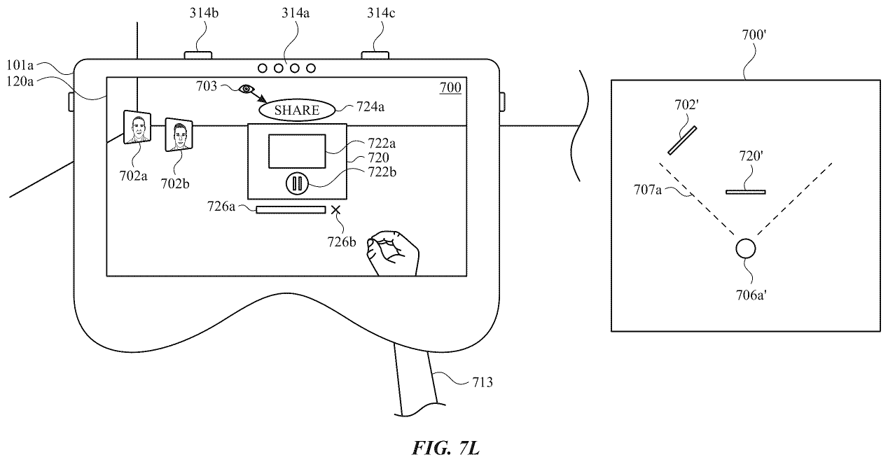

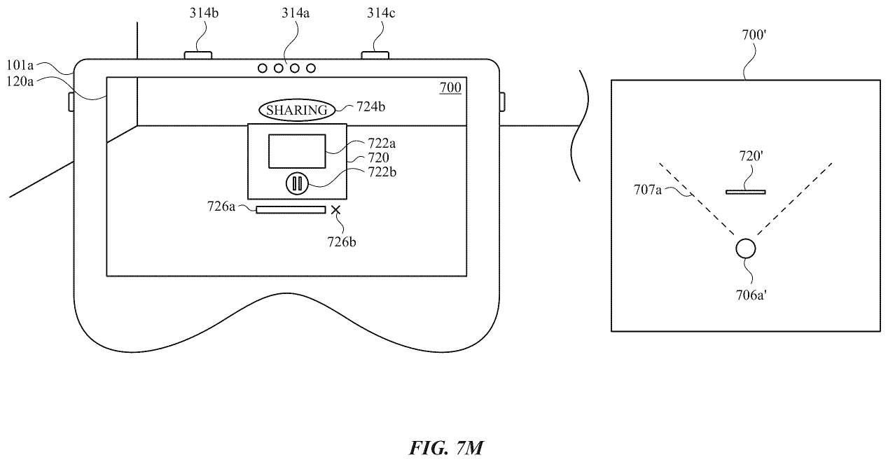

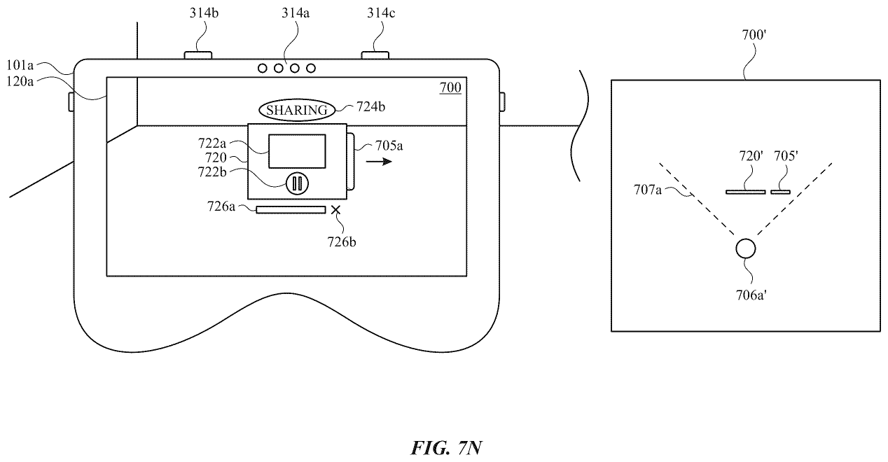

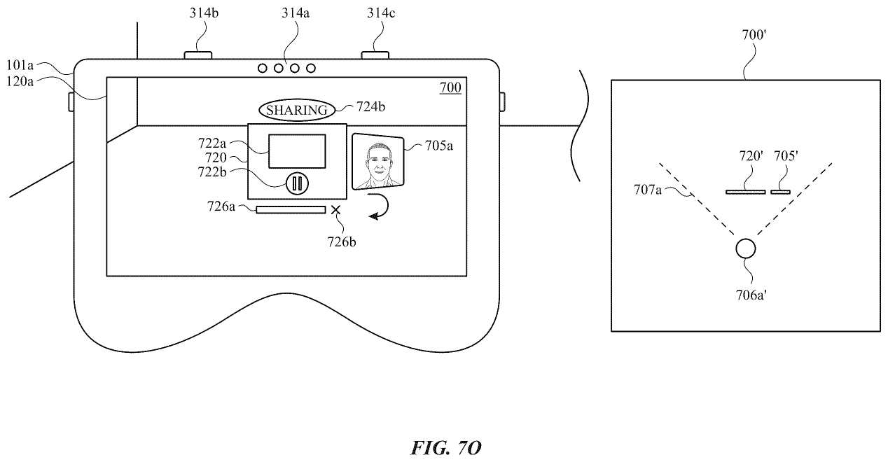

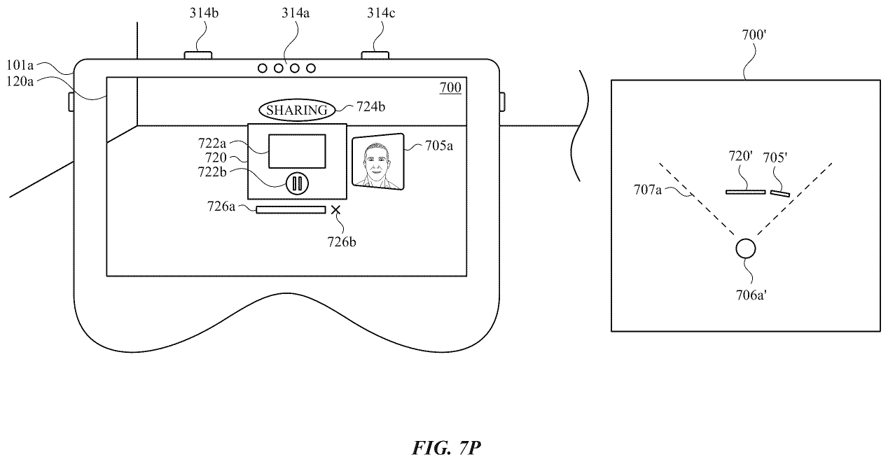

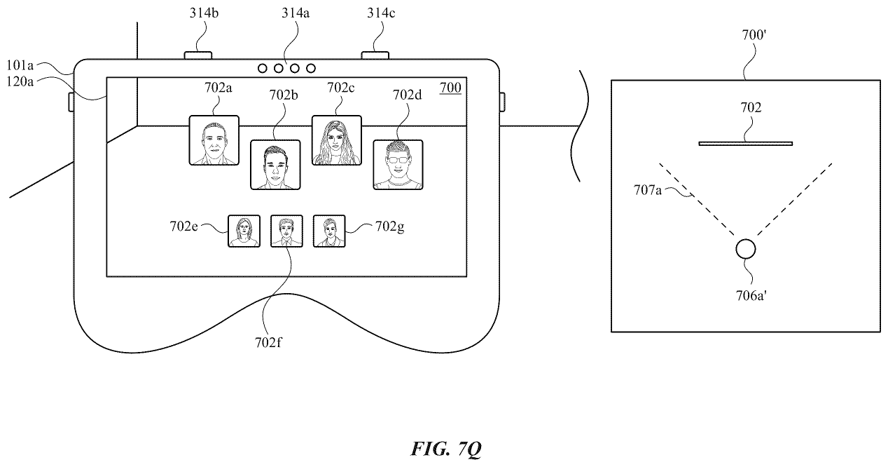

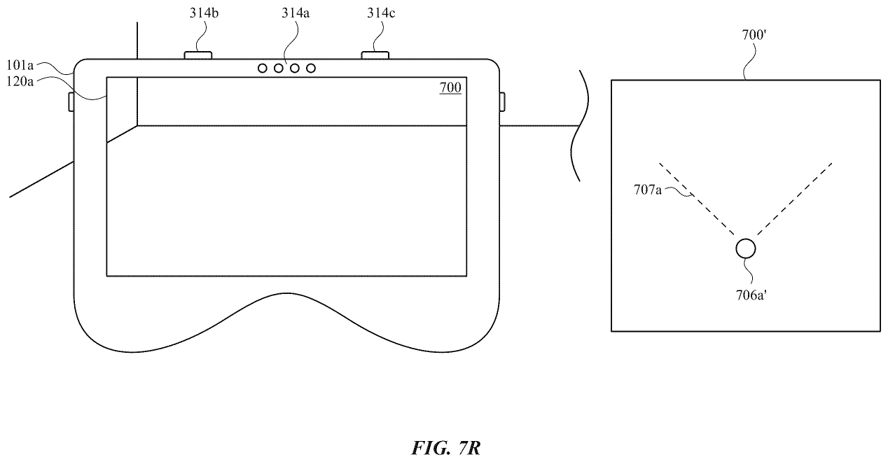

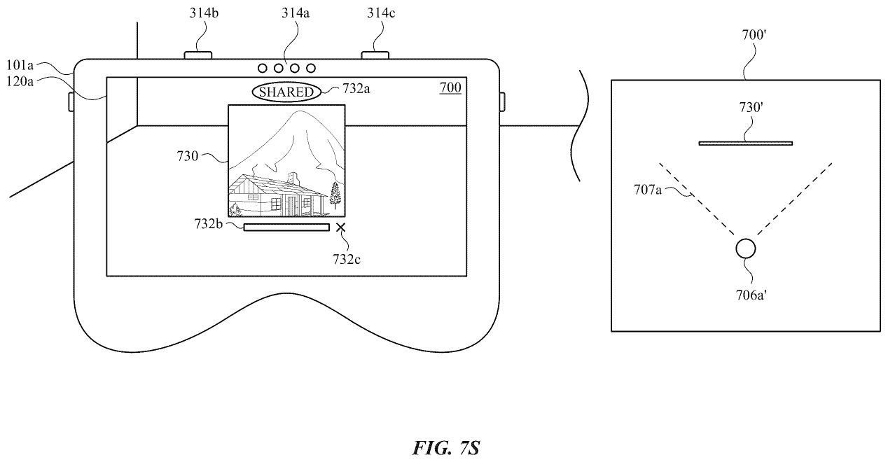

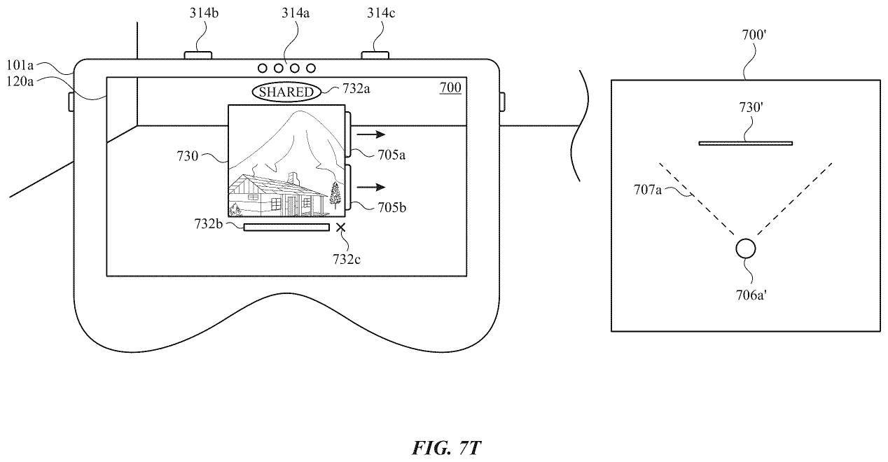

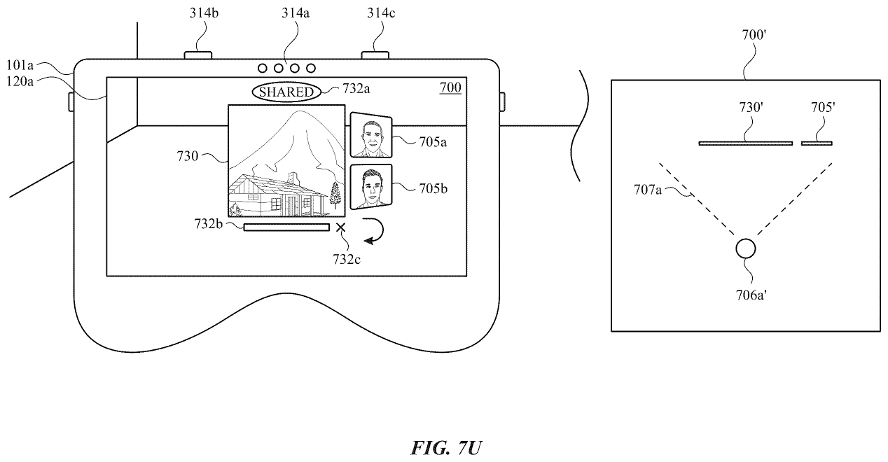

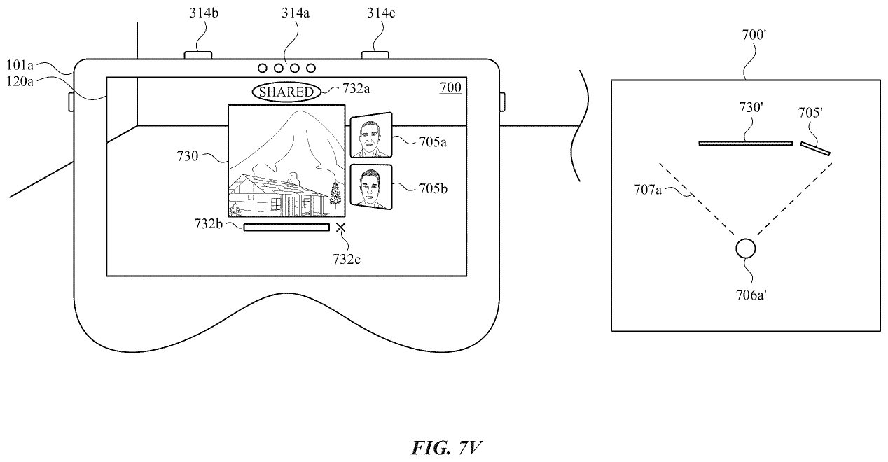

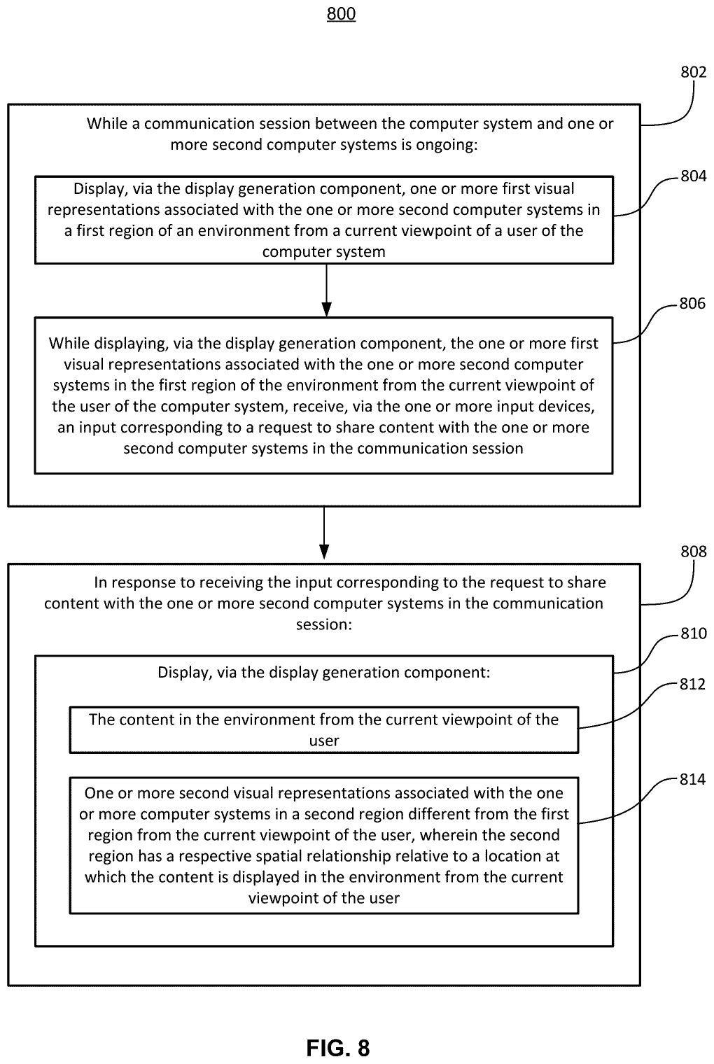

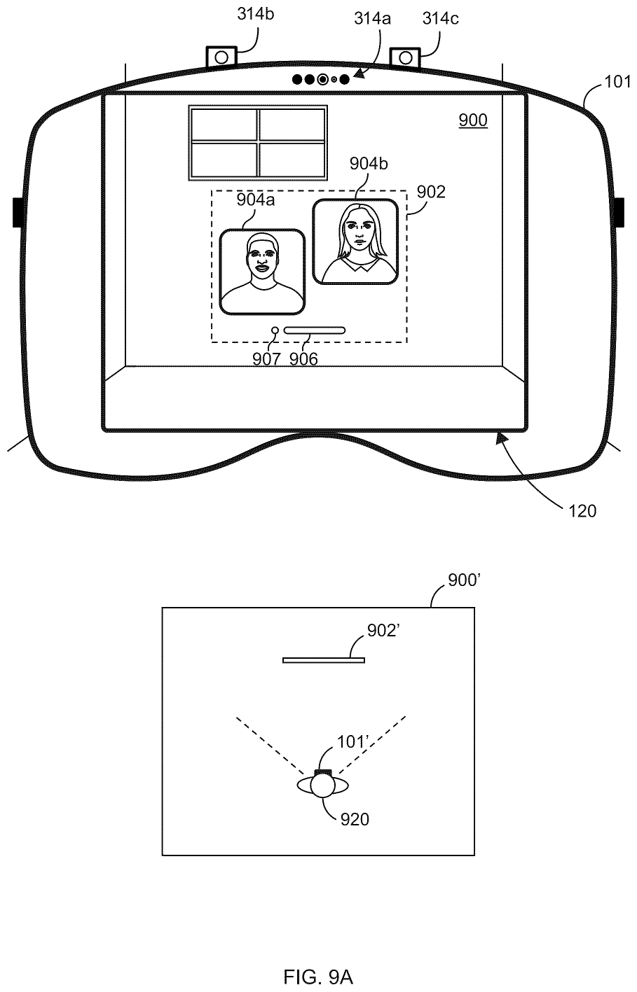

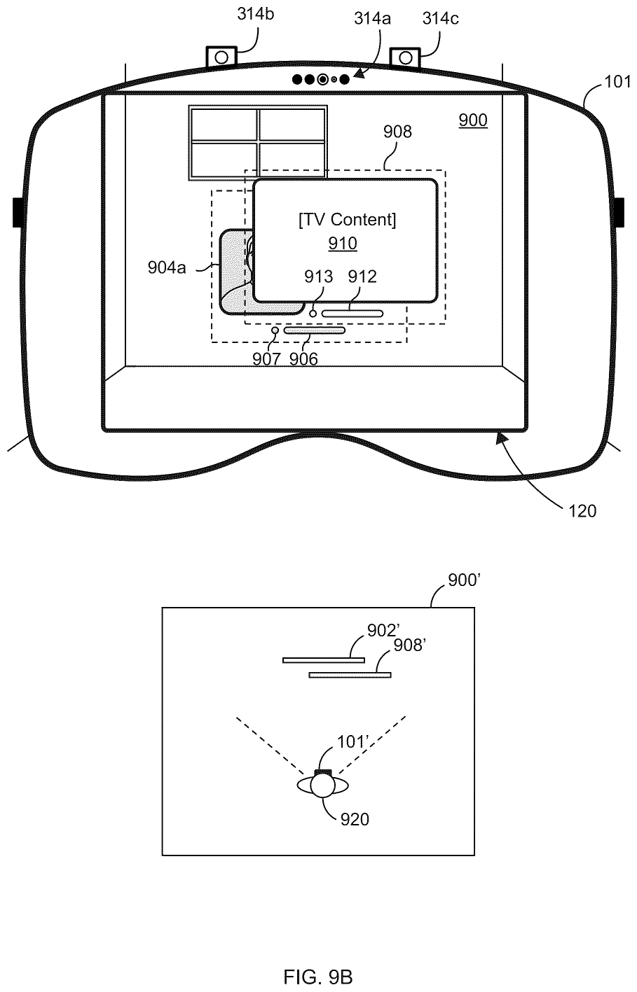

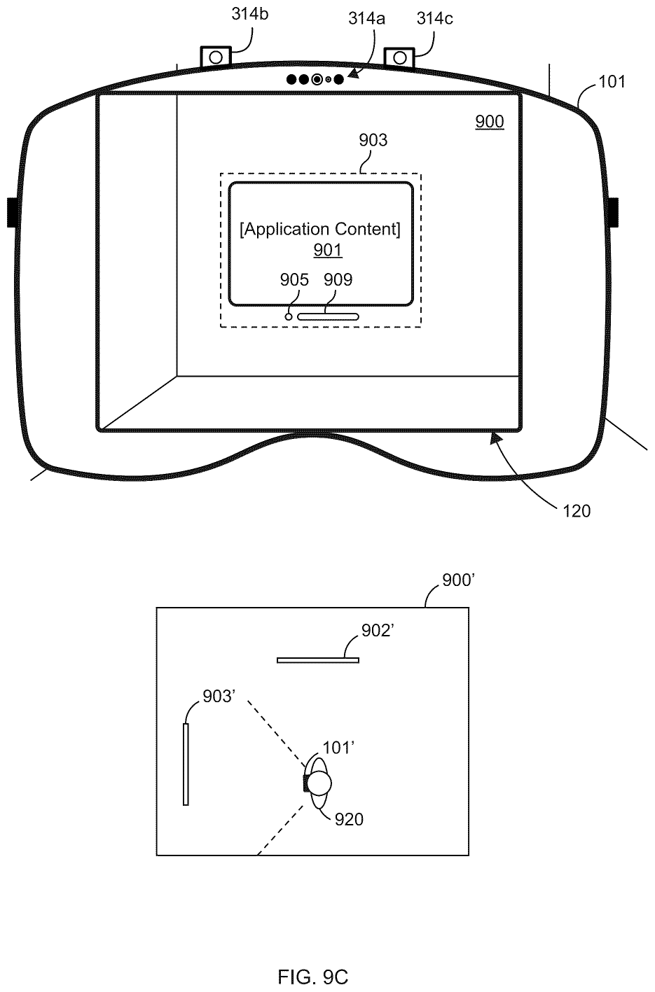

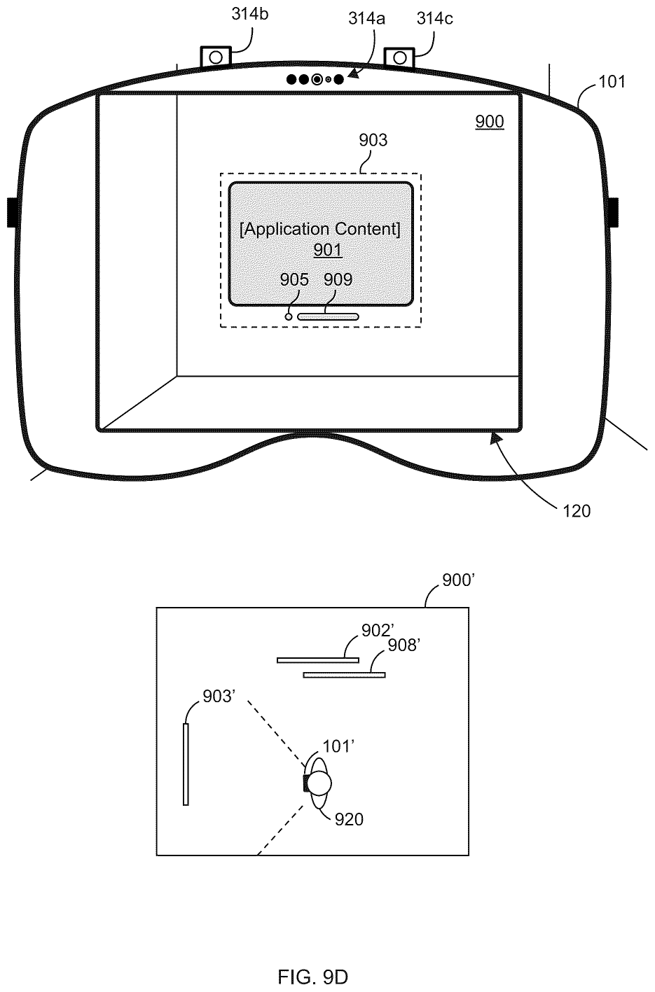

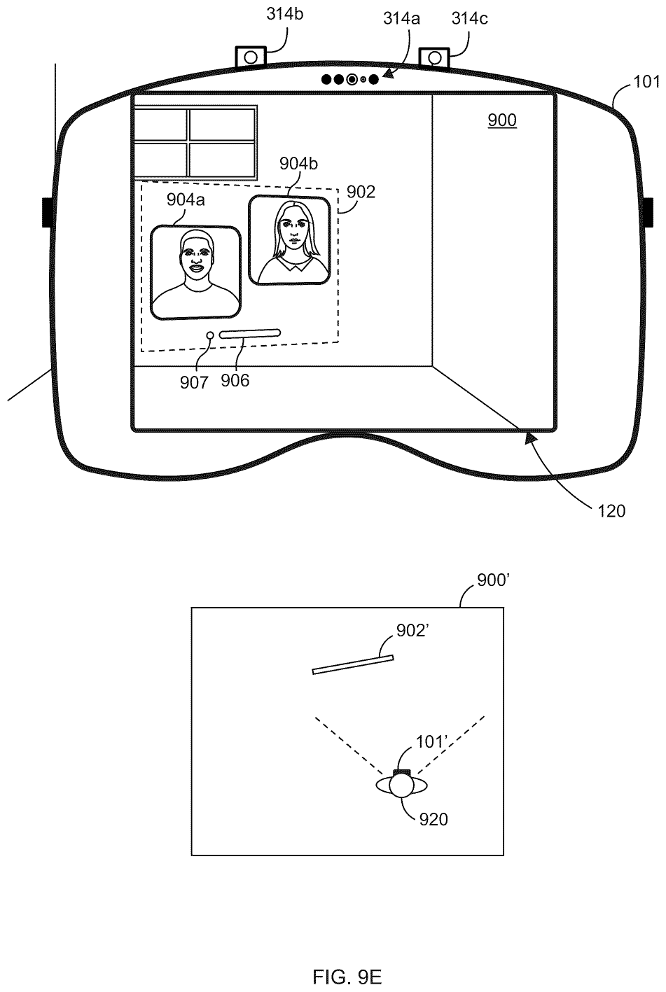

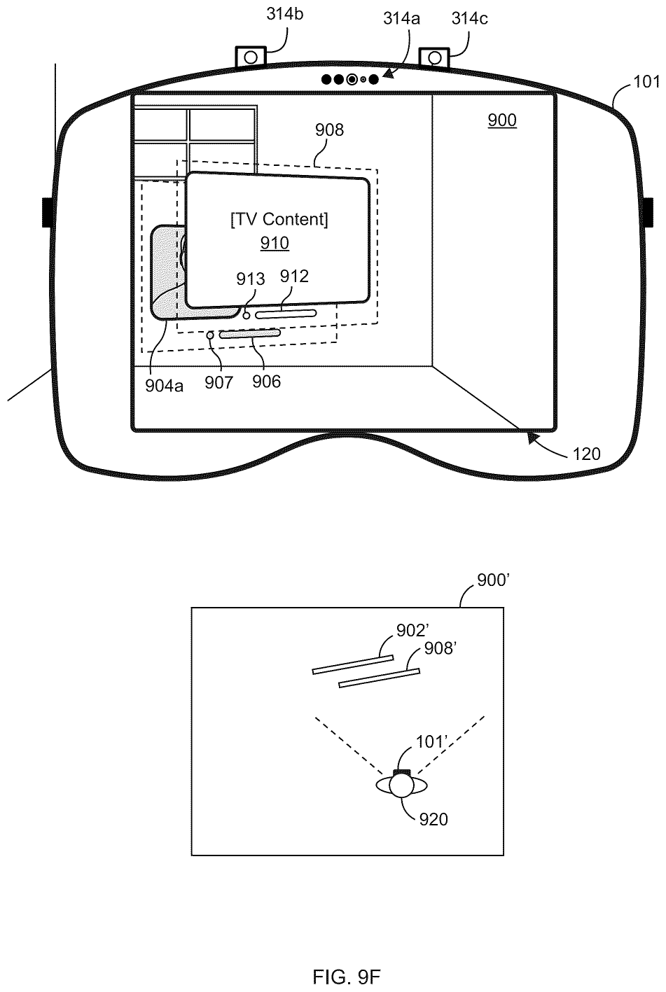

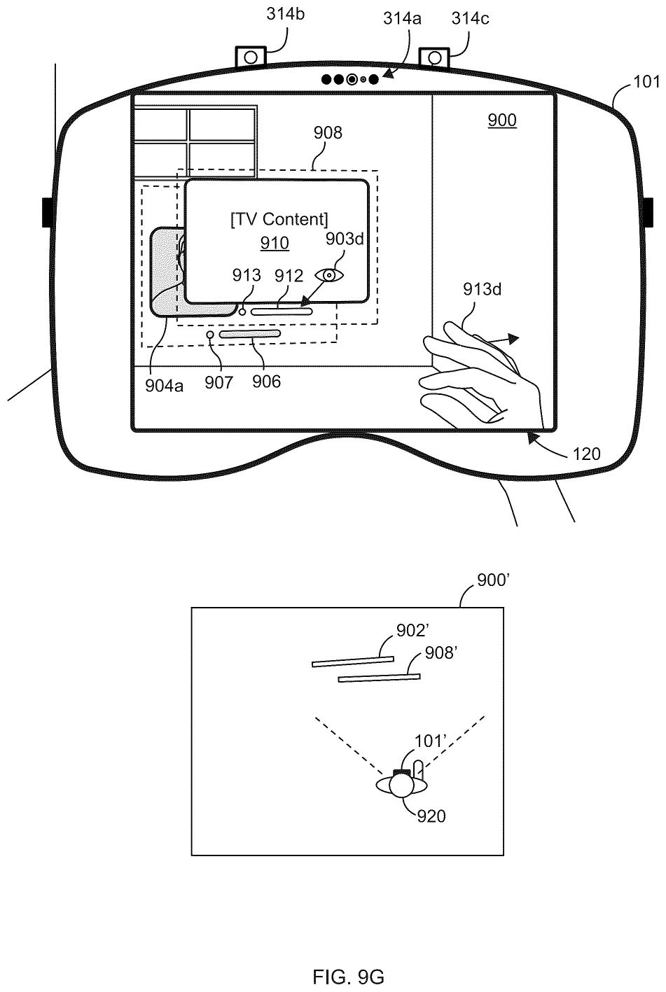

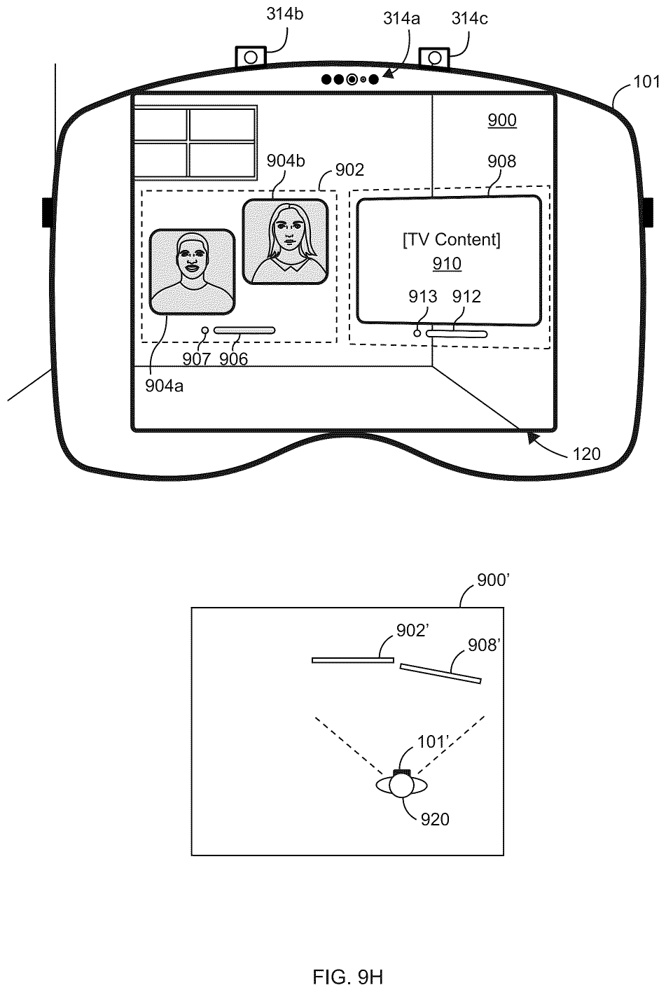

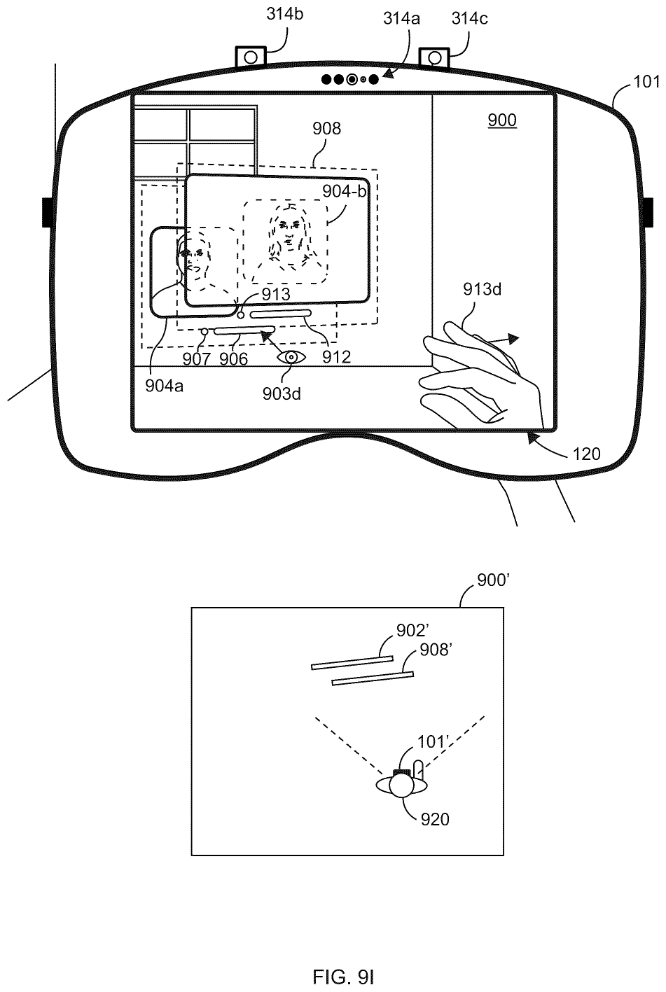

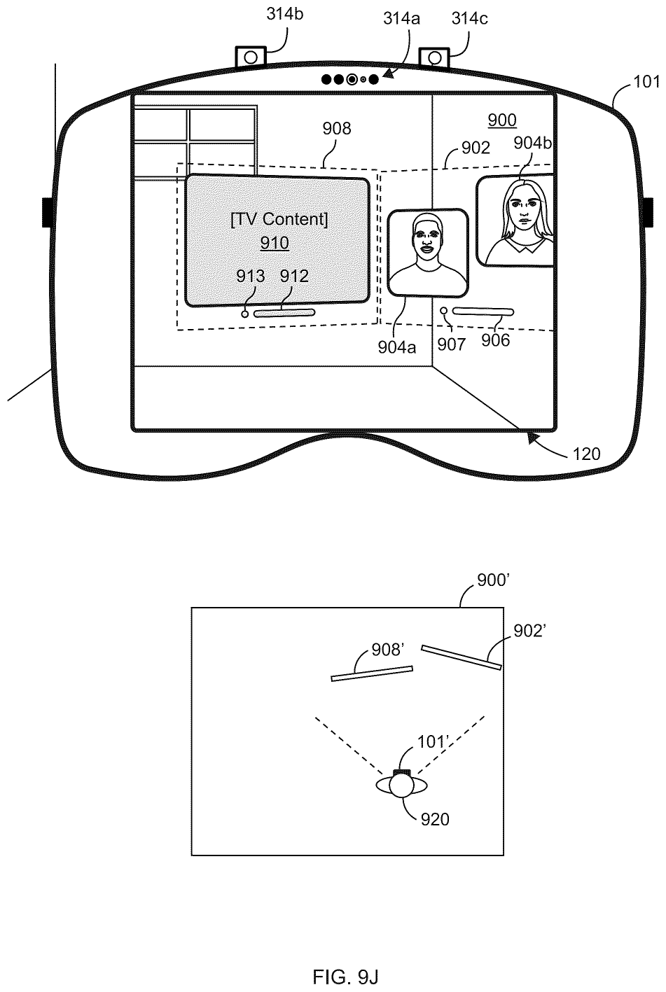

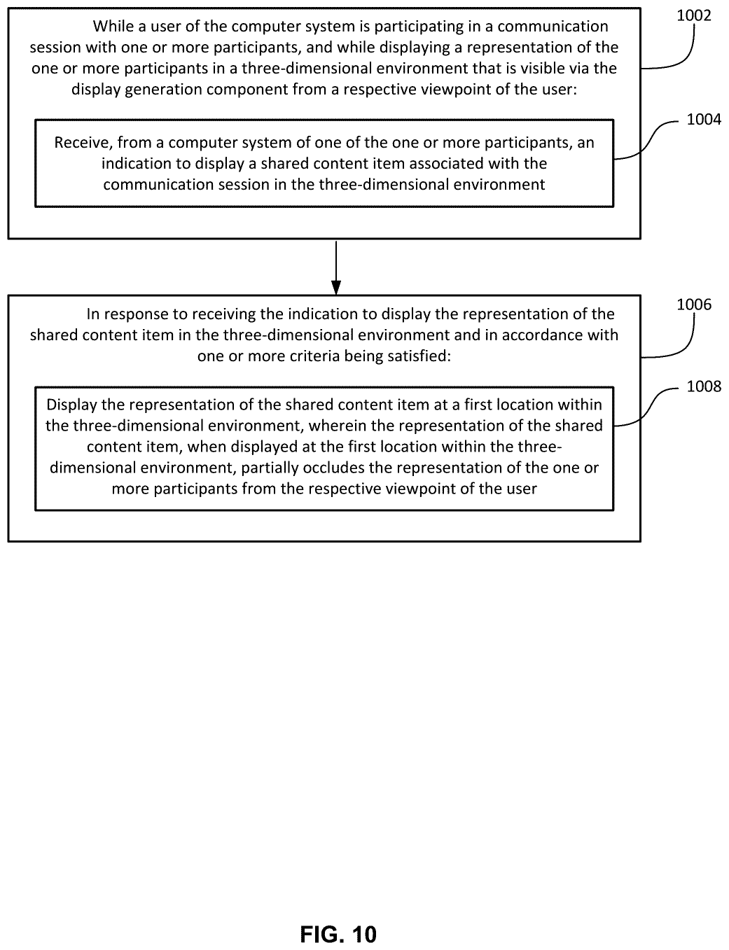

FIGS. 1A-6 provide a description of example computer systems for providing XR experiences to users (such as described below with respect to methods 800 and 1000). FIGS. 7A-7V illustrate example techniques for displaying representations of second computer systems included in a communication session and/or content in an environment in accordance with some embodiments. FIG. 8 depicts a flow diagram of a process for displaying representations of second computer systems included in a communication session and/or content in an environment in accordance with some embodiments. The user interfaces in FIGS. 7A-7V are used to illustrate the processes in FIG. 8. FIGS. 9A-9J illustrate example techniques for displaying representations of shared content items in a communication session and/or representations of one or more participants of a video communication session in accordance with some embodiments. FIG. 10 depicts a flow diagram of a process for displaying representations of shared content items in a communication session and/or representations of one or more participants of a video communication session in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

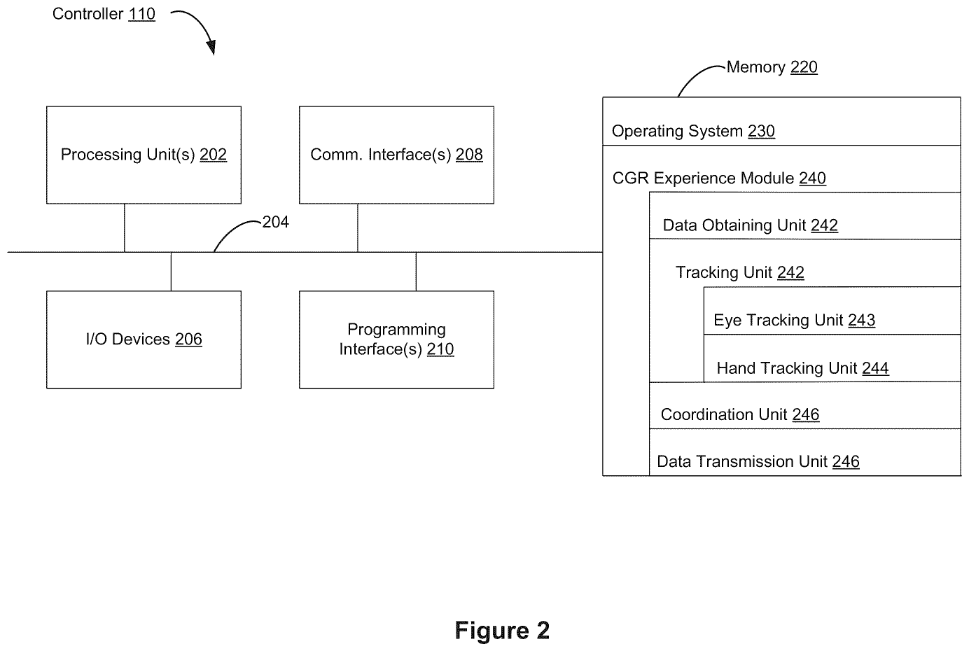

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

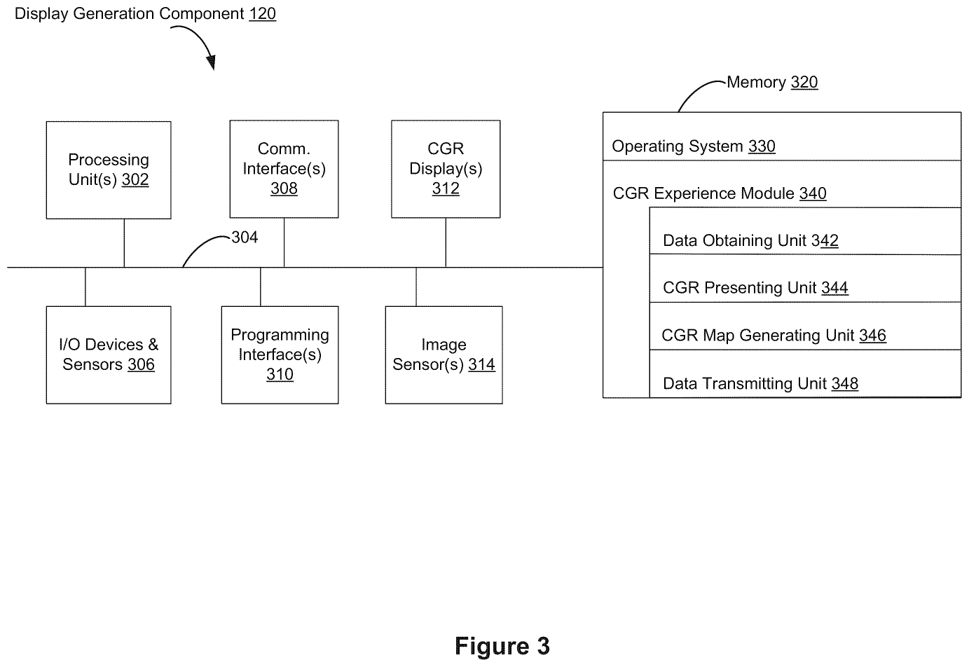

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, cither alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, cither alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent Figs. referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent Figs. and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, cither alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other Figs. shown and described herein. Likewise, any of the features, components, and/or parts, including the arrangements and configurations thereof shown and described with reference to any other Fig. shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, cither alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

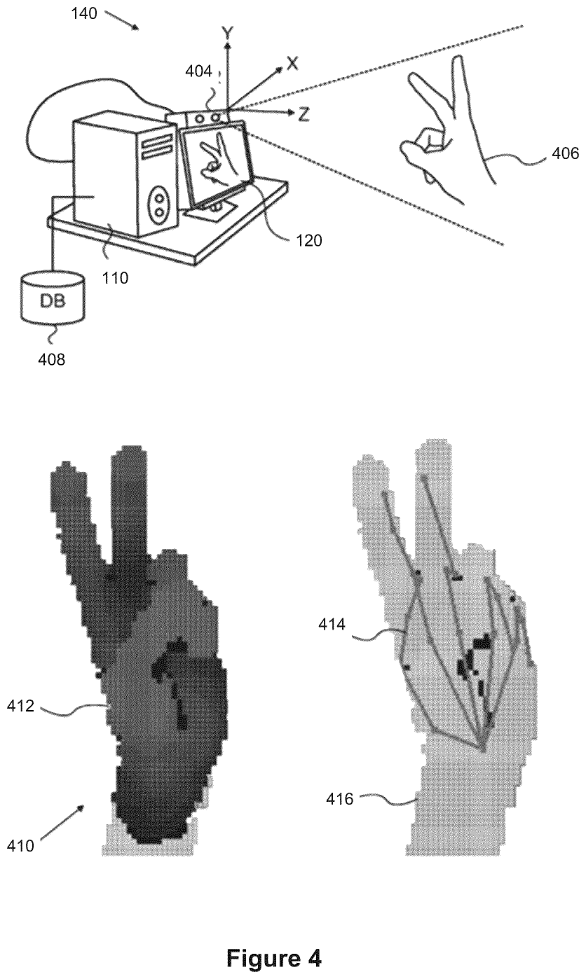

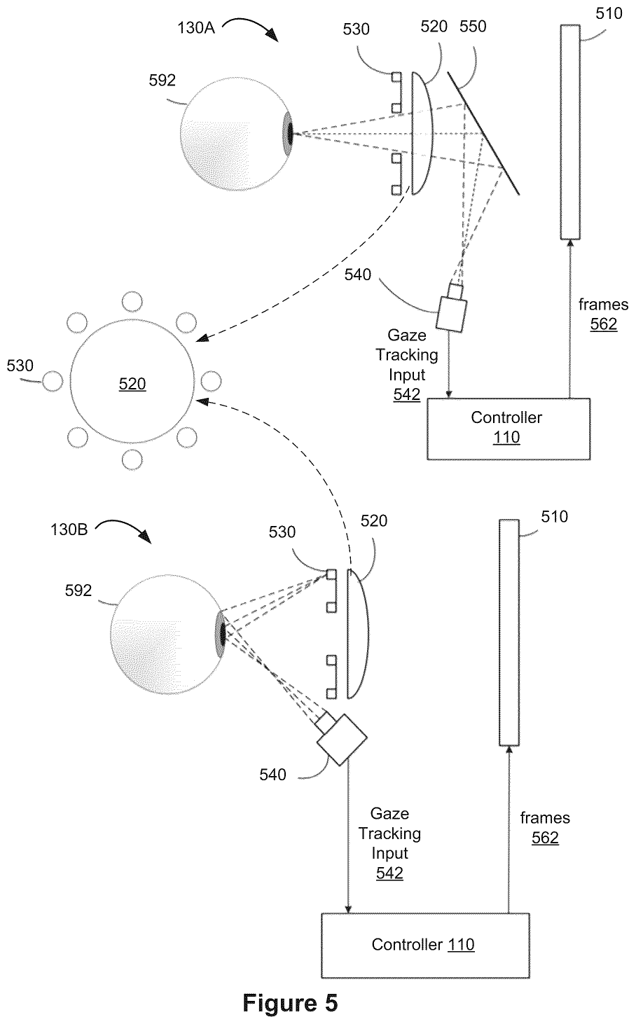

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens (cs) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

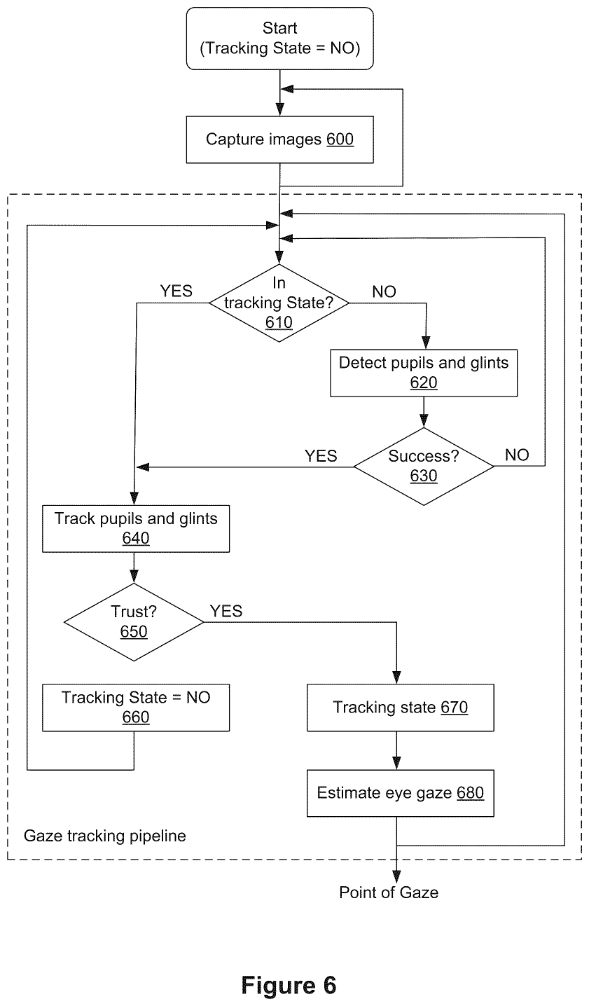

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7V illustrate examples of a computer system displaying representations of second computer systems included in a communication session and/or content in an environment in accordance with some embodiments.

FIG. 7A illustrates a computer system 101a displaying, via a display generation component 120a, a three-dimensional environment 700 (e.g., a three-dimensional user interface). It should be understood that, in some embodiments, computer system 101a utilizes one or more techniques described with reference to FIGS. 7A-7V in a two-dimensional environment without departing from the scope of the disclosure. As described above with reference to FIGS. 1-6, the computer system 101a optionally includes a display generation component (e.g., a head-mounted display) and a plurality of image sensors 314a (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the computer system displays the user interface or three-dimensional environment to the user, and uses sensors to detect the physical environment and/or movements of the user's hands (e.g., external sensors facing outwards from the user) such as movements that are interpreted by the computer system 101a as gestures such as air gestures, and/or gaze of the user (e.g., internal sensors facing inwards towards the face of the user).

FIG. 7A illustrates a view of the environment 700 from a viewpoint of the user of the computer system 101a in the environment 700 and a top-down view of the environment 700′. In some embodiments, the environment 700 is a three-dimensional environment in which objects included in the environment 700 have associated positions in three dimensions. For example, the view of the environment 700 via display generation component 120a captures the positions of various objects in two dimensions (e.g., x, y) and the top-down view of the environment 700′ captures positions of various objects in a different two dimensions (e.g., y, z).

In some embodiments, the three-dimensional environment 700 includes a view of the physical environment of the computer system 101a. For example, real walls and a real floor in the physical environment are visible in environment 700 presented via display generation component 120a. As described in more detail herein, the portions of the real environment are displayed using passthrough techniques in some embodiments.

In the example of FIG. 7A, the computer system 101a presents representations 702a-g and 706b of one or more second computer systems included in a communication session with the computer system 101a. In some embodiments, the communication session includes transmitting and receiving audio captured at the computer systems participating in the communication session. In some embodiments, the communication session includes transmitting and receiving video captured at the computer systems participating in the communication session. For example, one or more of representations 702a through 702g include video captured at respective second computer systems in the communication session. In some embodiments, one or more computer systems participating in the communication session, optionally including computer system 101a, capture video to enable other computer systems to present an animated avatar of the user of the respective computer system. For example, the other computer systems participating in the communication session present video that includes the avatar of the user of a respective computer system moving in manners corresponding to movements of the user of the respective computer system captured in real time by the computer system. For example, representation 706b is a three-dimensional avatar of a second computer system participating in the communication session that moves in accordance with movements of the user of the second computer system captured by the second computer system during the communication session. As another example, one or more of representations 702a through 702g include simulated video of one or more avatars of one or more second computer systems that move in accordance with movements of the users of respective second computer systems captured with video during the communication session. Additionally or alternatively, in some embodiments, one or more of representations 702a through 702g include a still image associated with a respective second computer system, thus allowing one or more computer systems to participate in the communication session without sharing video.

As shown in FIG. 7A, in some embodiments, the computer system 101a displays representations 702a through 702d at a larger size than the size of representations 702e through 702g. In some embodiments, representations 702a through 702d correspond to second computer systems that have participated in the communication session more than other second computer systems in the communication session. For example, these second computer systems have users that have talked more times, for longer, and/or more recently than users of other second computer systems in the communication session, as described in more detail below with reference to method 800. In some embodiments, as the communication session continues and the amount of participation of users of various second computer systems changes, the computer system 101a updates the size(s) and/or position(s) of associated representations 702a through 702g accordingly, as described in more detail below with reference to method 800. In some embodiments, all of the second computer systems participating in the communication session are represented by representations 702a through 702g, 706b and/or 704′. In some embodiments, the computer system 101a forgoes presenting a representation of one or more second computer systems during the communication session. For example, there is a limit to the number of representations 702a through 702g that the computer system 101a will display concurrently during the communication session. In some embodiments, among second computer systems not represented by representations 706b and 704′, second computer systems that have participated the most correspond to representations 702a through 702d; second computer systems that have participated the least are not represented; and second computer systems that have participated less than those represented by representations 702a through 702d but more than those not represented are represented by representations 702e through 702g. In some embodiments, as the communication session continues, and the relative amounts of participation of the second computer systems changes, the computer system 101a accordingly updates which of the second computer systems are represented by representations of the size of representations 702a through 702d, represented by representations of the size of representations 702e through 702g, and/or not represented.

As described above, in some embodiments, representations 702a through 702g are optionally two-dimensional representations of respective second computer systems included in the communication session and representation 706b is a three-dimensional representation of a respective second computer system included in the communication session. In some embodiments, the second computer system associated with representation 706b is not additionally represented by one of representations 702a through 702g, and representations 702a through 702g are associated with unique ones of the second computer systems.

In some embodiments, the computer system 101a displays representation 706b at a location in the environment 700 associated with the second computer system corresponding to representation 706b. For example, during the communication session, the second computer system corresponding to representation 706b presents environment 700 from the location in the environment associated with the second computer system corresponding to representation 706b, including displaying a representation of computer system 101a at the location in environment 700 associated with computer system 101a. In some embodiments, the computer system 101a presents environment 700 from the location in the environment 700 associated with the computer system 101a. For example, top-down view of environment 700′ includes a representation 706a′ of the computer system 101a indicating the location in the environment 700′ associated with the computer system 101a and a representation 706b′ of the second computer system corresponding to representation 706b indication the location in the environment 700′ associated with the second computer system corresponding to representation 706b. In some embodiments, computer system 101a and the second computer system corresponding to representation 706b have a shared spatial truth when respectively presenting environment 700. In some embodiments, the top-down view of the environment 700′ further includes a representation 704′ of another second computer system participating in the communication session while presenting environment 700. Because the location of the second computer system associated with representation 704′ is outside of the field of view 707a of the computer system 101a in environment 700′, computer system 101a does not present a representation of the computer system associated with representation 704′ in FIG. 7A.

In some embodiments, the second computer systems associated with representations 702a through 702g do not share environment 700 while participating in the communication session. In some embodiments, one or more of the second computer systems associated with representations 702a through 702g participate in the communication session without presenting a three-dimensional environment. For example, one or more of the second computer systems associated with representations 702a through 702g are not in communication with three-dimensional display generation components. For example, one or more of these computer systems are smartphones, tablets, and/or computers in communication with two-dimensional display generation components (e.g., monitors, touch screens, or projectors). In some embodiments, one or more of the second computer systems corresponding to representations 702a through 702g present three-dimensional environments independent from environment 700. For example, one or more of these computer systems present representations of other computer systems participating in the communication session in a three-dimensional environment different from environment 700. Optionally, these second computer systems present representations of computer system 101a and the computer system corresponding to representation 706b that are similar to representations 702a through 702g. Optionally, these second computer systems present representations of computer system 101a and the computer system corresponding to representation 706b that are similar to representation 706b, but at locations in the other environment different from the locations of representations 706a′ and 706b′ in environment 700′.

In some embodiments, environment 700 includes a spatial template associated with presentation of representations 702a through 702g at computer system 101a and at the computer systems associated with representations 706b′ and 704′. For example, representations 706a′, 706b′, and 704′ are positioned in environment 700 for comfortable viewing of representations 702a through 702g, represented in the top-down view of the environment 700′ as representation 702′, concurrently with representations 706a′, 706b′, and/or 704′, such as representation 706b in environment 700. For example, representations 712a through 702g are angled towards locations in the environment 700 associated with computer system 101a and the computer systems associated with representations 706b′ and 704′.

Additionally, as shown in FIG. 7A, computer system 101a displays a user interface 712 of a content application that is not shared with other computer systems in environment 700. For example, user interface 712 is a user interface of a video content application. In some embodiments, the computer system 101a displays user interface 712 with an option 710a to share the user interface 712 with the other computer systems in the communication session, an element 711a for changing the position of user interface 712 in environment 700, and an option 711b to close user interface 172.

As shown in FIG. 7A, the computer system 101a receives an input selecting the option 710a to share the content of user interface 712 with the second computer systems in the communication session. For example, FIG. 7A illustrates the computer system detecting an air gesture including detecting the attention 703 (e.g., including gaze) of the user being directed to option 710a while detecting the user perform a pinch with hand 713. In some embodiments, in response to the input illustrated in FIG. 7A, the computer system 101a shares the contents of user interface 712 with the second computer systems participating in the communication session and updates display of environment 700, as described below. In some embodiments, the computer system 101a transitions from displaying the environment 700 as shown in FIG. 7A to displaying the environment 700 updated in accordance with sharing the content of user interface 712 in FIG. 7E with an animation illustrated in FIGS. 7B-7D.

In some embodiments, sharing the contents of user interface 712 includes enabling the second computer systems in the communication session to display the content displayed by the computer system 101a in user interface 712 and/or present audio associated with the content. In some embodiments, sharing the content in user interface 712 includes presenting the content in a manner synchronized across the computer systems participating in the communication session. For example, user interface 712 includes video content and the computer systems in the communication session present the video content in a synchronized manner. Examples of sharing other types of content are described in more detail below with reference to method 800.

FIG. 7B illustrates an example of a portion of the animated transition from not sharing the content of user interface 712 to sharing the content of user interface 712 with the other computer systems in the communication session. As described above, in response to receiving the input illustrated in FIG. 7A, the computer system 101a shares the content of user interface 712, including presenting an animated transition. In some embodiments, a portion of the animated transition, such as the beginning, includes ceasing display of representations 702a through 702g of second computer systems in the communication session. Additionally or alternatively, in some embodiments, and as shown in FIG. 7B, the computer system 101a re-arranges the environment 700 to use a spatial template associated with shared viewing of the content of user interface 712. For example, as shown in FIG. 7B, the top down view of environment 700′ includes arranging representations 704′, 706a′, and 706b′ adjacent to each other and facing user interface 712. Thus, in some embodiments, the computer system 101a updates the location at which it displays user interface 712 in the environment 700. Additionally or alternatively, in some embodiments, the computer system 101a updates the size of user interface 712. In some embodiments, because the content of user interface 712 is being shared with the communication session, the computer system 101a displays the user interface 712 with an indication 710b that the user interface 712 is being shared. In some embodiments, in response to detecting an input directed to indication 710b, the computer system 101a presents an option to cease sharing the user interface 712 with the communication session. In some embodiments, the animation continues as shown in FIG. 7C.

FIG. 7C illustrates an example of another portion of the animated transition from not sharing the content of user interface 712 to sharing the content of user interface 712. In some embodiments, the computer system 101a presents the portion of the animation illustrated in FIG. 7C after presenting the portion of the animation shown in FIG. 7B. For example, FIG. 7C illustrates movement of representations 705a through 705c of second computer systems in the communication session emerging from behind user interface 712. In some embodiments, the computer system 101a displays representations 705a through 705c parallel to user interface 712 during this portion of the animation, as shown in the top down view of environment 700′. In some embodiments, the computer system 101a displays representations 705a through 705c at an angle relative to user interface 712 while displaying the animation of the representations 705a through 705c emerging from behind user interface 712, such as the angle shown in FIG. 7E. In some embodiments, representations 705a through 705c are representations of second computer systems participating in the communication session corresponding respectively to the second computer systems represented by representations 702a through 702c in FIG. 7A. In some embodiments, representations 705a through 705c include the same content as representations 702a through 702c, respectively. Additional characteristics of representations 705a through 705c are described in more detail below, including with reference to method 800.

FIG. 7D illustrates an example of another portion of the animated transition from not sharing the content of user interface 712 to sharing the content of user interface 712. In some embodiments, the computer system 101a presents the portion of the animation illustrated in FIG. 7D after presenting the portion of the animation illustrated in FIG. 7C. In some embodiments, as shown in FIG. 7D, the animation includes the representations 705a through 705c rotating inwards from the positions shown in FIG. 7D in which representations 705a through 705c are parallel to the content of user interface 712 to the positions illustrated in FIG. 7E. In some embodiments, as described above, the animation includes movement of the representations 705a through 705c from behind user interface 712 while representations 705a through 705c are displayed at an angle from user interface 712. In some embodiments, the animation does not include rotation of representations 705a through 705c.

In some embodiments, one or more of the second computer systems also present the animation illustrated in FIGS. 7B-7D in response to receiving an indication that computer system 101a shared the content of user interface 712 with the communication session. In some embodiments, the second computer systems do not display the animation illustrated in FIGS. 7B-7D. For example, the second computer systems display a different animation or no animation at all. Similarly, in some embodiments, the computer system 101a displays an animation similar to the animation in FIGS. 7B-7D in response to receiving an indication of one of the second computer systems sharing content in the communication session. In some embodiments, the computer system 101a does not display the animation similar to the animation illustrated in FIGS. 7B-7D and instead displays a different animation or no animation at all.

FIG. 7E illustrates an example of the computer system 101a displaying representations 705a through 705c of second computer systems participating in the communication session concurrently with the content in user interface 712 that is shared with the communication session. In some embodiments, the computer system 101a displays a smaller number of representations 705a through 705c in FIG. 7E while sharing content in the communication session than the number of representations 702a through 702g displayed in FIG. 7A while not sharing content in the communication session. In some embodiments, the size and number of representations 705a through 705c in FIG. 7E corresponds to the size of user interface 712, as described in more detail below with reference to method 800. In some embodiments, the second computer systems represented by representations 705a through 705c while sharing the content of user interface 712 are selected based on amounts of participation in the communication session, as described above with reference to FIG. 7A and below with reference to method 800. In some embodiments, as the communication session continues and the amounts of participation of the various second computer systems updates, the computer system 101a updates which second computer systems are represented by representations similar to representations 705a through 705c to include computer systems that have participated the most and/or most recently. In some embodiments, while sharing the content of user interface 712, the computer system 101a displays representations 705a through 705c at the same size irrespective of relative amounts of participation in the communication session of the second computer systems associated with representations 705a through 705c. As shown in the top-down view of the environment 700′ in FIG. 7E, the computer system 101a displays representations 705a through 705c, corresponding to representation 705′, at angle θa at the conclusion of the animated transition. As shown in FIG. 7E, the angle θa is tilted inwards towards user interface 712′. As described in more details below with reference to method 800, in some embodiments, the angle θa between the user interface 712′ and the representations 705′ is selected based on the position of the computer system 101a and/or the computer systems represented by representations 704′ and 706b′ in the environment relative to the user interface 712′ and/or representations 705′.

FIG. 7F illustrates an example of one of the second computer systems 101b displaying representations 705a through 705c of second computer systems participating in the communication session concurrently with the content in user interface 712 that is shared with the communication session. As shown in FIG. 7F, in some embodiments, the second computer system 101b displays the user interface 712′ and representations 705′ with the same angle θa as the angle θa with which the computer system 101a displayed the user interface 712′ and representations 705′, although computer system 101a and second computer system 101b have different associated locations in the environment 700. In some embodiments, when the computer system 101a and second computer system 101b (e.g., and one or more additional second computer systems) display the user interface 712′ and the representations 705′ with the same angle θa, the angle θa is selected based on the positions of the computer system 101a and the second computer system 101b relative to the user interface 712′ and/or the representations 705′ in the environment. In some embodiments, displaying the user interface 712′ and representations 705′ with the same angle θa at the computer system 101a and the second computer system 101b preserves shared spatial truth between the computer system 101a and the second computer system 101b. In some embodiments, although the second computer system 101b displays the environment 700 including the same angle θa between the user interface 712′ and the representations 705′ as the angle θa with which the computer system 101a displayed the user interface 712′ and representations 705′, the presentation of the environment 700 appears different in FIG. 7F than was the case in FIG. 7E because the second computer system 101b has a different viewpoint in the environment 700 than computer system 101a. In some embodiments, the second computer system 101b displays the user interface 712 with the indication 710c that the content of user interface 712 is being shared by another computer system in the communication session, as shown in FIG. 7F.

FIG. 7G illustrates another example of one of the second computer systems 101b displaying representations 705a through 705c of second computer systems participating in the communication session concurrently with the content in user interface 712 that is shared with the communication session. As shown in FIG. 7G, in some embodiments, the second computer system 101b displays the user interface 712′ and representations 705′ with a different angle θb from the angle θa with which the computer system 101a displayed the user interface 712′ and representations 705′ because computer system 101a and second computer system 101b have different associated locations in the environment 700. In some embodiments, when the computer system 101a and second computer system 101b (e.g., and one or more additional second computer systems) display the user interface 712′ and the representations 705′ with different angles, the angle θa with which computer system 101a displays the user interface 712′ and representations 705′ is selected based on the position of the computer system 101a relative to the user interface 712′ and/or the representations 705′ and the angle θb with which the second computer system 101b displays the user interface 712′ and representations 705′ is selected based on the position of the second computer system 101b relative to the user interface 712′ and/or the representations 705′. In some embodiments, displaying the user interface 712′ and representations 705′ with different angles at the computer system 101a and the second computer system 101b improves comfort and legibility when viewing the user interface 712′ and the representations 705′. FIG. 7G includes illustration of the second computer system 101b presenting the environment 700 including the representations 705a through 705c at the angle θb indicated in the top-down view of environment 701′.

In some embodiments, when a computer system changes its position in the environment 700, that computer system updates the angle between the user interface 712′ and the representations 705′. Examples of situations in which the location in the environment of a computer system changes are described in detail below with reference to method 800, including movement of the user and/or computer system in its physical environment or the computer system receiving an input to update its position in the environment that does not include movement of the user and/or computer system. In embodiments in which the computer system 101a and the second computer system 101b display the user interface 712′ and representations 705′ with the same angle, updating the angle for one computer system in accordance with movement of that computer system updates the angle for both (or all) computer systems in the environment. In embodiments in which the computer system 101a and the second computer system 101b display the user interface 712′ and representations 705′ with different angles, updating the angle for one computer system in accordance with movement of that computer system includes maintaining the respective other angle for other computer systems in the environment.

For example, in FIG. 7H, computer system 101b has moved in the environment 700 to the location indicated by representation 706b′ in the top-down view of the environment 700′. In accordance with the movement of the second computer system 101b, second computer system 101b updates display of the environment 700 to display the user interface 712′ and representations 705′ with angle θc. In some embodiments, the computer system 101a also displays the user interface 712′ and representations 705′ with angle θc in response to receiving an indication of the movement of second computer system 101b relative to the environment 700. In some embodiments, computer system 101a maintains display of the environment without changing the angle between user interface 712′ and representations 705′, such as continuing to display the environment 700′ with angle θa between user interface 712′ and representations 705′, as shown in FIG. 7F. In some embodiments, the second computer system 101b and/or the first computer system 101a updates the angle because of the type of movement of computer system 101b. For example, second computer system 101b and/or computer system 101a updates the angle between user interface 712′ and representations 705′ in response to the second computer system 101b receiving an input requesting to automatically re-position objects in the environment 700, but would not update the angle in response to the second computer system 101b detecting movement of the second computer system 101b and/or the user of the second computer system 101b in the physical environment. Additionally or alternatively, in some embodiments, the second computer system 101b and/or the computer system 101a updates the angle between the user interface 712′ and the representations 705′ in response to the second computer system 101b detecting movement of the second computer system 101b and/or the user of the second computer system 101b in the physical environment above a threshold amount.

As shown in FIGS. 7E-7H, in some embodiments, the computer system 101a and/or the second computer system 101b displays fewer representations 705a through 705c of second computer systems in the communication session while the content of user interface 712 is being shared than the number of representations 702a through 702g of second computer systems in the communication session displayed when the content of user interface 712 was not shared, as shown in FIG. 7A. In some embodiments, the representations 705a through 705c displayed while the content of user interface 712 is being shared are scrollable to reveal representations of other second computer systems in the communication session.

For example, FIG. 7I illustrates an example of the computer system 101a receiving an input corresponding to a request to scroll the representations 705a through 705c of second computer systems in the communication session while sharing the content of user interface 712 in the communication session. In FIG. 7I, the computer system 101a detects the attention 703 (e.g., including gaze) of the user directed towards the representations 705a through 705c while detecting an air gesture that includes the user making a pinch shape with their hand 713 and moving the hand 713 while holding the pinch shape. In some embodiments, in response to detecting the input in FIG. 7I, the computer system 101a scrolls the representations 705a through 705c in accordance with the movement of the hand 713, as described in more detail below with reference to method 800 and as shown in FIG. 7J.

FIG. 7J illustrates an example of the computer system 101a displaying the environment 700 with representations 705c through 705e in response to the scrolling input illustrated in FIG. 7I. As shown in FIG. 7J, in response to the input in FIG. 7I, the computer system 101a ceases displaying representations 705a and 705b that were displayed in FIG. 7I, updates the position of representation 705c, and initiates display of representations 705d and 705c. FIG. 7J also illustrates the computer system 101a receiving an input corresponding to a request to update the position of the user interface 712 in the environment. For example, the computer system 101a detects the attention 703 of the user directed to user interface element 711a while detecting the user move their hand 713 in the pinch hand shape. In some embodiments, in response to the input illustrated in FIG. 7J, the computer system 101a updates the position of the user interface 712 and representations 705c through 705e in the environment in accordance with the input, as shown in FIG. 7K.

FIG. 7K illustrates an example of the computer system 101a updating the positions of user interface 712 and representations 705c through 705e in the environment in response to the input illustrated in FIG. 7J. In some embodiments, the computer system 101a maintains the spatial relationship between the user interface 712 and the representations 705c through 705c before, after, and while updating the positions of the user interface 712 and representations 705c through 705e in accordance with the input. In some embodiments, updating the positions of the user interface 712 and representations 705c through 705e in accordance with the input includes updating the positions of the user interface 712 and representations 705c through 705e in a direction and by an amount corresponding to a direction and amount of movement of the hand 713 in the pinch hand shape during the input, as described in more detail below with reference to method 800.

In some embodiments, the computer system 101a participates in a communication session similar to the communication session included in the examples of FIGS. 7A-7V that does not include other users sharing environment 700. Rather, in some embodiments, the communication session displays two-dimensional representations of the second computer systems without displaying three-dimensional representations of the second computer systems. FIGS. 7L-7V illustrate examples of viewing shared content in communication sessions that do not include sharing a three-dimensional environment with other computer systems in the communication session.

For example, in FIG. 7L, the computer system 101a displays representations 702a and 702b of second computer systems in the communication session while displaying user interface 720. In some embodiments, user interface 720 is an audio player user interface for controlling playback of audio content, such as a music player user interface for controlling playback of music, a podcast player user interface for controlling playback of podcasts, and/or an audiobook player user interface for controlling playback of audiobooks. As shown in FIG. 7L, the user interface 720 includes an image 722a associated with an audio content item that is playing, an option 722b that, when selected, causes the computer system 101a to pause playback of the content, a user interface element 726a for repositioning the user interface 720 in the environment, an option 726b that, when selected, causes the computer system 101a to close the audio player user interface 720, and an option 724a that, when selected, causes the computer system 101a to share the user interface 720 and the content currently playing through user interface 720. In FIG. 7L, the computer system 101a receives an input requesting to share the content of user interface 720, including the visual contents of the user interface 720 and the audio content playing through user interface 720, with the second computer systems in the communication session. For example, the input includes the attention 703 of the user directed to the sharing option 724a and the user making a pinch shape with their hand 713, as described in more detail above and below with reference to method 800. In some embodiments, in response to receiving the input in FIG. 7L, the computer system 101a shares the content of user interface 720 as shown in FIG. 7P, including displaying the animation illustrated in FIGS. 7M-7O.

FIG. 7M illustrates a portion of the animated transition from not sharing the content of user interface 720 in FIG. 7L to sharing the content of user interface 720 in FIG. 7P. In FIG. 7M, the computer system 101a maintains display of user interface 720 at the same location in environment 700 as the location at which the computer system 101a displayed user interface 720 in FIG. 7L when the input was received. As shown in FIG. 7M, the animation includes ceasing display of the representations 702a and 702b that were displayed in FIG. 7L. In some embodiments, ceasing display of representations 702a and 702b includes displaying a fade-out animation to transition from displaying representations 702a and 702b to not displaying representations 702a and 702b.

FIG. 7N illustrates a portion of the animated transition from not sharing the content of user interface 720 in FIG. 7L to sharing the content of user interface 720 in FIG. 7P. In some embodiments, the portion of the animation illustrated in FIG. 7N comes after the portion of animation illustrated in FIG. 7M. As shown in FIG. 7N, the animation includes representation 705a, which corresponds to representation 702a in FIG. 7L, moving from behind user interface 720.

FIG. 7O illustrates a portion of the animated transition from not sharing the content of user interface 720 in FIG. 7L to sharing the content of user interface 720 in FIG. 7P. In FIG. 7O, the computer system 101a displays the entire representation 705a optionally after animation motion of the representation 705a as described above with reference to FIG. 7N. In FIG. 7O, as shown in the top-down view of environment 700′, the computer system 101a displays the representation 705′ parallel to the user interface 720′. As shown in the view of environment 700 via display generation component 120a, the representation 705a may appear distorted because of the representation 705a being placed towards the edge of the field of view 707a of the computer system 101a in the environment 700. Thus, in some embodiments, the computer system 101a displays representation 705a at an angle towards user interface 720, as shown in FIG. 7P. In some embodiments, as shown in FIG. 7O, the animation includes animating the representation 705a rotating towards user interface 720.

FIG. 7P illustrates an example of the computer system 101a concurrently displaying representation 705a while sharing the content of user interface 720 in the communication session. In some embodiments, the computer system 101a includes one representation 705a because of the size of user interface 720, as described in more details below with reference to method 800. In some embodiments, the angle between user interface 720′ and representation 705′ in the top-down view of environment 700′ in FIG. 7P is the same as angle θa in FIGS. 7E and 7F. In some embodiments, the angle between user interface 720′ and representation 705′ in the top-down view of environment 700′ in FIG. 7P is based on the position of the computer system 101a (corresponding to representation 706a′) relative to the user interface 720′ and/or the representation 705′.

FIG. 7Q illustrates an example of the computer system 101a participating in a communication session, including displaying representations 702a through 702g of second computer systems also participating in the communication session. In some embodiments, during the communication session, the computer system 101a receives an indication of one of the second computer systems sharing content in the communication session. In response to receiving the indication of one of the second computer systems sharing content in the communication session, the computer system 101a displays the shared content as shown in FIG. 7V, including displaying an animated transition illustrated in FIGS. 7R-7U.

FIG. 7R illustrates a portion of an animated transition from participating in the communication session without displaying shared content in FIG. 7Q to displaying the shared content in the communication session as shown in FIG. 7V. In FIG. 7R, the computer system 101a ceases displaying the representations 702a through 702g of the second computer systems participating in the communication session shown in FIG. 7Q. In some embodiments, the computer system 101a displays an animation of the representations 702a through 702g fading out from being displayed to not being displayed.

FIG. 7S illustrates another portion of the animated transition from participating in the communication session without displaying shared content in FIG. 7Q to displaying the shared content in the communication session as shown in FIG. 7V. In FIG. 7S, the computer system 101a displays a user interface 730 including content shared by one of the second computer systems participating in the communication session. For example, the user interface 730 is a user interface of a photos application that includes an image (e.g., a photo) shared by the second computer system in the communication session that shared user interface 730. In some embodiments, the computer system 101a displays the user interface 730 with an indication 732a that the user interface 730 is being shared by another computer system, a user interface element 732b for moving the user interface 730 in the environment 700, and a selectable option 732c that, when selected, causes the computer system 101a to cease displaying the user interface 730. In some embodiments, the computer system 101a displays the user interface 730 at a position in the user interface at which the computer system 101a previously displayed the representations 702a through 702g of the second computer systems in the communication session, such as in FIG. 7R.

FIGS. 7T through 7V illustrate an example of the computer system 101a animating the representations 705a and 705b of second computer systems in the communication session move from not being displayed in FIG. 7S, to being partially displayed in FIG. 7T, to being displayed in FIG. 7U, to being rotated towards the user interface 730 in FIG. 7V. This example is similar to other examples described above with reference to FIGS. 7C-7E and FIGS. 7N-7P. In FIG. 7V, the computer system 101a displays representations 705a and 705b at an angle towards user interface 730.

FIG. 8 is a flow diagram illustrating methods of displaying representations of second computer systems included in a communication session and/or content in an environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with a display generation component and one or more input devices. In some embodiments, the computer system is or includes an electronic device, such as a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while a communication session between the computer system and one or more second computer systems is ongoing (802), the computer system (e.g., 101a) displays (804), via the display generation component, one or more first visual representations associated with the one or more second computer systems in a first region of an environment from a current viewpoint of a user of the computer system, such as representations 702a through 702g in environment 700 in FIG. 7A. In some embodiments, the communication session includes transmission of audio, video, and/or other data between the computer system and the one or more second computer systems. For example, the communication session is a video call that includes receiving and transmitting audio and or video between the computer systems participating in the communication session. As another example, the communication session includes transmitting data to the second computer systems to enable the second computer systems to display a digital avatar of the user of the computer system that moves in accordance with movement of the user of the computer system (e.g., in a physical environment of the user) that is captured by the computer system. In some embodiments, the communication session includes the computer system receiving data from the one or more second computer systems that enables the computer system to display one or more avatars of one or more users of the one or more second computer systems that move in accordance with movement of the one or more users of the one or more computer systems. For example, the data includes avatar data, such as one or more visual characteristics of the avatar and/or one or more images of the avatar and/or video and/or motion data of the user corresponding to the avatar. In some embodiments, the one or more visual representations associated with the one or more second computer systems include live video captured by the one or more second computer systems, still images corresponding to the one or more users of the one or more second computer systems, and/or user avatars corresponding to the users of the one or more second computer systems. In some embodiments, the first region is a portion of an environment presented by the computer system and/or a region of the display generation component. In some embodiments, the computer system displays the one or more first visual representations associated with the one or more second computer systems in the first region while the computer system is not sharing content in the communication session. In some embodiments, the computer system displays the one or more first visual representations associated with the one or more second computer systems in the first region while the computer system is not sharing content in the communication session and while the one or more second computer systems are not sharing content in the communication session. In some embodiments, the computer system displays the one or more first visual representations associated with the one or more second computer systems in the first region while the computer system is not sharing content in the communication session, while one of the one or more second computer systems is sharing content in the communication session. In some embodiments, the (optionally three-dimensional) environment is generated, displayed, or otherwise caused to be viewable by the computer system. For example, the (optionally three-dimensional) environment is an extended reality (XR) environment, such as a virtual reality (VR) environment, a mixed reality (MR) environment, or an augmented reality (AR) environment.

In some embodiments, while a communication session between the computer system and one or more second computer systems is ongoing (802), while displaying, via the display generation component, the one or more first visual representations associated with the one or more second computer systems in the first region of the environment from the current viewpoint of the user of the computer system, the computer system (e.g., 101a) receives (806), via the one or more input devices, an input corresponding to a request to share content with the one or more second computer systems in the communication session, such as the input directed to option 710a in FIG. 7A. In some embodiments, the content is a user interface of an application other than the application associated with the communication session. In some embodiments, the content includes image, video, and/or audio content different from the image(s), video, and/or audio captured as part of the communication session. In some embodiments, sharing content with the one or more second computer systems enables the one or more second computer systems to present the content while in the communication session. In some embodiments, while the content is being shared, the computer system and the one or more second computer systems present the content in a synchronized manner, such as the computer system and the one or more second computer systems playing video content with the playback position synchronized across the computer system and the one or more second computer systems, or the computer system and the one or more second computer systems concurrently displaying the same user interface of a respective application other than the application associated with the communication session. In some embodiments, the input includes selection of an option confirming that content currently displayed by the computer system will be shared with the one or more second computer systems. In some embodiments, the input includes selection of a representation of content and/or an application in a menu for selecting content to be shared in the communication session. In some embodiments, the input corresponding to the request to share content includes one or more gestures and/or one or more air gestures performed by the user with their finger(s), hand(s), arm(s), head, and or other body part detected using the one or more input devices, input provided using a hardware input device of the one or more input devices, and/or a voice input. In some embodiments, other inputs disclosed herein have one or more of these characteristics described with reference to the input corresponding to the request to share content. In some embodiments, the computer system receives the input corresponding to the request to share the content while the computer system displays the content, but the one or more second computer systems do not display the content.

In some embodiments, in response to receiving the input corresponding to the request to share content with the one or more second computer systems in the communication session (808), such as the input illustrated in FIG. 7A, the computer system (e.g., 101a) displays (810), via the display generation component, the content in the environment from the current viewpoint of the user (812), such as the content of user interface 712 in FIG. 7E. In some embodiments, if the content includes an audio component, the computer system presents the audio component of the content while displaying a visual component of the content. In some embodiments, the computer system displays the content in the first region. In some embodiments, the computer system displays the content in the second region described below. In some embodiments, the computer system displays the content in a region other than the first or second region.

In some embodiments, in response to receiving the input corresponding to the request to share content with the one or more second computer systems in the communication session (808), such as the input illustrated in FIG. 7A, the computer system (e.g., 101a) displays (810), via the display generation component one or more second visual representations associated with the one or more computer systems in a second region different from the first region from the current viewpoint of the user, wherein the second region has a respective spatial relationship (e.g., position and/or orientation) relative to a location at which the content is displayed in the environment from the current viewpoint of the user (812), such as representations 705a through 705c in FIG. 7E. In some embodiments, the one or more second visual representations are the same as the one or more first visual representations. In some embodiments, the one or more second visual representations are different from the one or more first visual representations. In some embodiments, the second region overlaps the first region such that at least one of the second visual representations displayed in the second region is displayed at a location at which at least one of the first visual representations was displayed in the first region. In some embodiments, the second region does not overlap the first region such that the second visual representations displayed in the second region are displayed at locations different from the locations at which first visual representations were displayed in the first region. In some embodiments, displaying the one or more second visual representations in the second region includes changing a visual characteristic of one or more of the first visual representations and/or updating a spatial arrangement of one or more of the first visual representations, as described in more detail below. In some embodiments, the respective spatial relationship of the one or more second visual representations and the content is the second visual representations being displayed proximate and/or adjacent to the content. In some embodiments, while displaying the one or more second visual representations proximate and/or adjacent to the content, the computer system displays the content and the second one or more visual representations without displaying additional user interface elements between the content and the second one or more visual representations. In some embodiments, from the viewpoint of the user in the environment, the one or more second representations do not overlap the content. In some embodiments, from the viewpoint of the user in the environment, the one or more second representations are separated from a boundary of the content. In some embodiments, from the viewpoint of the user in the environment, the one or more second representations are displayed next to a same side of the content. Displaying the one or more visual representations of the one or more second computer systems in the second region relative to the location at which the content is displayed in response to the request to share the content with the one or more second computer systems enhances user interactions with the computer system by reducing the number of inputs needed to continue to interact with the communication session while sharing the content with the communication session, thereby simplifying user operation of the computer system and conserving time and power consumption of the computer system and avoids spatial conflicts between the shared content and the one or more second representations.

In some embodiments, such as in FIG. 7A, the environment (e.g., 700) is a three-dimensional environment. In some embodiments, as described above, the three-dimensional environment is optionally one of an extended reality (XR) environment, such as a virtual reality (VR) environment, a mixed reality (MR) environment, or an augmented reality (AR) environment. In some embodiments, the three-dimensional environment includes virtual content, such as the representations of the one or more second computer systems, the content shared by the computer system, user interfaces of other applications, and/or other virtual content. In some embodiments, the three-dimensional environment includes portions of the physical environment displayed at virtual and/or video passthrough by the display generation component and/or presented through a transparent portion of the display generation component as real and/or true passthrough. In some embodiments, the three-dimensional environment is shared with the one or more second computer systems. For example, the one or more second computer systems are not co-located with the computer system, but have respective associated locations in the three-dimensional environment. In some embodiments, the computer system displays third visual representations of the one or more second computer systems at the locations associated with the one or more second computer systems, as described in more detail below. For example, the third visual representations include three-dimensional avatars of the users of the one or more second computer systems. In some embodiments, the one or more second computer systems display and/or present the three-dimensional environment from respective viewpoints of the one or more second computer systems at the respective locations associated with the users of the one or more second computer systems. Displaying the visual representations of the one or more second computer systems and the content in a three-dimensional environment enhances user interaction with the computer system by displaying more content concurrently and providing intuitive ways of navigating and interacting with displayed elements.

In some embodiments, while displaying the content concurrently with the one or more second visual representations in the second region, the second region (and/or the one or more second visual representations of the one or more second computer systems) is non-planar to the content, such as representations 705a through 705c being non-planar to user interface 712 in FIG. 7E. In some embodiments, the content includes two-dimensional content displayed in the first plane. In some embodiments, the content is aligned along a first plane and the one or more second visual representations are aligned along as second plane different from the first plane. In some embodiments, the second region is two-dimensional in the second plane. In some embodiments, the second region includes two-dimensional content displayed in the second plane. In some embodiments, the one or more second visual representations includes two-dimensional content displayed in the second plane. In some embodiments, the content includes three-dimensional content. In some embodiments, the second region is a three-dimensional region. In some embodiments, the second region includes three-dimensional content. In some embodiments, the one or more second representations include three-dimensional content. In some embodiments, the first plane and the second plane being non-planar includes the first plane and second plane intersecting at a line, but not intersecting at a plane. For example, the content and the second region are displayed with an angle between them so that the content and the second region are oriented towards a viewpoint of the user of the computer system in the environment. In some embodiments, the orientation of the shared content relative to the viewpoint of the user is different from the orientation of the second region and/or the one or more second visual representations relative to the viewpoint of the user. In some embodiments, the orientation of the first region relative to the viewpoint of the user is different from the orientation of the second region relative to the viewpoint of the user. Displaying the content and the second region in a non-planar manner enhances user interactions with the computer system by improving user comfort when interacting with the content and the second region and improving visibility of the content and the second region.

In some embodiments, in accordance with a determination that a location in the environment associated with the computer system and locations in the environment associated with a first set of the one or more second computer systems has a first spatial relationship relative to the content, an angle between the second region and the content is a first angle associated with the first spatial relationship, such as angle θa in FIG. 7E. In some embodiments, the location in the environment associated with the computer system is the location of the viewpoint of the user of the computer system in the environment, with the viewpoint further including an orientation of the viewpoint of the user. In some embodiments, the locations of the first set one or more second computer systems in the environment correspond to locations of viewpoints of the users of the first set of the one or more second computer systems in the environment, as described above. In some embodiments, the first set of the one or more second computer systems is different from a set of the one or more second computer systems represented by the second visual representations of the one or more second computer systems. In some embodiments, the first set of the one or more second computer systems is the same as a set of the one or more second computer systems represented by the second visual representations of the one or more second computer systems. In some embodiments, the first set of the one or more second computer systems has one or more computer systems in common with a set of the one or more second computer systems represented by the second visual representations of the one or more second computer systems, and one or more second computer systems different from the set of the one or more second computer systems represented by the second visual representations of the one or more second computer systems. For example, the first set of the one or more second computer systems are represented by third visual representations of the one or more second computer systems, described in more detail below. In some embodiments, the spatial relationship of the location in the environment associated with the computer system and the locations in the environment associated with the first set of the one or more second computer systems includes relative positions and/or orientations of the location in the environment associated with the computer system and the locations in the environment associated with the first set of the one or more second computer systems in the environment. In some embodiments, the angle between the second region and the content is selected to orient the content and the second region towards the location associated with the computer system and the locations associated with the first set of the one or more second computer systems, as described in more detail below. In some embodiments, the one or more second computer systems are represented by the second visual representations, and are not associated with other locations in the environment, and the computer system displays the content and the second region with the first angle in accordance with the spatial relationship of the location in the environment associated with the first computer system and the location in the environment of the content having a first spatial relationship.

In some embodiments, in accordance with a determination that the location in the environment associated with the computer system and the locations in the environment associated with the first set of the one or more second computer systems has a second spatial relationship different from the first spatial relationship relative to the content, the angle between the second region and the content is a second angle associated with the second spatial relationship and different from the first angle, such as angle θc in FIG. 7H being different from θa in FIG. 7E. For example, if the location associated with the computer system and the locations associated with the first set of one or more second computer systems span a relatively small angle relative to the content and the second region, the angle between the content and the second region is relatively small. As another example, if the location associated with the computer system and the locations associated with the first set of one or more second computer systems span a relatively large angle relative to the content and the second region, the angle between the content and the second region is relatively large. Thus, in some embodiments, the computer system displays the content and the second region with an angle between them that depends on the spatial arrangement of the location associated with the computer system in the environment and the locations associated with the first set of one or more second computer systems in the environment. Alternatively, in some embodiments, the angle between the content and the second region is a predetermined angle independent of the spatial arrangement of the location associated with the computer system and the locations associated with the first set of the one or more second computer systems. In some embodiments, the one or more second computer systems are represented by the second visual representations, and are not associated with other locations in the environment, and the computer system displays the content and the second region with the second angle in accordance with the spatial relationship of the location in the environment associated with the first computer system and the location in the environment of the content having a second spatial relationship. Displaying the content and the second region with an angle corresponding to the spatial relationship of the location associated with the computer system and the locations associated with the first set of the one or more second computer systems enhances user interactions with the computer system by improving user comfort when interacting with the content and the second region and improving visibility of the content and the second region while maintaining shared spatial truth with the first set of the one or more second computer systems.

In some embodiments, in accordance with the determination that the location in the environment associated with the computer system and the locations in the environment associated with the first set of the one or more second computer systems has the first spatial relationship relative to the content, the content and the one or more second visual representations in the second region are displayed at the first angle at the first set of the one or more second computer systems, such as computer system 101a using angle θa in FIG. 7E and computer system 101b using θa in FIG. 7F. In some embodiments, the location in the environment associated with the computer system, the locations in the environment associated with the first set of the one or more second computer systems, the first spatial relationship of the location in the environment associated with the computer system and the locations in the environment associated with the first set of the one or more second computer systems, and the first angle between the content and the second region have one or more characteristics of the corresponding elements described in more detail above. In some embodiments, the first set of the one or more second computer systems display the second region and the content with the same angle (e.g., the first angle), irrespective of the locations in the environment corresponding to the computer system displaying the content and the second region.

In some embodiments, in accordance with the determination that the location in the environment associated with the computer system and the locations in the environment associated with the first set of the one or more second computer systems has the second spatial relationship relative to the content, the content and the one or more second visual representations in the second region are displayed at the second angle at the first set of the one or more second computer systems, such as computer system 101b using θc in FIG. 7H while computer system 101a uses θc. In some embodiments, the location in the environment associated with the computer system, the locations in the environment associated with the first set of the one or more second computer systems, the second spatial relationship of the location in the environment associated with the computer system and the locations in the environment associated with the first set of the one or more second computer systems, and the second angle between the content and the second region have one or more characteristics of the corresponding elements described in more detail above. In some embodiments, the first set of the one or more second computer systems display the second region and the content with the same angle (e.g., the second angle), irrespective of the locations in the environment corresponding to the computer system displaying the content and the second region. Displaying the content and the second region with the same angle at the computer system and the first set of the one or more second computer systems enhances user interactions with the computer system by maintaining spatial truth between the computer systems participating in the communication session.

In some embodiments, while a spatial relationship of the location in the environment associated with the computer system and the locations in the environment associated with the first set of the one or more second computer systems relative to the content is a respective spatial arrangement and the angle between the content and the second region is a respective angle, the computer system receives, via the one or more input devices, an indication that the spatial relationship has changed to a third spatial relationship different from the respective spatial relationship, such as changing from the arrangement of representations 706a′, 706b′, and 704′ in FIG. 7G to the arrangement of representations 706a′, 706b′, and 704′ in FIG. 7H. In some embodiments, the location in the environment associated with the computer system, the locations in the environment associated with the first set of the one or more second computer systems, the spatial relationship of the location in the environment associated with the computer system and the locations in the environment associated with the first set of the one or more second computer systems, and the angle between the content and the second region have one or more characteristics of the corresponding elements described in more detail above. In some embodiments, the respective angle between the content and the second region is the first angle described above and the spatial arrangement of the location in the environment associated with the computer system and the locations in the environment associated with the one or more second computer systems is the first spatial arrangement described above. In some embodiments, the respective angle between the content and the second region is the second angle described above and the spatial arrangement of the location in the environment associated with the computer system and the locations in the environment associated with the one or more second computer systems is the second spatial arrangement described above. In some embodiments, the respective angle corresponds to the spatial arrangement of the location in the environment associated with the computer system and the locations in the environment associated with the one or more second computer systems at the time at which the computer system received the input corresponding to the request to share the content. In some embodiments, the indication that the spatial relationship has changed includes an indication that the location in the environment associated with the computer system has changed. For example, the computer system detects movement of the user and/or the computer system in the physical environment of the computer system. As another example, the computer system detects a request to change the location of the computer system in the environment that does not include movement of the computer system and/or the user in the physical environment. As another example, the computer system detects a request to change the location of the environment relative to the computer system that does not include movement of the computer system and/or user in the physical environment. In some embodiments, the indication that the spatial relationship has changed includes an indication that one or more locations in the environment associated with the first set of the one or more second computer systems has changed. For example, the computer system receives an indication of movement of a user of one of the first set of the one or more second computer systems in their physical environment. As another example, the computer system receives an indication of movement of one of the first set of the one or more second computer systems and/or its user in its respective physical environment. As another example, the computer system receives an indication of one of the first set of the one or more second computer systems detecting a request to change the location of the one of the first set of the one or more second computer systems in the environment that does not include movement of the one of the first set of the one or more second computer systems and/or the user of the one of the first set of the one or more second computer systems in its physical environment. As another example, the computer system receives an indication of one of the first set of the one or more second computer systems detecting a request to change the location of the environment relative to the one of the first set of the one or more second computer systems that does not include movement of the one of the first set of the one or more second computer systems and/or user of the one of the first set of the one or more second computer systems in the physical environment. In some embodiments, detecting the change in the spatial arrangement of the location in the environment associated with the computer system and the locations in the environment associated with the first set of the one or more second computer systems includes detecting one of the second computer systems entering the communication session and/or detecting one of the second computer systems leaving the communication session.

In some embodiments, in response to receiving the indication that the spatial relationship has changed, the computer system maintains the respective angle between the content and the second region, such as computer system 101a using angle θa from FIG. 7E in response to receiving an indication that the spatial arrangement is now the spatial arrangement of representations 704′, 706a′, and 706b′ in FIG. 7H. In some embodiments, once the computer system displays the content with the respective angle relative to the second region, the computer system does not update the angle between the content and the second region in response to changes in the spatial arrangement of the location associated with the computer system and the locations associated with the first set of the one or more second computer systems. Maintaining the respective angle between the content and the second region irrespective of changes to the spatial arrangement of the one or more second computer systems enhances user interactions with the computer system by improving user comfort when interacting with the content and the second region and reducing distracting movement of displayed elements while maintaining shared spatial truth with the first set of the one or more second computer systems.

In some embodiments, while displaying the content and the one or more visual representations in the second region at a respective angle, the content and the one or more visual representations in the second region are displayed by the first set of the one or more second computer systems at another angle different from the respective angle at one of the first set of the one or more second computer systems based on a location in the environment associated with the one of the first set of the one or more second computer systems, such as computer system 101a using angle θa in FIG. 7E while computer system 101b uses angle θb in FIG. 7G. In some embodiments, the respective angle is the first angle or the second angle described above. In some embodiments, the respective angle is based on the location in the environment associated with the computer system, as described above. In some embodiments, the other angle different from the respective angle is an angle based on the location in the environment associated with the one of the first set of one or more second computer systems in a manner similar to how the respective angle is based on the location in the environment associated with the computer system as described above. In some embodiments, while the computer system displays the content and the second region with the respective angle, and the one of the first set of the one or more second computer systems displays the content and the second region with the other angle different from the respective angle, another of the first set of the one or more second computer systems displays the content and the second region with a third angle different from the respective angle and different from the other angle. In some embodiments, the third angle is based on the location in the environment associated with the other of the first set of the one or more second computer systems in a manner similar to how the respective angle is based on the location in the environment associated with the computer system as described above. Displaying the content and the second region with different angles at the computer system and the one of the first set of the one or more second computer systems enhances user interactions with the computer system by enhancing user comfort and legibility of the content and the second visual representations while interacting with the content and the second visual representations.

In some embodiments, while a spatial relationship of the location in the environment associated with the computer system and the locations in the environment associated with the first set of the one or more second computer systems relative to the content is a respective spatial arrangement and the angle between the content and the second region is a respective angle, the computer system receives, via the one or more input devices, an indication that the spatial relationship has changed to a third spatial relationship different from the respective spatial relationship, such as the spatial arrangement of representations 706a′, 706b′, and 704′ relative to user interface 712′ changing from the arrangement shown in FIG. 7G to the arrangement in FIG. 7H. In some embodiments, the location in the environment associated with the computer system, the locations in the environment associated with the first set of the one or more second computer systems, the spatial relationship of the location in the environment associated with the computer system and the locations in the environment associated with the first set of the one or more second computer systems, and the angle between the content and the second region have one or more characteristics of the corresponding elements described in more detail above. In some embodiments, detecting the change to the third spatial relationship includes one of the examples described in more detail above.

In some embodiments, in response to receiving the indication that the spatial relationship has changed, the computer system updates the angle between the content and the second region to a third angle corresponding to the third spatial relationship and different from the respective angle, such as the computer system 101a going from using θa in FIG. 7E to using θc shown in FIG. 7H. In some embodiments, the third angle corresponds to the third spatial arrangement in the manner described above with respect to the first angle corresponding the first spatial arrangement and/or the second angle corresponding to the second spatial arrangement. In some embodiments, the computer system updates the angle between the content and the second region in accordance with a determination that a difference between the respective spatial arrangement and the third spatial arrangement satisfies one or more criteria; and forgoes updating the angle between the content and the second region in accordance with a determination that the difference between the respective spatial arrangement and the third spatial arrangement does not satisfy the one or more criteria. Examples of criteria in the one or more criteria include a change in an angle spanning the locations in the environment associated with the computer system and the first set of the one or more second computer systems by more than a threshold amount (e.g., 0.5, 1, 2, 3, 5, 10, or 15 degrees). Examples of criteria in the one or more criteria include a change in one or more of the locations in the environment associated with the computer system and the first set of the one or more second computer systems by more than a threshold amount (e.g., 0.5, 1, 2, 3, 5, or 10 meters). Examples of criteria in the one or more criteria include one of the first set of the one or more computer systems leaving or joining the communication session. Thus, for example, in some embodiments, the computer system updates the angle between the content and the second region in response to detecting a change to the spatial relationship that exceeds a threshold amount as described above, but does not update the angle between the content and the second region in response to detecting a change to the spatial relationship that is less than the threshold amount. As another example, in some embodiments, the computer system updates the angle between the content and the second region in response to detecting one of the first set of the one or more computer systems leaving or joining the communication session or in response to detecting a change to the spatial relationship that exceeds a threshold amount as described above, but does not update the angle between the content and the second region in response to detecting a change to the spatial relationship that is less than the threshold amount. As another example, in some embodiments, the computer system updates the angle between the content and the second region in response to detecting one of the first set of the one or more computer systems leaving or joining the communication session, but does not updated the angle between the content and the second region in response to detecting a change in the spatial relationship caused by movement of one of the locations in the environment associated with the computer system or one of the first set of the one or more second computer systems. Updating the angle between the content and the second region in response to detecting the change in the spatial relationship of the location in the environment associated with the computer system and the locations in the environment associated with the first set of the one or more second computer systems enhances user interactions with the computer system by improving user comfort when interacting with the content and the second region and improving visibility of the content and the second region while maintaining shared spatial truth with the first set of the one or more second computer systems.

In some embodiments, while a spatial relationship of the location in the environment associated with the computer system and the locations in the environment associated with the first set of the one or more second computer systems relative to the content is a respective spatial arrangement and the angle between the content and the second region is a respective angle, the computer system receives, via the one or more input devices, an indication that the spatial relationship has changed to a third spatial relationship different from the respective spatial relationship, such as the spatial relationship of representations 704′, 706a′, and 706b′ relative to user interface 712′ and representations 705′ changing from the spatial relationship shown in FIG. 7G to the spatial relationship shown in FIG. 7H. In some embodiments, the location in the environment associated with the computer system, the locations in the environment associated with the first set of the one or more second computer systems, the spatial relationship of the location in the environment associated with the computer system and the locations in the environment associated with the first set of the one or more second computer systems, and the angle between the content and the second region have one or more characteristics of the corresponding elements described in more detail above. In some embodiments, detecting the change to the third spatial relationship includes one of the examples described in more detail above.

In some embodiments, in response to receiving the indication that the spatial relationship has changed, in accordance with a determination that the location in the environment associated with the computer system changed, the computer system updates the angle between the content and the second region to a third angle corresponding to the third spatial relationship and different from the respective angle, such as computer system 101b using angle θc while at the location in the environment 700 shown by representation 706b′ in FIG. 7H. In some embodiments, the location in the environment associated with the computer system changes in response to the computer system detecting movement of the user and/or the computer system in the physical environment of the computer system. As another example, the location in the environment associated with the computer system changes in response to the computer system detecting a request to change the location of the computer system in the environment that does not include movement of the computer system and/or the user in the physical environment. As another example, the location in the environment associated with the computer system changes in response to the computer system detecting a request to change the location of the environment relative to the computer system that does not include movement of the computer system and/or user in the physical environment. In some embodiments, in response to detecting the movement of the location of the computer system in the environment, the computer system updates the orientation of the second region to be better oriented towards the new location in the environment associated with the computer system, which updates the angle between the content and the second region. For example, if the location in the environment associated with the computer system moves clockwise relative to the vertex of the angle between the content and the second region, the second region rotates clockwise. As another example, if the location in the environment associated with the computer system moves counterclockwise relative to the vertex of the angle between the content and the second region, the second region rotates counterclockwise. In some embodiments, changing the angle between the content and the second region does not include changing a position or orientation of the content. In some embodiments, changing the angle between the content and the second region at the computer system does not include changing the angle between the content and the second region at the one or more second computer systems. Thus, in some embodiments, the angle between the content and the second region may be different for different computer systems participating in the communication session.

In some embodiments, in response to receiving the indication that the spatial relationship has changed, in accordance with a determination that the location in the environment associated with the computer system did not change, maintaining the respective angle between the content and the second region, such as computer system 101a maintaining angle θa in response to receiving an indication that indication 706b′ has moved to the location shown in FIG. 7H. For example, the spatial relationship changes without the location in the environment associated with the computer system changing when a location in the environment associated with one of the first set of the one or more second computer systems changes and/or when one of the first set of the one or more second computer systems joins or leaves the communication session. Examples of a location in the environment associated with one of the first set of the one or more second computer systems changing includes the computer system receiving an indication of movement of one of the first set of the one or more second computer systems and/or its user in its respective physical environment. As another example, the computer system receives an indication of one of the first set of the one or more second computer systems detecting a request to change the location of the one of the first set of the one or more second computer systems in the environment that does not include movement of the one of the first set of the one or more second computer systems and/or the user of the one of the first set of the one or more second computer systems in its physical environment. As another example, the computer system receives an indication of one of the first set of the one or more second computer systems detecting a request to change the location of the environment relative to the one of the first set of the one or more second computer systems that does not include movement of the one of the first set of the one or more second computer systems and/or user of the one of the first set of the one or more second computer systems in the physical environment. In some embodiments, if the change in the spatial relationship is caused by movement of one of the first set of the one or more second computer systems relative to the environment, that second computer system updates the angle between the content and the second region in the manner described above with respect to the computer system, but the other computer systems in the communication session do not update the angles between the content and the second region. Again, in some embodiments, the angle between the content and the second region may be different for different computer systems participating in the communication session Updating the angle between the content and the second region in response to movement of the location in the environment associated with the computer system but not in response to other changes to the spatial relationship between the location in the environment associated with the computer system and the locations in the environment associated with the first set of the second computer systems enhances user interactions with the computer system by improving user comfort when interacting with the content and the second region and reducing distracting movement of displayed elements.

In some embodiments, displaying the content and the one or more second visual representations in the second region includes displaying the second region angled towards the content, such as the arrangement of user interface 712 and representations 705a through 705c in FIG. 7E. In some embodiments, the angle between the content and the second region is acute from the viewpoint of the user of the computer system in the environment. In some embodiments, edges of the content and the second region not at the apex of the angle between the content item and the second region are closer to the viewpoint of the user in the environment than how close the apex of the angle between the content item and the second region is to the viewpoint of the user of the computer system in the environment. Displaying the content and the second region angled towards the viewpoint of the user of the computer system in the environment enhances user interactions with the computer system by improving user comfort while interacting with the content and the second visual representations displayed in the second region and improving legibility of the content and the second visual representations displayed in the second region.

In some embodiments, while displaying the content concurrently with the one or more second visual representations in the second region, the second region is non-parallel to the content, such as the arrangement of user interface 712 and representations 705a through 705c in FIG. 7E. As described above, in some embodiments, the second region is displayed non-planar to the content. In some embodiments, the first plane of the content and the second plane of the second region are not planar to one another. In some embodiments, the first plane and the second plane intersect at a line. In some embodiments, the first plane and the second plane form an angle other than 180 degrees. Displaying the content and the second region not parallel to one another enhances user interactions with the computer system by improving user comfort while interacting with the content and the second visual representations displayed in the second region and improving legibility of the content and the second visual representations displayed in the second region.

In some embodiments, the one or more first representations include one or more of video, still images, and/or avatar representations of the one or more second computer systems, such as the representations 702a through 702g in FIG. 7A. In some embodiments, the video is two-dimensional or three-dimensional live video captured by the one or more second computer systems. In some embodiments, the still images include still images associated with user accounts of the one or more second computer systems. In some embodiments, the avatar representations include still and/or video images of an avatar corresponding to the user or user account of the one or more second computer systems. Example avatar representations include three-dimensional or two-dimensional still images of avatars corresponding to user accounts of the one or more second computer systems. Example avatar representations include two-dimensional or three-dimensional animated video of avatars of the user accounts of the one or more second computer systems moving in manners corresponding to live movement of the users of the one or more second computer systems.

In some embodiments, the one or more second representations include one or more of the video, the still images, and/or the avatar representations of the one or more second computer systems, in manners similar to those described above, such as the representations 705a through 705c in FIG. 7E. In some embodiments, the contents of a respective second representation are the same as the contents of a respective first representation corresponding to the same one of the one or more second computer systems. For example, if the computer system displays a first visual representation of a respective second computer system that includes a still image, the computer system displays a second visual representation of the respective second computer system that includes the still image. As another example, if the computer system displays a first visual representation of a respective second computer system that includes live video of the user of the respective second computer system, the computer system displays a second visual representation of the respective second computer system that includes a continuation of the live video of the user of the respective second computer system. Displaying video, still images, and/or avatar representations of the one or more second computer systems in the first and second visual representations of the one or more second computer systems enhances user interactions with the computer system by enhancing the contents of the communication session.

In some embodiments, displaying the one or more second visual representations in the second region while displaying the content includes arranging the one or more second representations vertically in the environment (e.g., in a vertical column or line), such as the arrangement of representations 705a through 705a in FIG. 7E. In some embodiments, displaying the one or more second visual representations includes displaying the one or more second visual representations vertically adjacent to other second visual representations without displaying second visual representations horizontally adjacent to other second visual representations. In some embodiments, the second visual representations are displayed horizontally adjacent to the content. In some embodiments, arranging the one or more second representations vertically in the environment includes arranging the one or more second representations vertically relative to the viewpoint of the user in the environment. Arranging the one or more second representations vertically enhances user interactions with the computer system by improving user comfort while interacting with the second visual representations and improving legibility of the second visual representations.

In some embodiments, displaying the one or more second visual representations in the second region while displaying the content includes displaying the second region vertically centered with the content, such as representations 705a through 705c being vertically centered with user interface 712 in FIG. 7E. As described above, in some embodiments, the second visual representations are displayed in a vertical arrangement (e.g., in a vertical column or line) in the environment and/or relative to the viewpoint of the user in the environment. In some embodiments, the vertical column or line including the second visual representations is middle-aligned vertically with the content. In some embodiments, as described above, the one or more second visual representations are displayed horizontally adjacent to the content. Displaying the second visual representations vertically centered with the content enhances user interactions with the computer system by improving user comfort when interacting with the content and the second visual representations.

In some embodiments, displaying the content in response to receiving the input corresponding to the request to share content with the one or more second computer systems in the communication session includes displaying a visual indication that indicates the content is shared in the communication session, such as displaying indication 710b with user interface 712 in FIG. 7E. In some embodiments, the visual indication is displayed proximate and/or adjacent to the content in a manner similar to the manner described above in which the second visual representations are displayed proximate and/or adjacent to the content. In some embodiments, the visual indication is displayed proximate and/or adjacent to a different edge of the content than the edge of the content to which the second representations are displayed proximate and/or adjacent. For example, the indication is displayed above a top edge of the content and the second visual representations are displayed horizontally adjacent to the content. In some embodiments, the visual indication is displayed overlaid on the content. In some embodiments, the visual indication includes images and/or text indicating that the content is being shared with the one or more second computer systems. In some embodiments, while the computer system displays the content without sharing the content, the computer system forgoes displaying the visual indication. In some embodiments, the one or more second computer systems display the visual indication while displaying the content in a manner similar to the manner in which the computer system displays the visual indication while displaying and while sharing the content. Displaying the visual indication that the content is being shared enhances user interactions with the computer system by reminding the user that other users can see the content, which enhances user privacy.

In some embodiments, displaying the one or more second visual representations in response to receiving the input corresponding to the request to share content with the one or more second computer systems in the communication session includes, in accordance with a determination that the content is displayed at a first size, displaying a first number of second visual representations that corresponds to the first size of the content, such as displaying representations 705a through 705c with user interface 712 in FIG. 7E. In some embodiments, the larger the size at which the content is displayed, the larger the number of second visual representations that are displayed. In some embodiments, the smaller the size at which the content is displayed, the smaller the number of second visual representations that are displayed. Additionally or alternatively, in some embodiments, the larger the size at which the content is displayed, the larger the size at which the second visual representations are displayed. Additionally or alternatively, in some embodiments, the smaller the size at which the content is displayed, the smaller the size at which the second visual representations are displayed.

In some embodiments, displaying the one or more second visual representations in response to receiving the input corresponding to the request to share content with the one or more second computer systems in the communication session includes, in accordance with a determination that the content is displayed at a second size different from the first size, displaying a second number of second visual representations that corresponds to the second size of the content and is different from the first number of visual representations, such as displaying representation 705a with user interface 720 in FIG. 7P. For example, if the second size is larger than the first size, the second number is larger than the first number and if the second size is smaller than the first size, the second number is smaller than the first number. Displaying a number of second visual representations based on the size of the content enhances user interactions with the computer system by enhancing user comfort while interacting with the content and the second visual representations.

In some embodiments, while displaying, via the display generation component, the content at a respective size and a respective number of second visual representations, the computer system receives, via the one or more input devices, an input corresponding to a request to resize the content, such as an input requesting to resize user interface 712 in FIG. 7J. In some embodiments, the respective size at which the computer system displays the content is the first size or the second size described above. In some embodiments, while displaying the content with the respective size, the computer system displays a number of second visual representations corresponding to the respective size, as described above.

In some embodiments, in response to receiving the input corresponding to the request to resize the content, the computer system displays, via the display generation component, the content at a third size different from the respective size in accordance with the input corresponding to the request to resize the content, such as displaying the user interface 712 at a different size than the size shown in FIG. 7J. In some embodiments, the input corresponding to a request to resize the content includes a direction of resizing (e.g., whether to make the content bigger or smaller) and an amount of resizing. For example, the input includes movement and the amount (e.g., speed, distance, and/or duration) of the movement corresponds to the amount of resizing, where greater movement corresponds to a greater change in size and less movement corresponds to a smaller change in size.

In some embodiments, in response to receiving the input corresponding to the request to resize the content, the computer system displays, via the display generation component, a third number of second visual representations that corresponds to the third size of the content and is different from the respective number of second visual representations, such as displaying a different number of representations similar to representations 705a through 705c different from the number of representations 705a through 705c in FIG. 7J. In some embodiments, in response to an input corresponding to a request to reduce the size of the content, the computer system reduces the size of the content and displays fewer second visual representations. In some embodiments, in response to an input corresponding to a request to increase the size of the content, the computer system increases the size of the content and displays more second visual representations. Changing the number of second visual representations displayed in response to receiving the input corresponding to the request to resize the content enhances user interactions with the computer system by enhancing user comfort while interacting with the content and the second visual representations.

In some embodiments, displaying the one or more first visual representations of the one or more second computer systems includes displaying a first number of the first visual representations and displaying the one or more second visual representations of the one or more second computer systems includes displaying a second number, less than the first number, of the second visual representations, such as displaying representations 702a through 702g in FIG. 7A and representations 705a through 705c in FIG. 7E. In some embodiments, the number of second visual representations that the computer system displays depends on the size at which the computer system displays the content, so it is possible that the computer system displays fewer visual representations when displaying the second visual representations than the number of first visual representations because the size of the content corresponds to a smaller number of representations than the number of the first visual representations. Displaying a smaller number of second visual representations than the number of first visual representations enhances user interactions with the computer system by improving user comfort while interacting with the content and the second visual representations.

In some embodiments, displaying the second number of the second visual representations includes displaying second visual representations of a first set of the one or more second computer systems, such as representations 705a through 705c in FIG. 7E corresponding to representations 702a through 702c in FIG. 7A, and forgoing displaying second visual representations of a second set of the one or more second computer systems selected based on one or more criteria including a criterion based on an amount of participation in the communication session, such as computer systems corresponding to representations 702d through 702g in FIG. 7A. In some embodiments, the computer system displays visual representations of users that are participating more in the communication session than other users. For example, visual representations of users with the most time talking, the most number of times talking, and/or who talked most recently are displayed and visual representations of users with less time talking, a lower number of times talking, or talked less recently are not displayed. In some embodiments, the computer system displays the visual representation of the user that is currently talking. In some embodiments, after that user is done talking, the computer system may cease to display the representation corresponding to that user in favor of displaying a visual representation of a user that has more participation in the conversation (e.g., based on duration and/or number of times talking). In some embodiments, the computer systems participating in the communication session are assigned prominence scores based on the one or more criteria and the computer system displays first visual representations of a predetermined number of second computer systems with the highest prominence scores at larger sizes than sizes of first visual representations of the remaining second computer systems. Displaying second visual representations based on the amount of participation of respective users in the communication session enhances user interactions with the computer system by reducing the number of inputs needed to view relevant content.

In some embodiments, while displaying a first set of the one or more second visual representations of the one or more second computer systems, the computer system receives, via the one or more input devices, an input corresponding to a request to scroll the one or more second visual representations, such as the input directed to representations 705a through 705c in FIG. 7I. In some embodiments, the input corresponding to the request to scroll includes movement with a direction and a magnitude (e.g., of speed, distance, and/or duration). For example, detecting the input includes detecting an air gesture including movement of a hand of the user in a pinched hand shape (e.g., a shape in which one or more fingers are within a threshold distance of touching the thumb), and the direction and magnitude of movement described herein is direction and movement of the hand in the pinch hand shape.

In some embodiments, in response to receiving the input corresponding to the request to scroll the one or more second visual representations of the one or more second computer systems, the computer system scrolls the one or more second visual representations of the one or more second computer systems in accordance with the request to scroll, including displaying a second set of the one or more second visual representations not included in the first set of the one or more second visual representations, such as displaying representations 705d and 705e in FIG. 7J in response to the input illustrated in FIG. 7J. In some embodiments, the computer system scrolls the content in a direction that corresponds to the direction of movement of the input and by an amount that corresponds to the amount of movement of the input. In some embodiments, scrolling the second visual representations includes ceasing to display one or more of the first set of the one or more second visual representations. Displaying the second set of one or more second visual representations in response to receiving the input corresponding to the request to scroll the second visual representations enhances user interactions with the computer system by presenting more information in the same display area, which improves user comfort while interacting with the second visual representations.

In some embodiments, displaying the one or more first visual representations includes displaying, via the display generation component, a first set of the one or more first visual representations that satisfy one or more criteria including a criterion that is satisfied based on an amount participation in the communication session of respective second computer systems at a first size, such as representations 702a through 702d in FIG. 7A. In some embodiments, the one or more criteria including the criterion satisfied based on the amount of participating in the communication session have one or more of the characteristics described above. In some embodiments, the first set of the one or more first visual representations correspond to one or more second computer systems that have participated in the communication session so far more than other second computer systems in accordance with the one or more criteria. For example, a predetermined number of first representations corresponding to a first set of the one or more second computer systems that participated the most in the communication session are displayed at the first size.

In some embodiments, displaying the one or more first visual representations includes displaying, via the display generation component, a second set of the one or more first visual representations that do not satisfy the one or more criteria at a second size less than the first size, such as representations 702e through 702g in FIG. 7A. In some embodiments, the second set of the one or more first visual representations correspond to one or more second computer systems that have participated in the communication session so far less than other second computer systems in accordance with the one or more criteria. In some embodiments, as computer systems in the second set participate in the communication session more based on the one or more criteria and/or computer systems in the first set participate in the communication session less based on the one or more criteria, the computer system changes which second computer systems are in the first set and/or the second set. For example, if a first computer system in the first set changes to participating in the communication session less than a second computer system in the second set, the computer system updates display of the one or more first visual representations to include the first visual representation of the first computer system in the second set and to include the first visual representation of the second computer system in the first set. In some embodiments, the computer system displays the first visual representations of the first set of the one or more second computer systems in a first portion of the first region and displays the first visual representations of the second set of the one or more second computer systems in a second portion of the first region, different from the first portion. For example, first representations corresponding to a second set of the one or more second computer systems that are not in the predetermined number of second computer system that's participated the most in the communication session are displayed at the second size smaller than the first size.

In some embodiments, displaying the one or more second visual representations includes displaying a third set of the one or more second visual representations at a third size independent of whether which of the one or more second computer systems satisfy the one or more criteria (e.g., without displaying a fourth set of the one or more second visual representations at a fourth size different from the third size), such as displaying representations 705a through 705c in FIG. 7E. As described above, in some embodiments, the number of second visual representations is less than the number of first visual representations. In some embodiments, the number of second visual representations is less than the number of the first set of the first visual representations, so one or more of the second computer systems represented by the first set of the first visual representations are not represented by the second visual representations. In some embodiments, the number of second visual representations is greater than the number of the first set of the first visual representations, so one or more of the second computer systems represented by the second set of the first visual representations are represented by the second visual representations. In some embodiments, the third size is different from the first size and different from the second size. In some embodiments, the third size is the same as the first size or the same as the second size. In some embodiments, the computer system displays the second visual representations at the same size. Displaying the first visual representations of the one or more second computer systems at sizes based on the one or more criteria including the criterion based on the participation of the second computer systems in the communication session enhances user interactions with the computer system by displaying relevant content with fewer inputs.

In some embodiments, displaying the content in response to receiving the input corresponding to the request to share content with the one or more second computer systems in the communication session includes, in accordance with a determination that the first region has a first location, displaying the content in a region that includes the first location from the current viewpoint of the user of the computer system, such as displaying content at the location at which representations 702a through 702g were displayed in FIG. 7A in response to the input in FIG. 7A. In some embodiments, the computer system displays the content in the first region. In some embodiments, the computer system displays the content at the same location as the location at which the computer system displayed the first visual representations of the one or more second computer systems.

In some embodiments, displaying the content in response to receiving the input corresponding to the request to share content with the one or more second computer systems in the communication session includes, in accordance with a determination that the first region has a second location different from the first location, displaying the content in a region that includes the second location from the current viewpoint of the user of the computer system such as displaying content at the location at which representations 702a through 702g were displayed if the representations were displayed at a different location than the location shown in FIG. 7A in response to the input in FIG. 7A. In some embodiments, in response to receiving an indication of one of the one or more second computer systems sharing content in the communication session without receiving the input corresponding to the request to share content, the computer system displays the content shared by the one of the one or more second computer systems in the first region and displays the second visual representations in the second region. In some embodiments, in response to receiving the input corresponding to the request to share content with the one or more second computer systems while displaying the content in a third region, the computer system maintains display of the content in the third region and initiates display of the second visual representations in a fourth region having the respective spatial relationship to the third region. In some embodiments, the respective spatial relationship of the third region and fourth region is the same as the respective spatial relationship of the content and the second region described herein. Displaying the content at the location as the first region in which the computer system displayed the first visual representations of the one or more second computer systems enhances user interactions with the computer system by improving user comfort when transitioning from displaying the first visual representations to sharing the content and displaying the second visual representations, and maintaining spatial truth with the one or more second computer systems.

In some embodiments, while displaying the one or more first visual representations, the computer system displays, via the display generation component, a third representation of a respective second computer system in a third region of the environment from the current viewpoint of the user of the computer system, wherein the second visual representations are of a first type (e.g., two-dimensional and/or not associated with a particular location in the environment) and the third representation is of a second type (e.g., three-dimensional and/or associated with a particular location in the environment) different from the first type, such as representation 706b in FIG. 7A. In some embodiments, the third representation is a three-dimensional representation of a respective second computer system and/or of the user of the respective second computer system. For example, the third representation is a three-dimensional avatar. In some embodiments, the computer system displays the third visual representation at a location corresponding to the location of the respective second computer system in the environment, in a manner similar to the manner described above with respect to locations in the environment corresponding to various computer systems. For example, the respective second computer system presents the environment from a viewpoint at the location in the environment at which the computer system displays the third visual representation of the respective second computer system. In some embodiments, the location is in the third region. In some embodiments, the third region is different from the first region. In some embodiments, the third region is different from the second region. In some embodiments, the computer system displays a plurality of third visual representations of a plurality of respective second computer systems in a manner similar to the manner of displaying the third visual representation of the respective second computer system. In some embodiments, the computer system does not display a first visual representation corresponding to the respective second computer system while displaying the third visual representation corresponding to the respective second computer system.

In some embodiments, in response to receiving the input corresponding to the request to share content with the one or more second computer systems in the communication session, the computer system maintains display, via the display generation component, of the third representation of the respective second computer system in the third region of the environment from the current viewpoint of the user of the computer system, such as maintaining the position of representation 706b′ in the environment 700 in response to the input shown in FIG. 7A. In some embodiments, the computer system does not change the location of the third visual representation in response to receiving the input corresponding to the request to share the content item because the third visual representation is displayed at the location associated with the respective second computer system. In some embodiments, the computer system changes the location of the third representation of the respective second computer system in response to receiving an indication that the location of the respective second computer system in the environment has changed. Examples of locations in the environment associated with computer systems changing are described in more detail above. In some embodiments, the computer system does not display a second visual representation corresponding to the respective second computer system while displaying the third visual representation corresponding to the respective second computer system. In some embodiments, the third visual representation changes location in the environment in response to the input to share the content, but the new location is outside of the second region, such as in FIG. 7B Displaying the third representation of the respective second computer system in the third region enhances user interactions with the computer system by maintaining spatial truth with the respective second computer system.

In some embodiments, displaying the one or more second visual representations in response to receiving the input corresponding to the request to share content with the one or more second computer systems in the communication session includes, before displaying the one or more second visual representations in the second region, displaying, via the display generation component, an animated transition between displaying the one or more first visual representations in the first region to displaying the one or more second visual representations in the second region including movement from the first region to the second region, such as the animation shown in FIGS. 7B-7D. In some embodiments, the animation includes motion of one or more first visual representations towards the positions of one or more second visual representations. In some embodiments, the animation includes one or more first visual representations morphing into the one or more second visual representations. For example, if a first visual representation of a respective second computer system is a larger size than the second visual representation of the respective second computer system, the animation includes the first visual representation of the respective second computer system gradually shrinking. In some embodiments, the animation includes one or more first visual representations fading out. In some embodiments, the animation includes one or more second visual representations fading in. Displaying the animated transition from displaying the one or more first visual representations to displaying the one or more second visual representations enhances user interactions with the computer system by improving user comfort.

In some embodiments, while displaying the content and the one or more second visual representations in the second region with the respective spatial relationship relative to the location at which the content is displayed in the environment form the current viewpoint of the user, the computer system receives, via the one or more input devices, an input corresponding to a request to update the location of the content, such as the input shown in FIG. 7J directed to element 711a. In some embodiments, the input includes movement that has a direction and magnitude (e.g., of speed, distance, and/or duration). In some embodiments, the input includes an air gesture described above with reference to the input corresponding to the request to scroll.

In some embodiments, in response to receiving the input corresponding to the request to update the location of the content, the computer system updates the location of the content in accordance with the input, as shown in FIG. 7K. In some embodiments, moving the content in accordance with the input includes moving the content in a direction corresponding to the direction of the movement of the input. In some embodiments, moving the content in accordance with the input includes moving the content by an amount corresponding to the magnitude of movement of the input. In some embodiments, moving the content includes moving the content in the environment for all computer systems (e.g., including one or more second computer systems) in the environment, thereby maintaining shared spatial truth.

In some embodiments, in response to receiving the input corresponding to the request to update the location of the content, the computer system updates a location of the second region to maintain the respective spatial relationship relative to the updated location at which the content is displayed, as shown in FIG. 7K. In some embodiments, the computer system moves the second visual representations in the second region by the same direction and amount by which the computer system moves the content. Maintaining the spatial relationship of the second region and the content in response to moving the content enhances user interactions with the computer system by reducing the number of inputs needed to continue to interact with the content and the second visual representations concurrently when moving the content.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9J illustrate examples of a computer system displaying representations of one or more participants included in a communication session and/or shared content in an environment in accordance with some embodiments.

FIG. 9A illustrates a computer system 101a displaying, via a display generation component 120, a three-dimensional environment 900 (e.g., a three-dimensional user interface). It should be understood that in some embodiments, computer system 101a utilizes one or more techniques described with reference to FIGS. 9A-9J in a two-dimensional environment without departing from the scope of the disclosure. As described above with reference to FIGS. 1-6, the computer system 101a optionally includes a display generation component 120 (e.g., a head-mounted display) and a plurality of image sensors 314a (e.g., image sensors 314 of FIG. 3). The image sensors optionally include one or more of a visible light camera, an infrared camera, a depth sensor, or any other sensor the computer system 101a would be able to use to capture one or more images of a user or a part of the user (e.g., one or more hands of the user) while the user interacts with the computer system 101a. In some embodiments, the computer system displays the user interface or three-dimensional environment to the user, and uses sensors to detect the physical environment and/or movements of the user's hands (e.g., external sensors facing outwards from the user) such as movements that are interpreted by the computer system 101a as gestures such as air gestures, and/or gaze of the user (e.g., internal sensors facing inwards towards the face of the user).

As shown in FIG. 9A, the computer system 101 displays a three-dimensional environment 900 that includes a visual representation of one or more participants 902 (902′ in the top down view) that are part of a video communication session. As illustrated in FIG. 9A, the representation of the one or more participants 902 specifically includes two participants 904a and 904b. However, the example of FIG. 9A should not be seen as limiting to the disclosure, and the number of participants that are represented in a given visual representation can be more or less than two. In some embodiments, representation 902 is a non-spatial representation (e.g., is not a spatial representation sharing one or more characteristics with the spatial representations described above with respect to method 800). In some embodiments, and since it is non-spatial, representation 902 is displayed on a two-dimensional plane as illustrated in FIG. 9A. The representation of the one or more participants 902 in FIG. 9A includes one or more user interface elements 906 and 907 that allow the user 920 of computer system 101 to interact with the representation 902. For instance, representation 902 includes user interface element 907 that, when selected by the user (for instance by applying an air gesture such as an air pinch to the affordance while directing their gaze to the element), causes representation 902 to close (e.g., cease to be displayed). User interface element 907 (e.g., a grabber bar), when selected by the user, is used to move representation 902 to various locations within three-dimensional environment 900 (described in further detail below.)

In some embodiments, a participant of the video communication session (using their own computer system that is external to computer system 101) can transmit a shared content item to computer system 101, indicating that the participant wishes to share the shared content item with user 920 via the video communication session. In some embodiments, in response to receiving the shared content item from the external participant of the video communication system, computer system 101 displays the shared content item within the three-dimensional environment 900 as illustrated in FIG. 9B. For example, receiving the shared content item includes receiving, from the computer system associated with the participant in the communication session, an indication of the shared content. As illustrated in FIG. 9B, computer system 101 displays a visual representation of the shared content item 908 (represented as 908′ in the top-down view) within three-dimensional environment 900. In some embodiments, in order to provide a visual indication that the representation of the shared content item 908 is associated with the video communication session, computer system 101 displays the representation of the shared content item 908 in front of and both horizontally and vertically offset from the representation of the one or more participants 902 such that representation 908 partially occludes representation 902 with respect to the viewpoint of user 920.

In some embodiments, in addition to displaying the representation of the shared content item 908 in a location that is offset from the location that the representation of the one more participants 902 is displayed within the three-dimensional environment, computer system 101 visually deemphasize the representation of the one or more participants 902 with respect to the representation of the shared content item 908 (that in the example of FIG. 9B includes TV content 910) as illustrated in FIG. 9B. For instance, and as illustrated in FIG. 9B, computer system 101 changes the color of representation 902 such that it is darker in color (e.g., grayed out) with respect to representation 908 (e.g., the representation of the shared content item) thereby providing a visual indication that with respect to the video communication session, representation 908 is the active window, while representation 902 is a background window. In some embodiments, and as will be described in further detail below, even though representation 902 is visually deemphasized with respect to representation 908, it still retains user interface elements 907 and 906. In some embodiments, while representation 902 is a background window, the computer system 101 forgoes displaying user interface elements 907 and 909. Computer system 101 also displays representation 908 with its own user interface elements 913 and 912 which provide the same functionality as user interface elements 907 and 906 respectively (described above).

In some embodiments, the representation of shared content item 908 is displayed at the same orientation with respect to the user's viewpoint as the representation of the one or more participants 902 as illustrated in FIG. 9B, thereby providing another visual indicator that representation 908 is a part of the same video communication session as representation 902. As will be described in further detail below, computer system 101 generally displays virtual objects with orientations that are toward the viewpoint of the user (e.g., perpendicular to the user). However, when a representation of the shared content item 908 is at least initially displayed by computer system 101, it is initially displayed at the same orientation (e.g., parallel to) representation 908 irrespective of whether or not this orientation is towards the viewpoint of the user, thus “locking” the orientation of representation 908 to the orientation of representation 902. However, as discussed in further detail below, the orientation of representation 908 optionally becomes unlocked with respect to the orientation of representation 902, after initially being displayed in three-dimensional environment 900 and when the user changes the location at which representation 908 is displayed within the three-dimensional environment 900.

In some embodiments, the location in the three-dimensional environment 900 at which the representation of the shared content item 908 is displayed at is dependent on the location of the representation of the one or more participants 902 and is independent from the viewpoint of the user 920 of computer system 101 as illustrated in FIG. 9C. As illustrated in FIG. 9C, user 920, while engaged in a video communication session that includes representation 902 but does not yet include representation 908, has rotated/moved their viewpoint such that representation 902 is no longer visible. Instead, user interface 903 (that displays application content, and includes one or more user interface elements 905 and 909) is visible to the user 920 within three-dimensional environment 900 while representation 902 is not visible (but is still located within the three-dimensional environment). For example, the top-down view of the three-dimensional environment 900′ in FIG. 9C illustrates the position of the representation 902′ outside of the field of view of the user 920.

In some embodiments, even though representation 902 is not visible within the field of view (e.g., viewport) of user 920, when a shared content item that is associated with the video communication session with which representation 902 is associated is initially displayed by computer system 101, the computer system can provide one or more visual indicators to the user 920 indicating that a newly displayed shared content item has been introduced into three-dimensional environment 900 as illustrated in FIG. 9D. As illustrated in FIG. 9D, and specifically in the top-down view of the three-dimensional environment 900′, the representation of shared content item 908′ is placed by computer system 101 in the three-dimensional environment 700′ based on the location of representation 902′ so that it partially occludes representation 902′ from the position of the user 920 as described above with respect to FIG. 9B. However, since the viewpoint of user 920 is such that neither representation 902 nor 908 are visible to user 920 (since their viewpoint is directed to another portion of three-dimensional environment 900), user 920 may not be aware that the shared content item has been displayed. Thus, in some embodiments, in response to introducing representation 908 into the three-dimensional environment, computer system 101 visually deemphasizes any visible virtual objects, such as user interface 903, using the deemphasis techniques (e.g., graying out) described above to provide the user with a visual indication that a shared content item has been associated with the video communication session.

In some embodiments, and as described above, the placement of a representation of a shared content item within the three-dimensional environment 900 (including location and orientation) is based on the location of the representation of the one or more participants of the video communication session and is not based on the viewpoint of the user as illustrated in FIGS. 9E-9F. In the example of FIG. 9E, the viewpoint of user 920 with respect to three-dimensional environment 900 is different than the viewpoint illustrated in FIG. 9A. Specifically, the representation of the one or more participants 902 is now located to the left of user 920. As illustrated in FIG. 9E, the orientation of representation 902 is slightly skewed so that representation 902 faces user 920, since the representation is to the left of the user rather than directly in front of the user as in the example of FIG. 9A. In some embodiments, when representation 908 is initially displayed by computer system 101 within three-dimensional environment 900, the location at which it is displayed (as well as its orientation with respect to the viewpoint of the user) is based on the location and orientation of representation 902 as illustrated in FIG. 9F.

As illustrated in FIG. 9F, the representation of the shared content item 908 is placed by computer system 101 within three-dimensional environment 900 such that it is partially (visually) occludes representation 902, in substantially the same manner as described above with respect to FIG. 9B. Thus, similar to the example of FIG. 9B, computer system 101 displays representation 908 according to a pre-defined spatial relationship to representation 902 regardless of what the user's viewpoint of the three-dimensional environment 900 is at the time that representation 908 is initially displayed within the three-dimensional environment 900 by computer system 101. In some embodiments, the orientation of representation 908 is locked to the orientation of representation 902 such that the two representations are parallel to one another (i.e., have the same orientation) even though representation 908 is both horizontally and vertically displaced within the three-dimensional environment 900 with respect to representation 908.

In some embodiments, while the representation of the shared content item 908 is displayed within the three-dimensional environment 900 according to a pre-defined spatial relationship to the representation of the one or more participants 902 as described above and at an orientation that is locked to the orientation of representation 902, the user can relocate (e.g., move) representation 902 and/or representation 908 within the three-dimensional environment as illustrated in FIGS. 9G-9J. In the example of FIG. 9G, while the representation of the shared content item 908 and the representation of the one or more participants 902 are displayed within three-dimensional environment 900 such that representation 908 partially occludes representation 902 and is oriented parallel to representation 902 such as in FIG. 9F, computer system 101 detects that the user's gaze 903d is directed to user interface element 912 (e.g., the grabber bar) and that the user is performing an air pinch gesture with hand 913d while moving hand 913d to the right thereby indicating that the user is moving representation 908 to the right. In some embodiments, and in response to detecting that the user's gaze 903d is directed to user interface element 912 while performing an air pinch with hand 913d, computer system 101 removes the orientation lock between representation 908 and 902, and displays representation 908 at an orientation that is commensurate with the position of representation 908 with respect to the viewpoint of the user as illustrated in FIG. 9G.

In some embodiments, and in response to the user's input described above (e.g., the gaze of the user 903d directed to user interface element 912 while performing an air pinch), computer system moves the representation of the shared content item 908 within three-dimensional environment 900 commensurate with the amount of movement of user's hand 913d as illustrated in FIG. 9H. As illustrated in FIG. 9H, the representation of the shared content item 908 is now located further to the right of representation of the one or more participants 902 and is now oriented with respect to user 920 in accordance with its location within the three-dimensional environment 900 with respect to user 920. In some embodiments, and as illustrated in FIG. 9H, computer system 101 maintains the visual deemphasis of representation 902 while representation 908 is being moved within three-dimensional environment 900. Alternatively, in some embodiments, and in response to moving representation 908, computer system 101 removes the visual deemphasis of representation 902 such that its visual emphasis is the same as the visual emphasis of representation 908 (e.g., representation 902 is no longer grayed out).

In some embodiments, in addition to having the option to move representation 908, computer system 101 can move the representation of the one or more participants 902 as illustrated in FIGS. 91-9J. In the example of FIG. 9I, while representation 908 and representation 902 are displayed such that representation 908 partially occludes representation 902 and is oriented in parallel to representation 902 such as in FIG. 9F, computer system 101 detects the gaze of the user 903d directed to user interface element 906 (e.g., the grabber bar) of representation 902, while also detecting that the user is performing an air pinch with hand 913d. In response to detecting that the gaze of the user 903d is directed to user interface element 906 of representation 902, and that the user is performing an air pinch with hand 913d, computer system 101 removes the orientation lock between representation 908 and representation 902 such that representation 908 (rather than being locked to the orientation of representation 902) is oriented towards the viewpoint of user 920 commensurate with its location within three-dimensional environment 900. Additionally, as illustrated in FIG. 9I, computer system 101 removes the visual deemphasis of representation 902 and causes representation 902 to visually “break through” representation 908 such that the portion of representation 902 that was visually occluded by representation 908 is at least partially visible through representation 902.

In some embodiments, and in response to the user's input described above (e.g., the gaze of the user 903d directed to user interface element 906 while performing an air pinch), computer system moves the representation of the one or more participants 902 within three-dimensional environment 900 commensurate with the amount of movement of user's hand 913d as illustrated in FIG. 9J. As illustrated in FIG. 9J, the representation of the one or more participants 902 is now located further to the right of representation of the shared content item 908 and is now oriented with respect to user 920 in accordance with its location within the three-dimensional environment 900 with respect to user 920. In some embodiments, and as illustrated in FIG. 9J, computer system 101 in response to the selection of representation 902 described above with respect to FIG. 9I, visually emphasizes representation 902, while visually deemphasizing representation 908 (e.g., graying out representation 908.) Alternatively, in some embodiments, computer system 101 continues to display representation 908 without any visual deemphasis. In some embodiments, computer system 101 can move either of representation 902 or representation is the X, Y, and/or Z directions based on the X, Y, and/or Z movement of the hand 913d.

FIG. 10 is a flowchart illustrating an exemplary method displaying representations of shared content items associated with a video communication session according to one or more embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system in communication with one or more input devices and a display generation component. For example, the computer system, the one or more input devices, and/or the display generation component have one or more characteristics of the computer system(s), the one or more input devices, and/or the display generation component(s) described with reference to method 800. In some embodiments, while a user of the computer system is participating in a communication session with one or more participants (1002), (for example a video communication session in which the computer system displays one or more visual representations of the one or more participants, while emitting and/or generating audio associated with the one or more participants; in some embodiments, the communication session and/or the one or more participants have one or more of the characteristics of the communication sessions and/or one or more participants described with reference to method 800) and while displaying a representation of the one or more participants in a three-dimensional environment that is visible via the display generation component from a respective viewpoint of the user, such as the representation of the one or more participants 902 in FIGS. 9A-9J, (in some embodiments, the three-dimensional environment displayed by or visible via the computer system has one or more characteristics of the three-dimensional environment described with reference to method 800), the computer system receives (1004), from a computer system of one of the one or more participants, an indication to display a shared content item associated with the communication session in the three-dimensional environment (such as receiving an indication to display the representation of shared content item 908 in FIG. 9B from an external computer system associated with a participant of a video communication session). In some embodiments, the shared content item that is displayed by the computer system is a user interface of an application other than the application associated with the communication session (e.g., other than the application that is facilitating and/or displaying content for the communication session, such as a video call application). In some embodiments, the shared content item includes image, video, and/or audio content different from the image(s), video, and/or audio captured as part of the communication session. For instance, the content items can include a move, television show, or audio content displayed by a content playback application. Alternatively or additionally, the content items can include photos and/or text-based documents that are shared via a word/image processing application. In some embodiments, sharing content with the one or more computer systems of the one or more participants enables the one or more computer systems associated with the one or more participants to present the content while in the communication session with the computer system. In some embodiments, while the content is being shared, the computer system and the one or more computer systems of the one or more participants present the content in a synchronized manner, such as the computer system and the one or more participant computer systems playing video content with the playback position synchronized across the computer system and the one or more participant computer systems, or the computer system and the one or more participant computer systems concurrently displaying the same user interface of a respective application other than the application associated with the communication session. In some embodiments, the shared content item includes one or more characteristics of the “content” described above with respect to method 800. In some embodiments, the indication to display the shared content item is transmitted from a computer system of a participant of the video communication session (external to the computer system of the user). For instance, if a participant of the video communication session wishes to share content, the computer system of the participant transmits information regarding the content to the computer system of the user, thus transmitting to the computer system the indication to display the shared content item. In some embodiments, receiving an indication to display the display the shared content item, includes detecting an input for sharing such as receiving an input at a user interface (e.g., by detecting an air gesture such as an air pinch while the gaze of the user is directed to the user interface) indicating the user wants to view the shared content item that is transmitted by the computer system of the participant wishing to share content. In some embodiments, the input for sharing includes one or more characteristics of the input for sharing content described above with respect to method 800.

In some embodiments, in response to receiving the indication to display the representation of the shared content item in the three-dimensional environment and in accordance with one or more criteria being satisfied (1006), the computer system displays (1008) the representation of the shared content item at a first location within the three-dimensional environment, wherein the representation of the shared content item, when displayed at the first location within the three-dimensional environment, partially occludes the representation of the one or more participants from the respective viewpoint of the user. For instance, the location of representation 908 within three-dimensional environment 900 partially occludes representation 902 in FIG. 9B. In some embodiments, the one or more criteria includes but is not limited to receiving an input from the user of the computer system to display to accept the content item shared by the participant. Additionally or alternatively, the one or more criteria includes any criteria that is indicative of a request to display the shared content item in the three-dimensional environment. In some embodiments, and as described in further detail below, the one or more criteria includes a determination that the representation of the one or participants is a non-spatial representation. In some embodiments, the first location within the three-dimensional environment is configured to display the shared content item within the three-dimensional environment such that the shared content partially occludes a representation of the one or more participants, thereby providing the user of the computer system with a visual indicator that the shared content item is associated with the video communication session with the one or more participants. In some embodiments, “partially occludes” refers to displaying the shared content item in the three-dimensional environment such that at least a part of the representation of the one or more participants is visible with respect to the viewpoint of the user in the three-dimensional environment. In some embodiments, the first location is determined/selected by the computer system based on one or more of the following factors: the size of the shared content item to be displayed, the size of the representation of the one or more participants, the size of the three-dimensional environment, the location of the representation of the one or more participants within the three-dimensional environment (from the viewpoint of the user), and the type of content that is being shared via the shared content item. In some embodiments, the first location is selected by the computer system such that a center point of the shared content item and a center point of the representation of the one or more participants are offset with respect to one another. As an example, the first location is selected by the computer system such that the shared content item is displayed higher and to the right of the representation of the one or more participants, thereby partially occluding the representation of the one or more participants but still allowing for a portion of the representation of the one or more participants to be visible within the three-dimensional environment from the viewpoint of the user. In some embodiments, the first location is any location that is offset from the location of the representation of the one or more participants such that when the shared content item is displayed by the computer system at the first location, the shared content item partially covers/occludes the representation of the one or more participants without completely occluding the representation from the viewpoint of the user. In some embodiments, the viewpoint of the user and the representation of the one or more participants do not change locations when the share content item is initially displayed in the three-dimensional environment. Displaying the shared content item so as to partially occlude a representation of one or more participants in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, in response to receiving the indication to display the representation of the shared content item in the three-dimensional environment and in accordance with the one or more criteria being satisfied, the computer system displays the representation of the one or more participants at a second location within the three-dimensional environment, different from the first location, wherein the first location is closer to the respective viewpoint of the user than the second location. For example, the representation of the shared content item 908 is closer to the user of computer system 101 than the representation of the one or more participants 902 in FIG. 9B. In some embodiments, the computer system sets the first location at which to display the representation of the shared content window at a location that both causes the representation of the shared content window to both partially occlude the representation of the shared content window and causes the representation of the shared content window to be closer (e.g., distance wise) to the viewpoint of the user of the computer system within the three-dimensional environment. In some embodiments, the first location can be closer to viewpoint with respect to any of the three orthogonal dimensions of the three-dimensional environment, including the X-direction (e.g., horizontal), the Y-direction (e.g., vertically), or the Z-direction (e.g., depth wisc.) In some embodiments, the first location is closer to the viewpoint than the second location according to any combination of the three orthogonal dimensions described above. Thus, in some embodiments, the first location is closer to the viewpoint of the user than the second location, if it is closer to the viewpoint of the user according to any one of the three orthogonal dimensions of the three-dimensional environment. For instance, if the first location is closer to the viewpoint of the user in the X-direction than the second location, it is deemed to be closer to the viewpoint of the user regardless of the distances in the Y-direction and Z-direction. In some embodiments, the distance between the first location and the viewpoint of the user as well as the distance between the second location and the viewpoint of the user are measured from the center of the representation of the shared content window and the center of the representation of the representation of the one or more participants respectively. Additionally or alternatively, the distance between the first location and the viewpoint of the user as well as the distance between the second location and the viewpoint of the user are measured from the edge of each representation that is closest to the viewpoint of the user. Displaying the shared content item so that it both partially occludes a representation of one or more participants and is closer to the viewpoint of the user in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, the first location is in front of the second location relative to the viewpoint of the user of the computer system in a depth dimension of the three-dimensional environment such as representation 908 being closer to the user in the depth dimension than representation 902 in FIG. 9B. In some embodiments, the first location is selected by the computer system such that the representation of the shared content item is closer to the viewpoint of the user in the Z-direction (e.g., displayed as being in front of the representation of the one or more participants.) In some embodiments, by displaying the representation of the shared content item in front of the representation of the one or more participants (e.g., closer in the depth dimension), the computer system causes the representation of the shared content item to partially occlude the representation of the one or more participants. Displaying the shared content item so that it both partially occludes a representation of one or more participants and is closer to the viewpoint of the user in the depth dimension in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, displaying the representation of the shared content item at the first location includes displaying the shared content item on a two-dimensional plane within the three-dimensional environment. For instance, the representation of shared content item 908 is displayed on a two-dimensional plane in FIG. 9B. In some embodiments, the shared content item is a two-dimensional content item and is thus displayed on a two-dimensional plane within the three-dimensional environment. Additionally or alternatively, the two-dimensional shared content item is displayed within the three-dimensional environment within a three-dimensional volume of the three-dimensional environment. In some embodiments, the shared content item is a three-dimensional content item that is displayed within a three-dimensional volume of the three-dimensional environment. Displaying a two-dimensional shared content item on a two-dimensional plane with the three-dimensional environment in a video communication session when the shared content item is associated with the video communication session allows for continued engagement with the video communication session without the need for additional user input to do so, thus minimizing the occurrence of erroneous user input and thereby conserving computing resources associated with correcting erroneous input.

In some embodiments, displaying the representation of the one or more participants includes displaying the representation of the one or more participants on a two-dimensional plane within the three-dimensional environment. For instance, the representation of the one or more participants 902 is displayed on a two-dimensional plane in FIG. 9B. In some embodiments, the representation of the one or more participants is a non-spatial representation and that represented in two-dimensions and is thus displayed on a two-dimensional plane within the three-dimensional environment. Additionally or alternatively, the two-dimensional representation of the one or more participants is displayed within the three-dimensional environment within a three-dimensional volume of the three-dimensional environment. In some embodiments, the non-spatial representation of the one or more participants is a three-dimensional representation that is displayed within a three-dimensional volume of the three-dimensional environment. Displaying a two-dimensional representation of the one or more participants on a two-dimensional plane with the three-dimensional environment in a video communication session when the shared content item is associated with the video communication session allows for continued engagement with the video communication session without the need for additional user input to do so, thus minimizing the occurrence of erroneous user input and thereby conserving computing resources associated with correcting erroneous input.

In some embodiments, displaying the representation of the shared content item in response to receiving the indication to display the representation of the shared content item in the three-dimensional environment and in accordance with the one or more criteria being satisfied comprises displaying the representation of the shared content item at an orientation relative to the three-dimensional environment (and/or the viewpoint of the user) that is the same as an orientation of the representation of the one or more participants relative to the three-dimensional environment (and/or the viewpoint of the user). For instance, as illustrated in FIG. 9B, the representation of the shared content item 908 is displayed at an orientation that is parallel (e.g., the same orientation) as the representation of the one or more participants 902. In some embodiments, the representation of the shared content item while being displayed at the first location so as to partially occlude the representation of the one or more participants, is also displayed with an orientation that is the same as the orientation of the representation of the one or more participants regardless of the horizontal and/or vertical position of the representation of the shared content item within the three-dimensional environment relative to the viewpoint of the user. Thus, in some embodiments, the orientation of the representation of the shared content item (when first displayed within the three-dimensional environment) is “locked” to or based on the orientation of the representation of the one or more participants. In some embodiments, being “locked” to the orientation of the representation of the one or more participants, means that the orientation of the representation of the shared content item is set as if the representation of the shared content item were being displayed in the same location as the representation of the one or more participants, regardless of whether the first location is different from the location that the representation of the one or more participants is displayed is either the horizontal, vertical, or depth dimensions. In some embodiments, both the representations of the shared content item and the one or more participants are orientated at the same angle relative to the viewpoint of the user and are thus parallel to one another. In some embodiments, if the representation of the one or more participants has a first orientation relative to the three-dimensional environment, the representation of the shared content item will also have the first orientation when initially displayed by the computer system. In some embodiments, if the representation of the one or more participants has a second orientation relative to the three-dimensional environment, different from the first orientation, the representation of the shared content item will also have the second orientation when initially displayed by the computer system. Displaying the representation of the shared content item with the same orientation as the representation of the one or participants in a video communication session when the shared content item is associated with the video communication session allows for continued engagement with the video communication session without the need for additional user input to do so, thus minimizing the occurrence of erroneous user input and thereby conserving computing resources associated with correcting erroneous input.

In some embodiments, while displaying the representation of the shared content item at the first location, and while displaying the representation of one or more participants at a second location in the three dimensional environment (wherein the first location and second locations are set such that representation of the shared content window partially occludes the representation of the one or more participants as described above), the computer system receives, via the one or more input devices, a first input from a first portion of the user, including a first air gesture directed to the representation of the one or more participants followed by movement of the first portion of the user such as the air pinch and movement performed by hand 913d in FIG. 9G. In some embodiments, the first input from the first portion of the user is performed while the user's gaze is directed to the representation of the one or more participants (at the portion of the representation and/or at a repositioning element that is not occluded by the representation of the shared content item). In some embodiments, the first air gesture is an air pinch (e.g., the user performing a pinch with their hand) while the computer system detects that the user's gaze is directed to the representation of the one or more participants.

In some embodiments, in response to receiving the first input, the computer system moves the representation of the one or more participants to a third location within the three-dimensional environment in accordance with the detected movement of the first portion of the user, and wherein the third location is different from the second location such as moving representation 902 from its original location within the three-dimensional environment shown in FIG. 9G, to a new location as shown in FIG. 9H. In some embodiments, once the computer system detects the first input followed by movement of the first portion of the user, the computer system removes the orientation lock between the representation of the shared content item and the representation of the one or more participants, thereby causing the representation of the shared content item to be orientated towards the viewpoint of the user based on one or more of the horizontal and/or vertical position of the shared content item within the three-dimensional environment. Alternatively, the computer system maintains the orientation of the representation of the shared content so that it remains the same as the orientation of the representation of the one or more participants. In some embodiments, the computer system detects the movement of the user's hand and moves the representation of the one or more participants in accordance with the movement of the user's hand. In some embodiments, the movement of the user's hand to move the representation of the one or more participants (after selecting the representation of the one or more participants) constitutes an air gesture. In some embodiments, the computer system changes the orientation of the representation of the one or more participants in accordance with the horizontal and vertical movement of the representation within the three-dimensional environment, such that the representation of the one or more participants is always oriented toward the user while it is being moved within the three-dimensional environment and is oriented toward the user once the first input has been terminated. Additionally, the computer system changes the orientation of the representation of the one or more participants such that the orientation of the representation of the one or more participants changes relative to the orientation of the representation of shared content item. In some embodiments, moving the representation of the one or more participants to the third location causes the representation of the shared content item to no longer visually occlude the representation of the one or more participants. In some embodiments, the representation of the one or more participants is moved independent of the representation of the shared content item, such that the representation of the shared content item maintains its location even though the location that the representation of the one or more participants is displayed at is changing. Enabling the user of the computer system to move the representation of the one or more participants with air gestures reduces unpredictable movements of the representation in the three-dimensional environment and minimizes the amount of input required to move a representation of the one or more participants to a specific location within the environment, thus minimizing the occurrence of erroneous user input and thereby conserving computing resources associated with correcting erroneous input.

In some embodiments, while displaying the representation of the shared content item at the first location, the computer system receives, via the one or more input devices, a first input from a first portion of the user, including a first air gesture directed to the representation of the shared content item followed by movement of the first portion of the user such as the air pinch and movement performed by hand 913d in FIG. 9I. In some embodiments, the first input from the first portion of the user is performed while the user's gaze is directed to the representation of the shared content item. In some embodiments, the first air gesture is an air pinch (e.g., the user performing a pinch with their hand) while the computer system detects that the user's gaze is directed to the representation of the shared content item.

In some embodiments, in response to receiving the first input, the computer system moves the representation of the shared content item to a third location within the three-dimensional environment in accordance with the detected movement of the first portion of the user, and wherein the third location is different from the first location such as moving representation 908 from its original location within the three-dimensional environment shown in FIG. 9I, to a new location as shown in FIG. 9J. In some embodiments, once the computer system detects the first input followed by movement of the first portion of the user, the computer system removes the orientation lock between the representation of the shared content item and the representation of the one or more participants, thereby causing the representation of the shared content to be oriented towards the viewpoint of the user based on one or more of the horizontal and/or vertical position of the shared content item within the three-dimensional environment. Alternatively, the computer system maintains the orientation of the representation of the shared content item maintains so that it remains the same as the orientation of the representation of the one or more participants. In some embodiments, the computer system detects the movement of the user's hand and moves the representation of the one shared content item in accordance with the movement of the user's hand. In some embodiments, the movement of the user's hand to move the representation of the shared content item (after selecting the representation of the one or more participants) constitutes an air gesture. In some embodiments, moving the representation of the shared content item to the third location causes the representation of the shared content item to no longer visually occlude the representation of the one or more participants. In some embodiments, the computer system changes the orientation of the representation of the shared content item such that the orientation of the representation of the shared content item changes relative to the orientation of the representation of the one or more participants. In some embodiments, the representation of the shared content item is moved independent of the representation of the one or more participants, such that the representation of the one or more participants item maintains its location even though the location that the representation of the shared content item is displayed at is changing. Enabling the user of the computer system to move the representation of the shared content item with air gestures reduces unpredictable movements of the representation in the three-dimensional environment and minimizes the amount of input required to move a representation of the one or more participants to a specific location within the environment, thus minimizing the occurrence of erroneous user input and thereby conserving computing resources associated with correcting erroneous input.

In some embodiments, moving the representation of the shared content item to the third location comprises changing an orientation of the representation of the shared content item relative to an orientation of the representation of the one or more participants and/or relative to the three-dimensional environment as demonstrated by the change in the orientation of representation 908 between FIGS. 91 and 9J. In some embodiments, the computer system changes the orientation of the representation of the shared content item in accordance with the horizontal and vertical movement of the representation within the three-dimensional environment, such that the representation of the shared content item is always oriented toward the viewpoint of the user while it is being moved within the three-dimensional environment and is oriented toward the viewpoint of the user once the first input has been terminated (e.g., the normal of the shared content item remains parallel to a vector extending from a center of the shared content item to the viewpoint of the user). In some embodiments, changing the orientation of the representation of the shared content item such that it is orientation toward the user causes the orientation of the shared content item to change with respect to the three-dimensional environment. Changing the orientation of the shared content item as it is moved within the three-dimensional environment so that the representation is orientation towards the user reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, the first location is based on a location of the representation of the one or more participants in the three-dimensional environment such as the location of representation 908 in FIG. 9B. In some embodiments, the first location is selected by the computer system such that the representation of the shared content item partially occludes the representation of the one or more participants. For example, the first location is selected to cause the representation of the shared content item to be located in front of (in the depth dimension) and to the side (either right or left) of the representation of the one or more participants, thereby partially occluding the representation of the one or more participants when the representation of the shared content item is initially displayed within the three-dimensional environment. In some embodiments, the representation of the shared content item is also vertically offset from the representation of the one or more participants. In some embodiments, the first location is also based on the size of the representation of shared content item and/or the size of the representation of one or more participants. For instance, if the size of the representation of the shared content item is large with respect to the size of the representation of the one or more participants, then the first location will be set by the computer system to be further in a horizontal and/or vertical direction, than if the size of the representation of the shared content item were smaller, so as to ensure that when the representation of the shared content item is displayed in the three-dimensional environment it only partially occludes the representation of the one or more participants rather than fully occluding it. In some embodiments, the first location is selected by the computer system such that a pre-determined minimum portion of the representation of the one or more participants are visible in either or both of the X and Y directions. In some embodiments, if the representation of the one or more participants is located at first location then the representation of the shared content item is located at a second location within the three-dimensional environment such that the representation of the shared content item has a first spatial representation with the representation of the one or more participants. If the representation of the one or more participants is located at a third location in the three-dimensional environment, different from the first location, then the representation of the shared content item is located at a fourth location, different from the second location, such that the representation of the one or more participants and the representation of the shared content item has the same first spatial relationship. Displaying the shared content item at a location in the three-dimensional environment based on the location that the representation of the one or more participants is displayed in the three-dimensional environment in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, the representation of the one or more participants is displayed at a second location in response to receiving the indication to display the representation of the shared content item in the three-dimensional environment and in accordance with the one or more criteria being satisfied, and wherein the first location of the shared content item has a pre-defined spatial relationship (e.g., position and/or orientation) to the second location of the representation of the one or more participants in the three-dimensional environment such as the spatial relationship between representation 908 and representation 902 illustrated in FIG. 9B. In some embodiments, the pre-defined spatial relationship between the representation of the shared content item and the representation of the one or more participants is configured to ensure that the representation of the shared content item partially occludes the representation of the one or more participants as described above. In some embodiments the pre-defined spatial relationship takes into account the sizes of the representation of the shared content item and the representation of the one or more first participants, so as to ensure that the representation of the shared content item will partially occlude the representation of the one or more participants when it is initially displayed in the three-dimensional environment. In some embodiments, the pre-defined relationship can be specified using the three orthogonal dimensions of the three-dimensional environment. For instance, the pre-defined relationship is specified as a displacement from the X, Y, and Z coordinates of the second location where the representation of the one or more participants is located. Thus, the pre-defined spatial relationship takes the X, Y, and Z coordinates of the second location and adds pre-defined values to the coordinates to determine the first location. As an example, the displacement that defines the pre-defined relationship is set to cause the representation of the shared representation to be in front of (in terms of depth) by a first predetermined amount, higher vertically (e.g., in the Y-direction) by a second predetermined amount and to the right horizontally (e.g., in the X-direction) by a third predetermined amount. The first, second, and/or third predetermined amounts are optionally absolute distances, distances proportional to the size(s) of the representations of participants and/or the shared content, and/or a combination of the two. By setting the pre-defined spatial relationship to be based on the second location, the position of the representation of the shared content item relative to the representation of the one or more participants will be the same no matter where in the three-dimensional environment the representation of the one or more participants is located. Displaying the shared content item at a location in the three-dimensional environment that is based on a pre-defined spatial relationship between the representation of the one or more participants and the representation of the shared content it in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, displaying the representation of the shared content item at the first location in response to receiving the indication to display the representation of the shared content item in the three-dimensional environment and in accordance with the one or more criteria being satisfied includes: in accordance with displaying the three-dimensional environment from a first viewpoint of the user, displaying the representation of the shared content item at the first location, and in accordance with displaying the three-dimensional environment from a second viewpoint of the user, different from the first viewpoint, displaying the representation of the shared content item at the first location. For instance, the placement of representation 908 with respect to representation 902 is the same regardless of whether the user's viewpoint encompasses representation 902 as in FIG. 9B or does not as in FIG. 9D. In some embodiments, the first location is not based on the viewpoint of the user (e.g., is independent of the viewpoint of the user), but rather is based on the location within the three-dimensional environment where the representation of the one or more participants is located within the three-dimensional environment as described above. Thus, in some embodiments, regardless of whether the viewpoint of the user (e.g., the user's field of view) encompasses the representation of the one or more participants or the representation is not visible to the user at their current viewpoint, the first location at which the representation of the shared content is placed within the three-dimensional environment is the same. In some embodiments, the representation of the shared content item becomes visible to the user when the user's viewpoint encompasses the first location but is otherwise not visible if the viewpoint does not encompass the first location. However, in some embodiments, the first location is not dependent on the viewpoint of the user. Displaying the shared content item at a location in the three-dimensional environment that is not based on the viewpoint of the user, but rather is based a pre-defined spatial relationship between the representation of the one or more participants and the representation of the shared content it in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, in response to displaying the representation of the shared content item at the first location within the three-dimensional environment, the computer system visually emphasizes the representation of the shared content item relative to the representation of the one or more participants. For example, representation 908 is visually emphasized with respect to representation 902 (e.g., representation 902 is visually deemphasized) as illustrated in FIG. 9B. In some embodiments, visually emphasizing the representation of the shared content item with respect to the representation of the one or more participants includes modifying the visual emphasis of the representation of the one or more first participants to be at a lower level of emphasis relative to the representation of the shared content item. For instance, when the representation of the shared content item is initially displayed in the three-dimensional environment, the representation of the one or more participants is visually deemphasized (e.g., relative to the three-dimensional environment) by removing one or more selectable options for manipulating the representation from the representation and/or altering the color, brightness, and/or translucency of the representation so that it appears visually duller or darker in comparison to the representation of the shared content item. In some embodiments, in addition to or alternatively to visually deemphasizing the representation of the one or more participants, the representation of the shared content item can be displayed with a level of visual emphasis (e.g., relative to the three-dimensional environment) that is greater than the level of visual emphasis with which the representation of the one or more participants is displayed (e.g., relative to the three-dimensional environment). For instance, using color, translucency/opaqueness, brightness, or other visual characteristics that are configured to highlight the appearance of the representation of the shared content item, the representation is displayed in manner that visually distinguishes (e.g., displayed at a higher level of emphasis) the representation of the shared content item from the representation of the one or more participants. Displaying the representation of the shared content item with a visual emphasis that is greater than a visual emphasis of the representation of the one or more participants it in a video communication session when the shared content item is associated with the video communication session allows for continued engagement with the video communication session without the need for additional user input to do so, and minimizes the likelihood of portraying the shared content item to the user of the computer system as being unassociated with a video communication session, thus minimizing the occurrence of erroneous user input and thereby conserving computing resources associated with correcting erroneous input.

In some embodiments, visually emphasizing the representation of the shared content item relative to the representation of the one or more participants comprises: while displaying the three-dimensional environment from a first viewpoint of the user, and while displaying a first virtual object within the three-dimensional environment, in response to displaying the representation of the shared content item at the first location within the three-dimensional environment, visually deemphasizing the first virtual object relative to the three-dimensional environment (and/or the representation of the shared content item) such as virtual object 903 being visually deemphasized in FIG. 9D. In some embodiments, when the representation of the one or more participants is not within the viewpoint being displayed by the computer system, the computer system alerts the user of the computer system that the representation of the shared content item has been introduced into the three-dimensional environment by visually deemphasizing other user interfaces or virtual objects displayed in the three-dimensional environment that are within the viewpoint of the user. In some embodiments, visually deemphasizing the virtual object includes removing one or more selectable options for manipulating virtual object and/or altering the color of the representation so that it appears visually duller or darker in comparison to the representation of the shared content item (e.g., graying out the virtual object). In some embodiments, the visual deemphasis is temporary and is undone after a pre-determined amount of time has passed. Additionally or alternatively, the visual deemphasis is undone after the computer system has detected that that the user has directed their attention (e.g., gaze) to the representation of the shared content item, or has otherwise provided an input to the computer system acknowledging the representation of the shared content item. In some embodiments, the representation of the shared content item may not be within the field of view (e.g., viewport) of the user. Thus, in response to detecting that the shared content item is now a part of the video communication session, the computer system visually deemphasizes the virtual object to provide the user with a visual indication that the shared content item has become part of the video communication system. Displaying other virtual objects with a lower visual emphasis than the representation of the shared content item, even when the representation of the shared content item is not within the viewpoint of the allows for the user to be alerted to the representation of the shared content item and minimizes the likelihood of portraying the shared content item to the user of the computer system as being unassociated with a video communication session, thus minimizing the occurrence of erroneous user input and thereby conserving computing resources associated with correcting erroneous input.

In some embodiments, the one or more criteria include a criterion that is satisfied when the representation of the one or more participants corresponds to one or more non-spatial representations such as illustrated in FIG. 7D. In response to receiving the indication to display the representation of the shared content item in the three-dimensional environment, in accordance with a determination that the representation of the one or more participants corresponds to one or more spatial representations, the computer system displays the shared content item at a third location in the three-dimensional environment, different from the first location, wherein the representation of the shared content item, when displayed at the third location within the three-dimensional environment does not visually occlude the representation of the one or more participants from the respective viewpoint of the user such as the arrangement between the representation of shared content item and the representation of the one or more participants illustrated in FIG. 7D. In some embodiments, a spatial representation shares one or more characteristics with the spatial characteristics described above with respect to method 800. In one or more examples, and in response to detecting that that the representation of the one or more participants is a spatial representation, the computer system displays the representation of the shared content so that both representations are completely visible within the three-dimensional environment without visually occluding one another, optionally with the shared content item being displayed at the previous location of the representation of the one or more participants, and the representation of the one or more participants being displayed at a new location in the three-dimensional environment. For instance, each representation is displayed side-by-side within the environment (such as in a manner described above with respect to FIGS. 7A-7T and described with respect to method 800 above). Displaying the representation of the one or more participants in a location relative to the location at which the representation of the shared content is displayed such that both representations do not visually occlude one another, enhances user interactions with the computer system by reducing the number of inputs needed to continue to interact with the communication session while sharing the content with the communication session, thereby simplifying user operation of the computer system and conserving time and power consumption of the computer system and avoids spatial conflicts between the shared content and the one or more second representations.

In some embodiments, in response to receiving the indication to display the representation of the shared content item in the three-dimensional environment, in accordance with the determination that the representation of the one or more participants is a spatial representation, the computer system moves the representation of the one or more participants from the second location within the three-dimensional environment to a fourth location within the three-dimensional environment, different from the second location such as the locations of representations 705a through 705c with respect to representation 712 in FIG. 7D. In some embodiments, moving the representation of the one or more participants from the second location to the fourth location in response to receiving the indication to display the representation of the shared content item shared one or more characteristics with the movement of the representation of the one or more participants described above with respect to method 800. In some embodiments, the fourth location is configured to allow for both the representation of the shared content item and the representation of the one or more participants to be simultaneously displayed within the three-dimensional environment (without visually occluding one another) without requiring the user of the computer system to adjust their viewpoint.) Displaying the representation of the one or more participants in a location relative to the location at which the representation of the shared content is displayed such that both representations do not visually occlude one another by moving the location at which the representation of the one or more participants is displayed within the three-dimensional environment, enhances user interactions with the computer system by reducing the number of inputs needed to continue to interact with the communication session while sharing the content with the communication session, thereby simplifying user operation of the computer system and conserving time and power consumption of the computer system and avoids spatial conflicts between the shared content and the one or more second representations.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

In some embodiments, aspects/operations of methods 800 and/or 1000 may be interchanged, substituted, and/or added between these methods. For example, the three-dimensional environments of methods 800 and/or 1000, the virtual objects of methods 800 and 1000, the virtual representations of methods 800 and/or 1000, the communication sessions of methods 800 and/or 1000, the attention (e.g., gaze) and attention-based inputs of methods 800 and/or 1000, techniques to move (e.g., change spatial arrangement of) virtual objects (e.g., and/or virtual representations) in 800 and/or 1000, and/or techniques to change (e.g., reduce) the visual prominence of virtual representations in methods 800 and/or 1000, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing and sharing video may enhance communication sessions with other computer systems. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with one or more input devices and a display generation component:
while a user of the computer system is participating in a communication session with one or more participants, and while displaying a representation of the one or more participants in a three-dimensional environment that is visible via the display generation component from a respective viewpoint of the user, receiving, from a computer system of one of the one or more participants, an indication to display a shared content item associated with the communication session in the three-dimensional environment; and
in response to receiving the indication to display the representation of the shared content item in the three-dimensional environment and in accordance with one or more criteria being satisfied, displaying the representation of the shared content item at a first location within the three-dimensional environment, wherein the representation of the shared content item, when displayed at the first location within the three-dimensional environment, partially occludes the representation of the one or more participants from the respective viewpoint of the user.

2. The method of claim 1, wherein the method further comprises in response to receiving the indication to display the representation of the shared content item in the three-dimensional environment and in accordance with the one or more criteria being satisfied, displaying the representation of the one or more participants at a second location within the three-dimensional environment, different from the first location, and wherein the first location is closer to the respective viewpoint of the user than the second location.

3. The method of claim 2, wherein the first location is in front of the second location relative to the viewpoint of the user of the computer system in a depth dimension of the three-dimensional environment.

4. The method of claim 1, wherein displaying the representation of the shared content item at the first location includes displaying the shared content item on a two-dimensional plane within the three-dimensional environment.

5. The method of claim 1, wherein displaying the representation of the one or more participants includes displaying the representation of the one or more participants on a two-dimensional plane within the three-dimensional environment.

6. The method of claim 5, wherein displaying the representation of the shared content item in response to receiving the indication to display the representation of the shared content item in the three-dimensional environment and in accordance with the one or more criteria being satisfied comprises displaying the representation of the shared content item at an orientation relative to the three-dimensional environment that is the same as an orientation of the representation of the one or more participants relative to the three-dimensional environment.

7. The method of claim 1, wherein the method further comprises:
while displaying the representation of the shared content item at the first location, and while displaying the representation of one or more participants at a second location in the three dimensional environment, receiving, via the one or more input devices, a first input from a first portion of the user, including a first air gesture directed to the representation of the one or more participants followed by movement of the first portion of the user; and
in response to receiving the first input, moving the representation of the one or more participants to a third location within the three-dimensional environment in accordance with the movement of the first portion of the user, and wherein the third location is different from the second location.

8. The method of claim 1, wherein the method further comprises:
while displaying the representation of the shared content item at the first location, receiving, via the one or more input devices, a first input from a first portion of the user, including a first air gesture directed to the representation of the shared content item followed by movement of the first portion of the user; and
in response to receiving the first input, moving the representation of the shared content item to a third location within the three-dimensional environment in accordance with the movement of the first portion of the user, and wherein the third location is different from the first location.

9. The method of claim 8, wherein moving the representation of the shared content item to the third location comprises changing an orientation of the representation of the shared content item relative to an orientation of the representation of the one or more participants and/or relative to the three-dimensional environment.

10. The method of claim 1, wherein the first location is based on a location of the representation of the one or more participants in the three-dimensional environment.

11. The method of claim 10, wherein the representation of the one or more participants is displayed at a second location in response to receiving the indication to display the representation of the shared content item in the three-dimensional environment and in accordance with the one or more criteria being satisfied, and wherein the first location of the shared content item has a pre-defined spatial relationship to the second location of the representation of the one or more participants in the three-dimensional environment.

12. The method of claim 10, wherein displaying the representation of the shared content item at the first location in response to receiving the indication to display the representation of the shared content item in the three-dimensional environment and in accordance with the one or more criteria being satisfied includes:
in accordance with displaying the three-dimensional environment from a first viewpoint of the user, displaying the representation of the shared content item at the first location; and
in accordance with displaying the three-dimensional environment from a second viewpoint of the user, different from the first viewpoint, displaying the representation of the shared content item at the first location.

13. The method of claim 1, wherein the method further comprises in response to displaying the representation of the shared content item at the first location within the three-dimensional environment, visually emphasizing the representation of the shared content item relative to the representation of the one or more participants.

14. The method of claim 13, wherein the visually emphasizing the representation of the shared content item relative to the representation of the one or more participants comprises:
while displaying the three-dimensional environment from a first viewpoint of the user, and while displaying a first virtual object within the three-dimensional environment, in response to displaying the representation of the shared content item at the first location within the three-dimensional environment, visually deemphasizing the first virtual object relative to the three-dimensional environment.

15. The method of claim 1, wherein the one or more criteria include a criterion that is satisfied when the representation of the one or more participants corresponds to one or more non-spatial representations, and wherein method further comprises:
in response to receiving the indication to display the representation of the shared content item in the three-dimensional environment, in accordance with a determination that the representation of the one or more participants corresponds to one or more spatial representations, displaying the shared content item at a second location in the three-dimensional environment, different from the first location, wherein the representation of the shared content item, when displayed at the second location within the three-dimensional environment does not visually occlude the representation of the one or more participants from the respective viewpoint of the user.

16. The method of claim 15, wherein the method further comprises:
in response to receiving the indication to display the representation of the shared content item in the three-dimensional environment, in accordance with the determination that the representation of the one or more participants is a spatial representation, moving the representation of the one or more participants from the second location within the three-dimensional environment to a third location within the three-dimensional environment, different from the second location.

17. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while a user of the computer system is participating in a communication session with one or more participants, and while displaying a representation of the one or more participants in a three-dimensional environment that is visible via the display generation component from a respective viewpoint of the user, receiving, from a computer system of one of the one or more participants, an indication to display a shared content item associated with the communication session in the three-dimensional environment; and
in response to receiving the indication to display the representation of the shared content item in the three-dimensional environment and in accordance with one or more criteria being satisfied, displaying the representation of the shared content item at a first location within the three-dimensional environment, wherein the representation of the shared content item, when displayed at the first location within the three-dimensional environment, partially occludes the representation of the one or more participants from the respective viewpoint of the user.

18. A non-transitory computer readable storage medium storing one or more programs, the one or more programs comprising instructions, which when executed by one or more processors of a computer system that is in communication with a display generation component and one or more input devices, cause the computer system to perform a method comprising:
while a user of the computer system is participating in a communication session with one or more participants, and while displaying a representation of the one or more participants in a three-dimensional environment that is visible via the display generation component from a respective viewpoint of the user, receiving, from a computer system of one of the one or more participants, an indication to display a shared content item associated with the communication session in the three-dimensional environment; and
in response to receiving the indication to display the representation of the shared content item in the three-dimensional environment and in accordance with one or more criteria being satisfied, displaying the representation of the shared content item at a first location within the three-dimensional environment, wherein the representation of the shared content item, when displayed at the first location within the three-dimensional environment, partially occludes the representation of the one or more participants from the respective viewpoint of the user.
